(19) United States
(12) Patent Application Publication
(10) Pub. No.: US 2019/0033542 A1
(43) Pub. Date: Jan. 31, 2019

(54) OPTICAL TRANSCEIVER

(71) Applicant: SAMTEC INC., New Albany, IN (US)

(72) Inventors: Marc EPITAUX, Gland (CH); John L. NIGHTINGALE, Portola Valley, CA (US)

(21) Appl. No.: 16/073,111

(22) PCT Filed: Jan. 27, 2017
(86) PCT No.: PCT/US2017/015293

§ 371 Date: Jul. 26, 2018

Related U.S. Application Data
(60) Provisional application No. 62/287,987, filed on Jan. 28, 2016.
(60) Provisional application No. 62/405,053, filed on Oct. 6, 2016.

(51) Int. Cl. G02B 6/42; G02B 6/35

(52) U.S. Cl. CPC G02B 6/4284; G02B 6/4214; G02B 6/3518; G02B 6/4246; G02B 6/4226

(57) ABSTRACT

An optical transceiver can include a transmitter having a photonic integrated circuit, and a receiver having a current-to-voltage converter and a photodetector in electrical communication with the current-to-voltage converter and separate from the photonic integrated circuit. Each of the transmitter and the receiver can include an interconnect member that includes first and second optical paths for the propagation of optical transmit signals and optical receive signals, respectively. The interconnect members of the transmitter and receiver can further define electrical paths that are configured to connect to an underlying substrate at one end, and the transmitter and receiver, respectively. The interconnect members can be separate from each other or can define a single monolithic interconnect member.

### CROSS-REFERENCE TO RELATED APPLICATIONS

This claims the benefit of U.S. Patent Application Ser. No. 62/287,987 filed Jan. 28, 2016 and U.S. Patent Application Ser. No. 62/405,053 filed Oct. 6, 2016, the disclosure of each of which is hereby incorporated by reference as if set forth in its entirety herein.

### BACKGROUND

The use of optical interconnects, instead of electrical interconnects, provides a significant gain in terms of bandwidth and bandwidth density (Gb/s/m² of surface area occupied by a transceiver). Although optical interconnects are already present in many telecommunication networks (especially transoceanic networks, metropolitan and access networks), they have not yet reached the level of integration, cost and energy efficiency sufficient to supplant electrical interconnects on short links. While optical engines are conceptually simple devices, the often incorporate vertical cavity surface emitting lasers (VCSELs) or photonic integrated circuits, for example, which are significantly more expensive than electrical interconnects.

Most optical engines include an electronic driver circuitry that reshapes and amplifies electrical input signals to properly drive the light source, which is typically a semiconductor laser. The laser is simply modulated on and off by its drive current. Such a modulation scheme is often referred to as OOK, On-Off Keying. In practical implementations, the driver circuitry includes numerous refinements to OOK including temperature dependent laser bias and modulation control, as well as equalization and pre-distortion for driving the laser. At higher bit rates, it also provides equalization on the electrical side. In addition, the capability to turn off a channel and monitor laser health might also be included in the driver. One popular type of laser, the VCSEL, can be modulated into several 10's of GHz modulation regime. It also outputs light having a high power with narrow optical spectral characteristics. These are all desirable elements for high data bit rate fiber transmission. The light emitted by the laser is then captured by an optical system and coupled to the core of an optical fiber.

The receiver side is also conceptually straightforward. The light emitted by a fiber is directed via an optical system to a photodetector. The photodetector, typically a PIN photodiode (named after its P-doped, Intrinsic, and N-doped junction structure) is in turn coupled to an ultra-low noise, very high gain trans-impedance amplifier (TIA) which converts the received photodiode current into an electrically compatible differential voltage output. The TIA output typically incorporates a limiting amplifier (LA) stage and equalization circuitry such as pre/de-emphasis. Advanced functionality such as loss of optical signal detection (LOS), received optical power and squelch might also be implemented.

Optical transceivers may incorporate a microcontroller to perform internal controls. The microcontroller may interface to the system via an I2C protocol, enabling control of the various programmable transceiver settings as well as reporting temperature, loss of signal and other electrical, temperature or optical alarm conditions (generally referred to as optical digital diagnostics). While I2C protocol is one suitable protocol, optical engines can employ any suitable control protocol as desired.

### SUMMARY

In accordance with one aspect of the present disclosure, an interconnect member that is configured to be mounted onto a substrate can include an optical coupler. The optical coupler can have at least one optically transmissive path configured to conduct optical signals from an origination surface of the interconnect member to a termination surface of the interconnect member. The interconnect member can also have an electrical interposer monolithic with the optical coupler. The electrical interposer can include a plurality of electrically conductive vias that extend from a first surface of the interconnect member to a second surface of the interconnect member. The electrically conductive vias can be configured to be placed in electrical communication with at least one electrical component of a transceiver at the first surface, and can be further configured to be placed in electrical communication with the substrate at the second surface.

### BRIEF DESCRIPTION OF THE DRAWINGS

The following detailed description will be better understood when read in conjunction with the appended drawings, in which there is shown in the drawings example embodiments for the purposes of illustration. It should be understood, however, that the present disclosure is not limited to the precise arrangements and instrumentalities shown. In the drawings:

FIG. 1 is an exploded perspective view of an active optical cable constructed in accordance with one example;

FIG. 2A is a perspective view of the active optical cable illustrated in FIG. 1, shown with the housing remove so as to illustrate an optical transceiver constructed in accordance with one example of the present disclosure, including a transmitter and a receiver mounted onto a substrate;

FIG. 2B is a perspective view of an active optical cable constructed in accordance with another example;

FIG. 3A is an exploded perspective view of the transmitter illustrated in FIG. 2B;

FIG. 3B is a schematic sectional side elevation view of the transmitter illustrated in FIG. 3A, showing a high speed electrical path and optical path;

FIG. 3C is a schematic sectional side elevation view of a portion of the transmitter illustrated in FIG. 3B, showing optical transmission from a photonic integrated circuit to an optical transmit waveguide;

FIG. 3D is another schematic sectional side elevation view of a portion of the transmitter similar to FIG. 3C, but constructed in accordance with an alternative embodiment;

FIG. 3E is a schematic sectional side elevation view of the portion of the transmitter illustrated in FIG. 3D, but showing the photonic integrated circuit including a protective layer;

FIG. 3F is another schematic sectional side elevation view of a portion of the transmitter similar to FIG. 3D, but having a reflector constructed as a micro-electromechanical structure in accordance with another embodiment;

FIG. 3G is a schematic perspective view of the micro-electromechanical structure illustrated in FIG. 3F;

FIG. 4 is a schematic sectional side elevation view of the receiver illustrated in FIGS. 2A and 2B, showing a high speed electrical path;

FIG. 5 is a schematic sectional side elevation view of a portion of the receiver illustrated in FIG. 4, showing optical transmission from an optical receive waveguide to a photodetector;

FIG. 6 is a schematic sectional side elevation view similar to FIG. 4, but illustrating an electrical path including a current-to-voltage converter to an electrical contact of the transceiver substrate;

FIG. 7 is a perspective view of an optical assembly constructed in accordance with an alternative embodiment;

FIG. 8A is a perspective view of a transceiver at one end of an active optical cable constructed in accordance with another example;

FIG. 8B is a perspective view of an optical engine of the transceiver illustrated in FIG. 8A;

FIG. 8C is a perspective view of an interconnect member of the optical engine illustrated in FIG. 8B;

FIG. 9A is a schematic sectional side elevation view of a receiver of the transceiver illustrated in FIG. 8A, showing a high speed electrical path and optical paths;

FIG. 9B is an enlarged portion of the receiver illustrated in FIG. 9A, further illustrating optical transmission from an optical receive waveguide to a photodetector;

FIG. 9C is a schematic sectional side elevation view of a receiver of the transceiver illustrated in FIG. 8A, showing a high speed electrical path and optical paths;

FIG. 9D is an enlarged portion of the receiver illustrated in FIG. 9C, further illustrating optical transmission from a light source to an optical transmit waveguide;

FIG. 10 is a side elevation view of the transceiver illustrated in FIG. 8A, including a heat sink;

FIG. 11 A is a perspective view of a transceiver having a removable waveguide assembly in accordance with an alternative embodiment, showing an optical waveguide assembly coupled to an interconnect member of the transceiver;

FIG. 11B is a perspective view of the transceiver illustrated in FIG. 11A, showing a pluggable waveguide assembly decoupled from the interconnect member;

FIG. 12A is an exploded perspective view of a portion of the transceiver illustrated in FIG. 11A, showing the optical waveguide assembly detached from the interconnect member;

FIG. 12B is a perspective view of the transceiver interconnect member illustrated in FIG. 12A;

FIG. 12C is a perspective view of the optical waveguide assembly illustrated in FIG. 12A;

FIG. 13A is a top plan view of a portion of the transceiver illustrated in FIG. 12A, showing the optical waveguide assembly coupled to the interconnect member;

FIG. 13B is an end elevation view of the portion of the transceiver illustrated in FIG. 13A;

FIG. 14A is a perspective view of the showing a data processing system including a plurality of optical engines illustrated in FIG. 12A, shown mounted on a host substrate of an application specific integrated circuit;

FIG. 14B is a sectional side elevation view of the data processing system illustrated in FIG. 14A, showing an electrical path in accordance with one embodiment; and

FIG. 14C is a sectional side elevation view of the data processing system illustrated in FIG. 14A, showing a heat dissipation assembly in accordance with one embodiment.

### DETAILED DESCRIPTION

One aspect of the present disclosure recognizes that optical engines of optical transceivers are constructed with silicon photonic chips with increasing prevalence. In particular, silicon photonics chips can be configured to receive electrical signals from a first electrical component, convert the electrical signals to optical signals, and output the optical signals to one or more optical waveguides for communication to a second component via an optical waveguide, which can be configured as an optical fiber. Silicon photonics chips can further be configured to receive optical receive signals from the second component via an optical waveguide, which can be configured as an optical fiber, convert the received optical signals to received electrical signals, and the received electrical signals can be communicated to the first electrical component. Thus, a single silicon photonics chip can be integrated into both an optical transmitter and an optical receiver.

However, the present disclosure recognizes that photodetectors of silicon photonics chips can be polarization sensitive, thereby causing complexities when the silicon photonics chip is integrated into the optical receiver. Further, optical signals received by a silicon photonics chip has been found to suffer inherent losses in converting from the optical mode size in an optical fiber to a mode size compatible with a silicon photonics chip. In particular, it is appreciated that the mode size in a single mode optical fiber can be larger than the mode size of a silicon photonics chip. For instance, the mode size of a single mode waveguide can be approximately 9 microns in an optical fiber, while the single mode size of a silicon photonics chip waveguide can be approximately 3 microns or less. The losses can be even more severe for multimode waveguides, where coupling light into a single mode waveguide typically creates high losses. Thus, one aspect of the present disclosure incorporates discrete photodetectors into the optical receiver, and a silicon photonics chip into the optical transmitter. Another aspect of the present disclosure provides an improved optical transmission between an optical engine and an optical waveguide. In particular, optical transmit signals are more precisely aligned with optical transmit waveguides. Further, optical receive signals are more reliably communicated to optical receiver engines compared to optical receiver engines that include silicon photonics chips. In particular, the optical signals can be received by a surface sensitive active region of a discrete photodetector, which is sized to receive the optical receive signals with reduced inherent losses than those associated with silicon photonics chips. Embodiments of transceivers are described herein that apply manufacturing techniques suitable for high volume manufacturing at low cost.

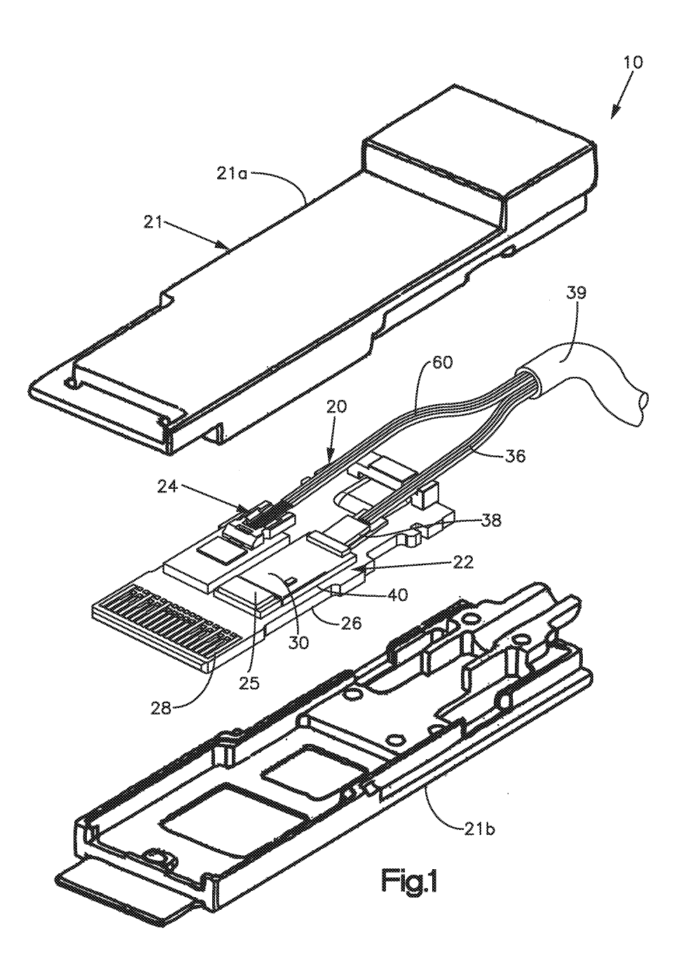

Referring now to FIG. 1, a portion of an active optical cable 10 is illustrated as including an optical transceiver 20 and a housing 21 that supports the optical transceiver 20. The housing 21 can include a first housing portion 21a and a second housing portion 21b that are combinable so as to at least partially encapsulate the optical transceiver. As will be appreciated from the description below, the active optical cable 10 is configured to provide electro-optical conversion and optical transmission. The active optical cable 10 can replace a pluggable electronic cable and connector that is mated with a first complementary electrical component, such that the form factor of the active optical cable 10 mirrors that of the electronic cable and connector that it replaces. The optical transceiver 20 may also be configured to unmate with the first complementary electronic component, so that it may be replaced or serviced as needed.

The optical transceiver 20 is configured to be coupled between the first electrical component and a second component. In particular, the optical transceiver 20 can include an optical engine that is configured to receive electrical transmit signals from the first electrical component, convert the electrical transmit signals to optical transmit signals, and output the converted optical transmit signals for transmission to the second component. The optical transceiver 20 can further include an optical engine that is configured to receive optical receive signals from the second component, convert the optical receive signals to electrical receive signals, and output the converted electrical receive signals for transmission to the first electrical component. It should thus be appreciated that a data communication system can include the optical transceiver 20, the first electrical component, and the second component.

In one example, the optical transceiver 20 can include an optical transmitter 22 that includes the optical transmitter engine, and an optical receiver 24 that includes the optical receiver engine. The optical transmitter 22 and the optical receiver 24 can each be coupled between the first electrical component and the second component. The optical transmitter 22 can be configured to receive electrical transmit signals from the first electrical component, convert the electrical transmit signals to optical transmit signals, and output the converted optical transmit signals for transmission to the second component. The optical receiver 24 can be configured to receive optical receive signals from the second component, convert the optical receive signals to electrical receive signals, and output the converted electrical receive signals for transmission to the first electrical component.

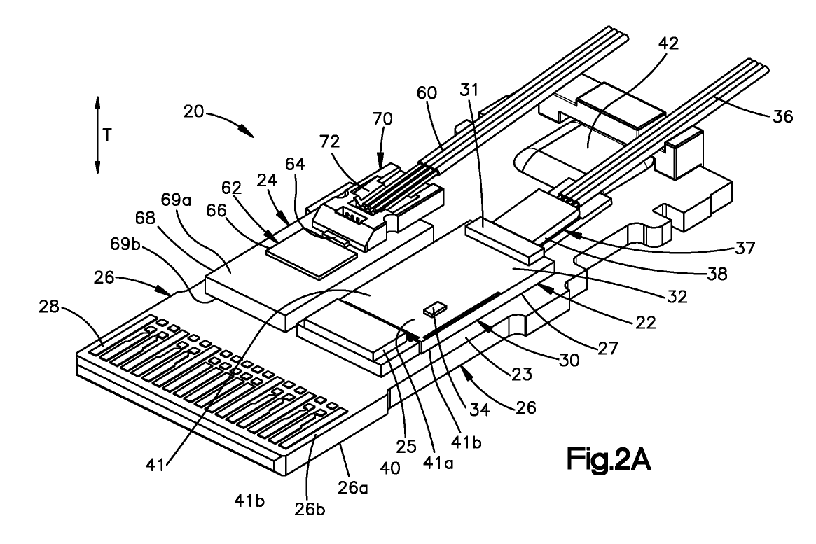

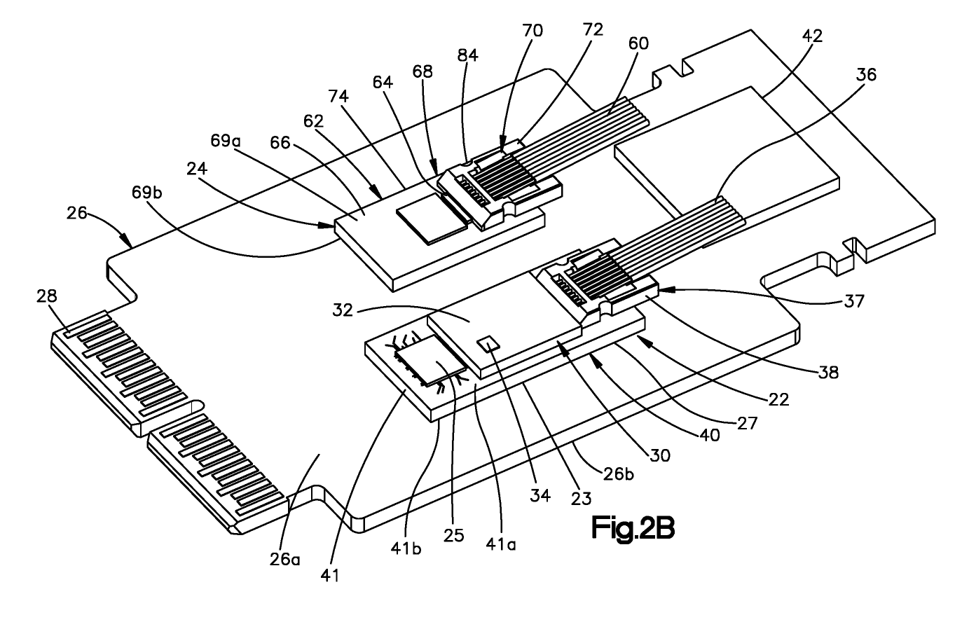

Referring now also to FIGS. 2A-2B, the optical transceiver 20 can further include a transceiver substrate 26 that supports each of the optical transmitter 22 and the optical receiver 24. The substrate 26 can be configured as a printed circuit board as desired. The substrate 26 can be configured to be placed in electrical communication with the first electrical component. For instance, the substrate 26 can define first electrical paths that are configured to extend from the optical transmitter 22 to the first electrical component when the optical transceiver 20 is mated with the first electrical component. The substrate 26 can further define second electrical paths that are configured to extend from the optical receiver 24 to the first electrical component when the optical transceiver is mated with the first electrical component.

For instance, the substrate 26 can include a plurality of electrical contacts 28 that can include electrical signal contacts alone or in combination with electrical ground contacts in any arrangement as desired. Adjacent ones of the signal contacts can define differential signal pairs. Alternatively, the electrical signal contacts can be single-ended. In an alternative embodiment, the electrical contacts 28 can be unassigned. The electrical contacts 28 can be configured as electrical contact pads that are carried by an outer surface of the substrate 26, and configured to be placed in electrical communication with complementary electrical contacts of the first electrical component when the substrate 26 is mated with the first electrical component. For instance, the substrate 26 can define an end that carries the contact pads. The end, and thus the contact pads 28, can be plugged into a receptacle of the first electrical component so as to place the optical transceiver 20 in electrical communication with the first electrical component. When the electrical contacts 28 are placed in electrical communication with the first electrical component, the first electrical component is placed in electrical communication with each of the optical transmitter 22 and the optical receiver 24. It should be appreciated, of course, that the substrate 26 can be placed in electrical communication with the first electrical component in accordance with any suitable alternative embodiment as desired. For instance, the electrical contacts 28 can be configured as electrically conductive holes that are configured to receive press-fit mounting tails of electrical contacts of the first electrical component.

The electrical contacts 28 can include a first group of electrical contacts 28 and a second group of electrical contacts 28. The first electrical paths can include the first group of electrical contacts, and the second electrical paths can include the second group of electrical contacts 28. The first electrical paths can further include a first group of electrical conductors that extend from respective ones of the first group of electrical contacts 28 to the optical transmitter 22. The second electrical paths can further include a second group of electrical conductors that extend from respective ones of the second group of electrical contacts 28 to the optical receiver 24.

The optical transceiver 20 further includes a plurality of optical transmit waveguides 36 and optical receive waveguides 60 that can each be in communication with the second component. For instance, the optical transmitter 22 can include the optical transmit waveguides 36, and the optical receiver 24 can include the optical receive waveguides 36. The optical transmit waveguides 36 may be permanently affixed or coupled to the optical transceiver 20, commonly referred to as pigtailed, or may be detachable. Similarly, the optical receive waveguides 60 may be permanently affixed or coupled to the optical transceiver 20, commonly referred to as pigtailed, or may be detachable. The optical transmit waveguides 36 can be configured as optical transmit fibers or any suitable alternatively constructed optical waveguide structure. Similarly, the optical receive waveguides 60 can be configured as optical transmit fibers or any suitable alternatively constructed optical waveguide structure. The optical transmit fibers and optical receive fibers can be configured as single mode fibers or multimode fibers as desired. At least some, up to all, of the optical transmit waveguides 36 and the optical receive waveguides 60 can be placed in optical communication with the second component. In one example, the optical transmit waveguides 36 and the optical receive waveguides 60 can be bundled into a cable 39 (see FIG. 1) that is placed in optical communication with the second component.

The optical transmitter 22 can further include an optical engine that is configured as an optical transmitter engine 30. The optical transmitter engine 30, in turn, can include at least one photonic integrated circuit 32, such as a plurality of photonic integrated circuits 32. In one example, the photonic integrated circuit 32 can be configured as a silicon photonics chip. The photonic integrated circuit 32, and thus the optical transmitter engine 30, can be supported by the substrate 26. The photonic integrated circuit 32 can be configured to receive at least one electrical transmit signal from the first electrical component, convert the electrical transmit signal to an optical transmit signal, and output the optical transmit signal.

The optical transmitter engine 30, and thus the optical transmitter 22, can further include at least one light source 34 such as a plurality of light sources 34 that emit light that is coupled into the photonic integrated circuit 32. For instance, the optical transmitter engine 30, and thus the optical transmitter 22, can include a coupler that causes the light source to be directed into the photonic integrated circuit 32. If the at least one light source 34 includes a plurality of light sources, each light source can operate at a different wavelength. One or more up to each of the at least one light source 34 can be mounted directly on the photonic integrated circuit 32. Alternatively, one or more up to each of the at least one light source 34 can be mounted off the photonic integrated circuit, and at some other location of the optical transceiver 20. If the light source 34 is located off the photonic integrated circuit 32, the transmitter engine 30, and thus the transmitter 22 can include optical waveguides that can direct light from the light source 34 to the photonic integrated circuit 32.

The photonic integrated circuit 32 can modulate the light output by the at least one light source 34 based on the received electrical transmit signals so as to produce the optical transmit signals. In particular, the optical transmitter 22 can include at least one modulator driver 25 that defines a modulation protocol that determines the modulation of the light based on the electrical signals received from the first electrical component. The transmitter 22 can include a plurality of modulator drivers 25, with each modulator driver being dedicated to a respective channel that receives the electrical transmit signal to be converted into a respective optical transmit signal in the photonic integrated circuit 32. Thus, each of the light sources 34 can be optically coupled to a respective one of the channels of the photonic integrated circuit 32. The modulator drivers may be fabricated on a single die. Each modulator driver 25 can be configured to provide an electrical input to the photonic integrated circuit 32 appropriate for driving the optical modulators located thereof. The optical modulators may take many forms, such as, but not limited to, an electro-absorption modulator, a Mach-Zehnder modulator, and a ring resonator modulator. Depending on the type of optical modulator used, the modulator driver 25 generates electrical signals appropriate for that modulator. For example, a drive signal for a Mach-Zehnder modulator can include a constant or slowly varying offset voltage to bias the two modulator arms for increased or maximum modulation depth. It should be appreciated that in some cases a multi-level modulation protocol, such as PAM4, can be used to increase data transfer rates. Thus, the photonic integrated circuit 32 can be configured to convert the received electrical transmit signals into optical transmit signals. In one example, the light source can be configured as any suitable diode laser. For instance, the light source can be configured as a laser, preferably emitting wavelengths between 1100 nm to 1600 nm. The laser may be configured as a vertical-cavity surface-emitting laser (VCSEL) a distributed feedback (DFB) laser or a Fabry-Perot (FP) laser. In the case of the DFB and FP lasers a coupling structure may be integrated with the laser so that light is emitted from the surface, rather than the edge of the die.

The optical transmit signals can be output to the second component. For instance, the photonic integrated circuit 32 can be optically coupled to the optical transmit waveguides 36 in any suitable embodiment as desired. In one example illustrated in FIG. 2A, the input ends of the transmit waveguides 36 can be placed adjacent, i.e. butted against, an edge of the photonic integrated circuit 32. Thus, the edge of the photonic integrated circuit 32 can define an optical output surface. This type of coupling is known as edge coupling or butt coupling. Accordingly, the optical transmit signals can be directly coupled between the photonic integrated circuit 32 and optical transmit waveguide 36 without passing through any intervening optical elements. In this embodiment provisions can be made in at least one of the photonic integrated circuit 32 waveguides and optical transmit waveguides 36 to mode match the light between the different waveguides.

Alternatively, one or more intervening optical elements having optical power may be disposed in the optical path between the optical transmit waveguide 36 and the photonic integrated circuit 32 to facilitate mode matching. For instance, the one or more intervening optical elements can include one or more of lenses, curved mirrors, transparent substrates, transparent couplers, and optical waveguides that collectively serve to provide an optical path between the photonic integrated circuit 32 waveguides and optical transmit waveguides 36. While the optical path is more complex in the embodiments using multiple optical elements, they may improve mode matching and relax alignment tolerances between the photonic integrated circuit 32 and optical transmit waveguides 36. The high coupling efficiency may advantageously be maintained over a large operating temperature range.

Also, in the edge coupling embodiment, the optical transmitter 22 can include a stiffener 31 that is mounted to the photonic integrated circuit 32. In particular, the stiffener 31 can be mounted to an external-facing surface of the photonic integrated circuit 32. The stiffener 31 can define an edge that extends substantially along the edge of the photonic integrated circuit 32 that is coupled to the optical transmit waveguides 36. The stiffener can further be elongate along the edge of the photonic integrated circuit. The outer surface of the photonic integrated circuit 32 to which the stiffener 31 is mounted can face away from the underlying substrate 26. The stiffener 31 can reduce bowing of the photonic integrated circuit 32. Further, the transmit waveguide coupler 38 can be attached to the stiffener 31 at a location facilitating alignment of the transmit waveguides 36 with the photonic integrated circuit 32. Thus, the stiffener 31, when attached to the photonic integrated circuit 32, can provide an increased attachment area for the transmit waveguide coupler 38, thereby increasing the reliability of the edge coupling between the photonic integrated circuit 32 and the transmit waveguides 36.

In another embodiment illustrated in FIG. 2B, and as described in more detail below, the photonic integrated circuit 32 may be surface coupled to the transmit optical fibers 36 rather than edge coupled. Examples of surface coupling light out of the photonic integrated circuit 32 and into the optical transmit waveguide 36 are described below.

In one example, the optical transmitter 22, and thus the optical transceiver 20, can include a transmit interconnect member 40 interposed between the substrate 26 and the photonic integrated circuit 32. The transmit interconnect member 40 can be supported by the substrate 26. In one example, the transmit interconnect member 40 can be mounted to the substrate 26. Further, in some embodiments, each of the modulator driver 25, photonic integrated circuit 32, and the transmit waveguide coupler 38 can be mounted onto the transmit interconnect member 40. The substrate 26 can define a first substrate surface 26a and a second substrate surface 26b opposite the first substrate surface 26a along a transverse direction T. The transmit interconnect member 40 can be mounted to the first surface 26a of the substrate 26. For instance, the transmit interconnect member 40 can define a first transmit interconnect member surface 41a and a second transmit interconnect member surface 41b opposite the first interconnect surface 41a along the transverse direction. The first transmit interconnect member surface 41a can define an upper surface, and the second transmit interconnect member surface 41b can define a lower surface. The first surface 41a is thus spaced from the second surface 41b in an upward direction. Similarly, the second surface 41b is spaced from the first surface 41a in a downward direction. The upward direction and the downward direction are both oriented along the transverse direction T.

The transmit interconnect member 40 can define an electrical transmit interposer 23. Alternatively, the transmit interconnect member 40 can define an optical transmit coupler 27. Alternatively still, the transmit interconnect member 40 can define both an electrical transmit interposer 23 and an optical transmit coupler 27. Accordingly, the transmit interconnect member 40 can be configured to communicate with either or both of 1) electrical signals between the substrate 26 and the photonic integrated circuit 32, and 2) optical signals between the photonic integrated circuit 32 and the transmit waveguides 36. Reference herein to the electrical transmit interposer 23 can apply equally to the transmit interconnect member 40, unless otherwise indicated. Further, reference herein to the optical transmit coupler 27 can apply equally to the transmit interconnect member 40 unless otherwise indicated.

As illustrated in FIG. 2A, the transmit interconnect member 40 can include the electrical transmit interposer 23. Further, because the optical transmit waveguides are butt coupled to the photonic integrated circuit 32, the transmit interconnect member 40 can be devoid of the optical transmit coupler 27. Alternatively, in FIG. 2A, the transmit interconnect member 40 can include the optical transmit coupler 27 even through optical transmit signals do not travel through the optical transmit coupler 27. As illustrated in FIG. 2A, electrical transmit signals travel through the electrical transmit interposer 23. As illustrated in FIG. 2B, the transmit interconnect member 40 can include both the electrical transmit interposer 23 and the optical transmit interposer 27, as electrical transmit signals travel through the electrical transmit interposer 23, and optical transmit signals travel through the optical interposer.

The optical transmitter 22 can include a transmit waveguide assembly 37 that can include the plurality of optical transmit waveguides 36 that are in optical alignment with the optical transmitter engine 30, and in particular are in optical alignment with the photonic integrated circuit 32. Thus, the optical transmit waveguides 36 are configured to receive respective ones of the optical transmit signals that are output by the optical transmitter engine 30, and carry the optical transmit signals to the second component. The transmit waveguide assembly 37 can be referred to as a transmit fiber assembly when the optical transmit waveguides 36 are configured as optical fibers. The transmit waveguide assembly 37, and thus the optical transmitter 22, can further include a transmit waveguide coupler 38 that is configured to support the optical transmit waveguides 36 such that an input end of the optical transmit waveguides are in optical alignment with the light output from the optical transmitter engine 30. Thus, the input ends of the optical transmit waveguides 36 are configured to receive the optical transmit signals from the optical transmitter engine 30. The transmit waveguide coupler 38 can be referred to as a transmit fiber coupler when the optical transmit waveguides 36 are configured as optical fibers. The transmit waveguide coupler 38 can be made from glass (including fused silica or any silica or non-silica based glass), ceramic, plastic or any suitable alternative material. In one example, the transmit waveguide coupler 38 can be configured as a molded optical structure (MOS) that couples one or both of the transmit interconnect member 40 and the substrate 26 to the optical transmit waveguides 36. In some embodiments, as will be described in more detail below, the transmit waveguide coupler 38 can include a reflector to direct the optical transmit signals. The transmit waveguide coupler 38 can be supported by the substrate 26. For instance, the transmit waveguide coupler 38 can be mounted to the substrate 26. Alternatively, the transmit waveguide coupler 38 can be mounted to the transmit interconnect member 40 which, in turn, is mounted to the substrate 26.

The optical transmit coupler 27 can be optically transparent so as to allow optical signals to pass therethrough. For instance, the transmit interconnect member, and thus the optical transmit coupler 27, can include a transmit coupler substrate 41 that is made from an optically transparent material. In one example, the substrate 41 can be a monolithic substrate. In another example, the substrate 41 can be made of more than one material joined to each other. The transparent material can comprise glass, silicon, or any alternative suitable material. As is further described in more detail below, optical transmit signals can travel through the optically transparent material of the optical transmit coupler 27. Thus, the optically transparent material of the optical transmit coupler 27 can be said to be optically transmissive, and can conduct the optical transmit signals. Accordingly, the optical transmit coupler 27 can be configured to transmit the optical transmit signals from the photonic integrated circuit 32 to the transmit waveguide assembly 37 through the optically transparent material of the optical transmit coupler 27.

When the transmit interconnect member 40 includes both of the optical transmit coupler 27 and the electrical transmit interposer 23 as a single unitary structure, the optical transmit coupler 27 and the electrical transmit interposer 23 can be referred to as monolithic with each other. The optical transmit coupler 27 and the electrical transmit interposer can be monolithic with each other even though the electrical transmit interposer 23 can include electrically conductive paths that travel through or along the optically conductive material. Thus, the electrical transmit interposer 23 can be made from the same optically transparent material as the optical transmit coupler 27. In this regard, the transmit interconnect member 40 can also be referred to as monolithic since the optically transparent material at the optical transmit coupler 27 can be the same material that supports the electrically conductive paths at the electrical transmit interposer 23. In still other embodiments, the optical transmit coupler 27 and the electrical transmit interposer 23 can be separate structures. When the optical transmit coupler 27 and the electrical transmit interposer 23 are monolithic with each other, the transmit interconnect member 40 can include an optically conductive region defined by the optical transmit coupler 27, and an electrically conductive region defined by the electrical transmit interposer 23. The optically conductive region and the electrically conductive region can be spaced from each other, or can be defined by a common overlapping region of the transmit interconnect member 40.

Because the transmit interconnect member 40 can include the optical transmit coupler 27, the transmit interconnect member 40 can be at least partially or entirely defined by the substrate 41. In some embodiments, the transmit interconnect member 40 can define the optical transmit coupler 27 and not the electrical transmit interposer 23, such that the transmit interconnect member 40 has only an optical function. Thus, in these embodiments the electrical transmit signals do not pass through the optical transmit interconnect member 40. Rather, the electrical transmit signals pass through any suitable alternative structure so as to travel from the electrical contacts 28 to the modulator drive 25 and/or the photonic integrated circuit 32. Alternatively or additionally, the transmit interconnect member 40 can define the electrical transmit interposer 23 that is configured to conduct electrical signals between the substrate 26 and the photonic integrated circuit 32.

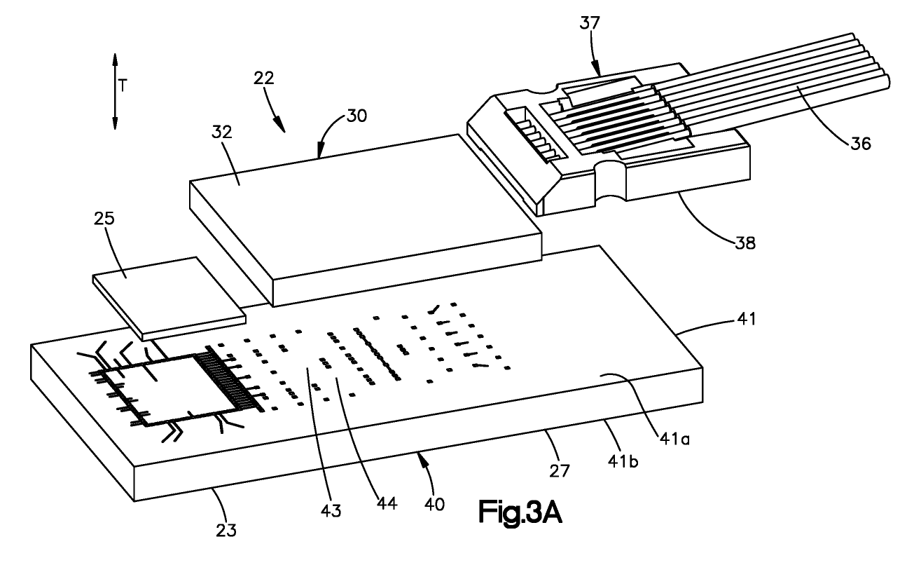

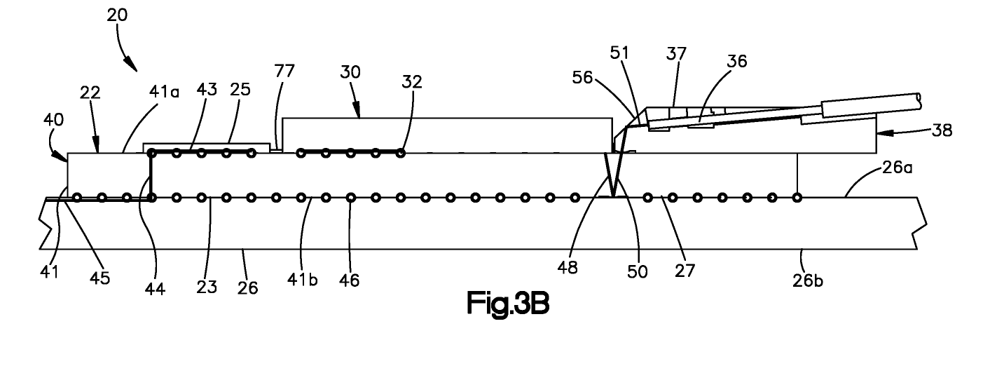

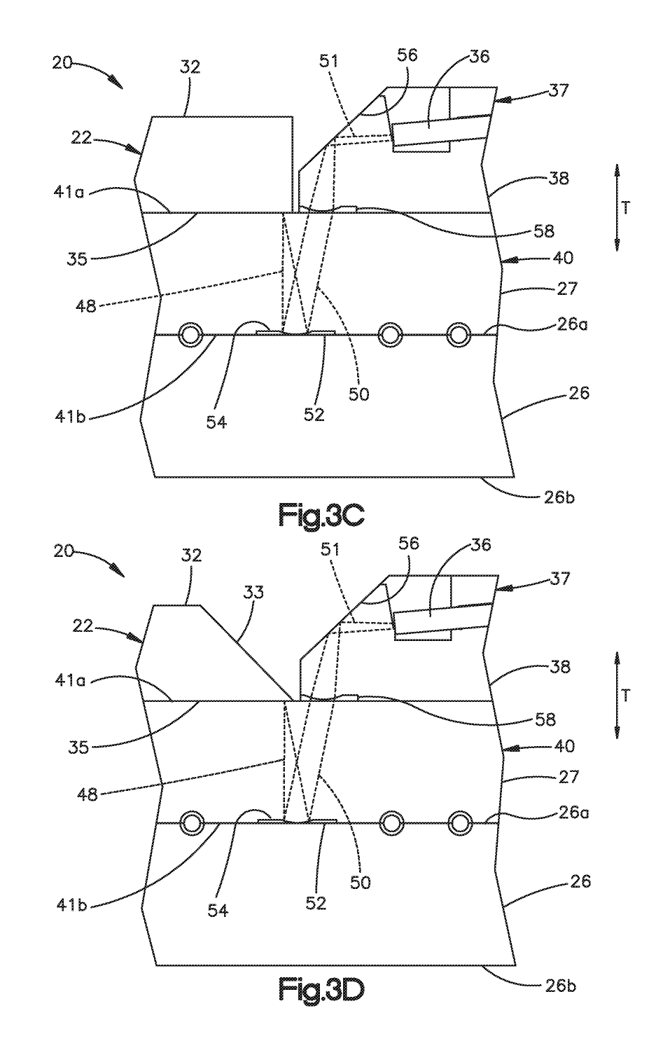

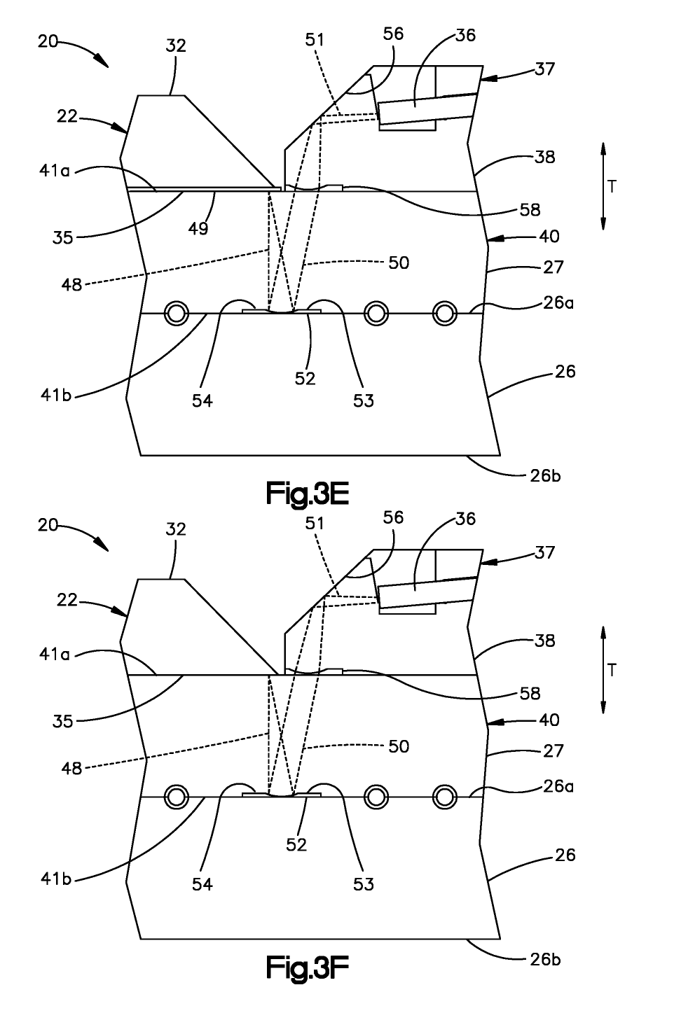

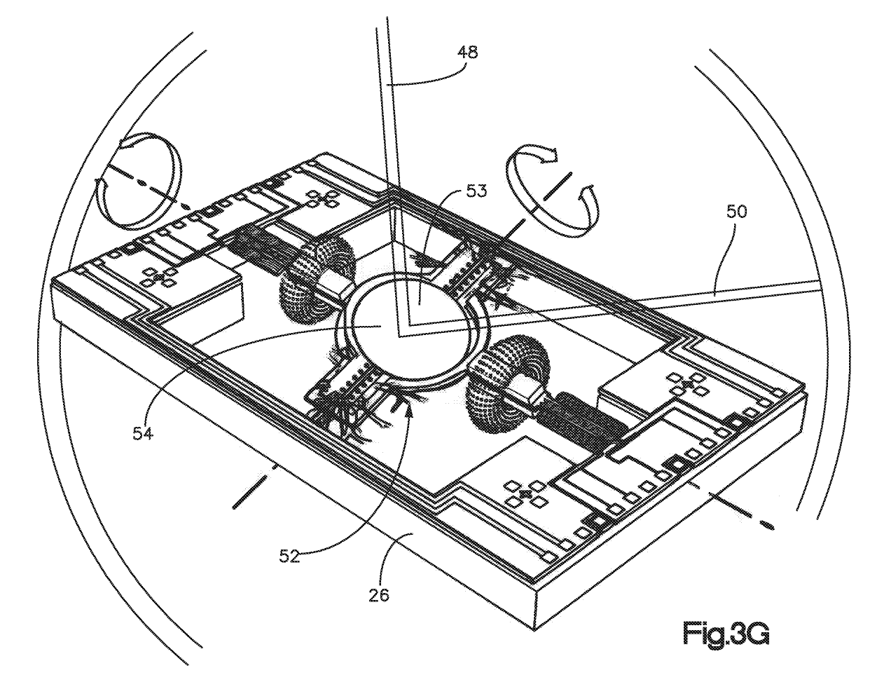

For instance, as illustrated in FIG. 3B, the electrical transmit interposer 23 can include one or more of electrical vias 44 and a redistribution layer 43 to route electrical signals to and from one or both of the modulation driver 25 and the photonic integrated circuit 32. In this example, the electrical vias 44 can be configured as apertures that extend at least into or through the optically transparent material of the substrate 41. The apertures can be at least partially or entirely filled or plated with an electrically conductive material so as to define an electrically conductive path between first and second surfaces of the electrical transmit interposer 23, which can be defined by the opposed surfaces 41a and 41b, respectively. In one example, the electrically conductive material can be configured as a cured electrically conductive paste. The paste is fired after insertion into the aperture. The paste can be inserted into the apertures using thick film technology. The vias 44 can be constructed as described in U.S. Pat. No. 9,374,892, which is hereby incorporated by reference as if set forth in its entirety herein. It should be appreciated that one via 44 is illustrated in FIG. 3B as representative of the plurality of vias 44 described herein.

The at least one redistribution layer 43 can be connected between the vias 44 and the photonic integrated circuit 32. The redistribution layer 43 can provide an electrically conductive path between the vias 44 and respective channels of the photonic integrated circuit 32. It is appreciated that the electrical transmit signals are received by respective ones of the first group of electrical contacts 28 along respective channels that are conducted to respective channels of the photonic integrated circuit 32. The optical transmit signals are output by the respective channels of the photonic integrated circuit 32 to corresponding ones of the optical transmit waveguides 36.

The at least one redistribution layer 43 can extend along the first transmit interconnect member surface 41a from a first location aligned with the photonic integrated circuit 32 along the transverse direction T to a second location aligned with respective outer ends of the vias 44 along the transverse direction T. Thus, the at least one redistribution layer 43 can be in contact with the vias 44 and the photonic integrated circuit 32 so as to conduct the electrical transmit signals from the vias 44 to respective channels of the photonic integrated circuit 32. It should be appreciated, of course, that the electrical transmit interposer 23 and the substrate 26 can be configured in accordance with any suitable alternative embodiment so as to place the electrical transmit interposer 23 in electrical communication with the first group of the electrical contacts 28. As just one example, the substrate 26 can define electrically conductive vias that extend into the first surface 26a, and the electrically conductive material of the electrical transmit interposer 23 can extend into the vias of the substrate 26 so as to place the transmit interposer 23 in electrical communication with the substrate 26. It should be appreciated, of course, that the substrate 26 can define any suitable electrical path that extends from the electrical contacts 28 at one end, and can be placed in electrical connection with the electrical transmit interposer 23.

It should thus be appreciated that the transceiver 20 can define a plurality of electrical paths 45 from the respective ones of the electrical contacts 28 of the substrate 26 to at least one electrical component which can be defined by one or both of the photonic integrated circuit 32 and the modulator driver 25 when the transmitter 22 is mounted to the substrate 26. Alternatively, as described below, the photonic integrated circuit 32 can be replaced by light sources 34 that are driven directly by the driver 25. Thus, the at least one electrical component can be further defined by the light sources. A plurality of electrical paths can also be established from the modulator driver 25 to the photonic integrated circuit 32. In one example, the respective ones of the electrical contacts 28 can define signal contacts. In particular, the electrical paths 45 can extend from respective ones of the electrical contacts, to respective ones of the vias 44, to the at least one redistribution layer 43 that can be disposed at the first transmit interconnect member surface 41a. The redistribution layer 43 may direct the electrical paths 45 to the modulator driver 25, where the signals are conditioned in a suitable manner for driving the photonic integrated circuit 32. The signals may then be routed along electrical path 77, which connects the modulator driver 25 to the respective channels of the photonic integrated circuit 32. Thus, when the substrate 26 is mated with the first electrical component, the first electrical component is placed in electrical communication with the photonic integrated circuit 32.

When the transmit interconnect member 40 includes the electrical interposer 23, the second interconnect surface 41b can be mounted to the first substrate surface 26a so as to place the electrical interposer 23, and thus the transmit interconnect member 40, in electrical communication with the substrate 26. Thus, the electrical vias 44 that define electrical conductors of the electrical transmit interposer 23 can be placed in electrical communication with the electrical contacts 28 of the substrate 26.

The electrical transmit interposer 23 can be surface mounted to the substrate 26 in one example. For instance, flip-chip technology, such as use of a ball grid array, copper pillars, or stud bumps, may be used to mount the electrical interposer 23, and thus the transmit interconnect member 40, to the substrate 26. In one example, the substrate 26 can include an array of electrically conductive lands 46 at the first substrate surface 26a that are configured to be placed in contact with the electrically conductive vias 44 at the second interconnect surface 41b when the electrical transmit interposer 23 is mounted to the substrate 26. The lands 46 are in electrical communication with respective ones of the first group of electrical conductors, and are thus in electrical communication with the corresponding respective ones of the electrical contacts 28. The lands 46 can be configured as a ball grid array (BGA) 47. Thus, when the electrical transmit interposer 23 is mounted to the substrate 26, the electrically conductive vias 44 can be mounted onto respective ones of the lands 46, such that the lands 46 establish an electrical connection with the electrically conductive material of the vias 44. The vias 44 are further placed in electrical communication with one or both of the modulator driver 25 and the photonic integrated circuit 32, such that the at least one or both of the modulator driver 25 and the photonic integrated circuit 32 is in electrical communication with the electrical contacts 28 of the substrate 26.

Thus, the electrical transmit interposer 23 can be mounted to the substrate 26 such that the photonic integrated circuit 32 is placed in electrical communication with the first group of electrical contacts 28 of the substrate 26. In particular, the electrical transmit interposer 23 can include a plurality of electrical conductors that are in electrical communication with the photonic integrated circuit 32. The electrical conductors of the electrical transmit interposer 23 can further be placed in electrical communication with respective ones of the first group of electrical conductors of the substrate 26 when the electrical transmit interposer 23 is mounted to the substrate 26.

Flip-chip technology, such as use of a ball grid array, copper pillars, or stud bumps, may also be used to mount either or both of the modulator driver 25 and the photonic integrated circuit 32 to the to the transmit interconnect member 40. Flip-chip technology can also be used to mount the transmit interconnect member 40 to the substrate 26.

Referring now to FIGS. 2B-3D, as described above the transmit interconnect member 40 can include the optical coupler 27. Thus, the second interconnect surface 41b of the transmit interconnect member 40 can be mounted to the first substrate surface 26a so as to place the photonic integrated circuit 32 in optical alignment with the transmit waveguides 36 as will now be described. The waveguides of the photonic integrated circuit 32 can be disposed adjacent a bottom surface of the photonic integrated circuit 32. The bottom surface of the photonic integrated circuit 32 can be defined by the surface of the photonic integrated circuit 32 that is mounted to the optical transmit interposer 27. Alternatively, as illustrated in FIG. 2A, the bottom surface of the photonic integrated circuit 32 can be mounted to the substrate 26. In both FIGS. 2A and 2B, the bottom surface of the photonic integrated circuit 32 faces the substrate 26. As described below, the bottom surface of the photonic integrated circuit 32 can define an optical output surface. Alternatively, as described above, for instance when the photonic integrated circuit 32 is edge coupled to the optical transmit waveguides 36, the optical output surface can be disposed at an edge of the photonic integrated circuit 32 that extends up from the bottom surface toward a top surface that is opposite the bottom surface along the transverse direction T. The waveguides of the photonic integrated circuit 32 can be disposed between a midline of the photonic integrated circuit 32 and the bottom surface of the photonic integrated circuit 32 with respect to the transverse direction T. The midline of the photonic integrated circuit 32 can be equidistantly disposed between the bottom surface of the photonic integrated circuit 32 and the upper surface of the photonic integrated circuit 32 along the transverse direction T. In one example, the waveguides of the photonic integrated circuit 32 can be spaced no more than approximately 20 microns from the bottom surface of the photonic integrated circuit 32. In another example, the waveguides of the photonic integrated circuit 32 can be spaced no more than approximately 10 microns from the bottom surface of the photonic integrated circuit 32.

At least a portion of the transmit interconnect member 40 can be disposed between the photonic integrated circuit 32 and the substrate 26 along the transverse direction T. For instance, the photonic integrated circuit 32 can be mounted to the first transmit interconnect member surface 41a. The second transmit interconnect member surface 41b can, in turn, be mounted to the substrate 26. The optical transmit coupler 27 can be configured to conduct the optical transmit signal along a transmission direction from the photonic integrated circuit 32 toward the optical transmit waveguides 36. In one example, the optical transmit coupler 27 can be configured to receive optical transmit signals that are output from the photonic integrated circuit 32, and direct the optical transmit signals along at least one optically transmissive path of the optical transmit coupler 27 toward the transmit waveguide assembly 37.

In particular, the optical transmit coupler 27 can be configured to receive optical transmit signals that are output from the photonic integrated circuit 32, and direct the optical transmit signals along a respective first transmit path 48, and redirect the optical transmit signal toward the transmit waveguide assembly 37 along a respective second transmit path 50 that is different than the first transmit path 48. Each optical transmit signal can then travel from the second transmit path 50 to a respective one of the transmit waveguides 36. As described above, the optical transmit coupler 27 can be formed from an optically transparent material, such that the optical transmit signals can propagate through the optically transparent material along at least a portion up to all of the first and second transmit paths 48 and 50. It is recognized that the optically transparent materials described herein with respect to the optical transceiver 20 can have less than 100% optical transparency, unless otherwise indicated, so long as optical signals can suitably propagate through the transparent material in the manner described herein. In one example, the transparent material of the optical transmit coupler 27 can be glass or silicon.

It is recognized that the optical transmit coupler 27 can further be made from an optically translucent or optically opaque material, but can define the optically transparent first and second transmit paths 48 and 50. Thus, the optical transmit coupler 27 can be made of an optically translucent or opaque material, and optically transparent channels can extend through the electrical transmit interposer 23 so as to define the first and second transmit paths 48 and 50. Thus, the first and second transmit paths 48 and 50 can be air paths that extend through the transmit interconnect member substrate 41. Thus, the optical transmit signals can propagate through the air along at least a portion, up to all, of the first and second transmit paths 48 and 50. Alternatively, the channels can be filled with an optically transparent material, such as glass or silicon, that can be different than the material of the transmit interconnect member substrate 41. Thus, the transmit interconnect member substrate 41 can be made of an optically transparent material, an optically translucent material, or an optically opaque material whereby the electrical transmit interposer 23 defines at least one transmit path configured to conduct the optical transmit signals from the photonic integrated circuit to the optical transmit waveguides. It should therefore be appreciated that the optical transmit signals can pass through the transmit interconnect member substrate 41 at the optical transmit coupler 27. In one example, the optical transmit signals can pass through the material of the transmit interconnect member substrate 41. In another example, the optical transmit signals can pass through a transmit channel defined by the transmit interconnect member substrate 41.

The substrate 41 can define the first and second transmit interconnect member surfaces 41a and 41b that are opposite each other with respect to the transverse direction T. In one example, the transmit interconnect member 40 can define a thickness along the transverse direction T from the first transmit interconnect member surface 41a to the second transmit interconnect member surface 41b that is between approximately 125 microns and approximately 2 mm. For instance, the thickness can be between 250 microns and approximately 1 mm. In one example, the thickness can be approximately 500 microns. The redistribution layer 43 can be carried by the first transmit interconnect member surface 41a.

The first transmit path 48 can extend in a direction from a respective origination surface which can be defined by transmit first surface or input surface of the optical transmit coupler 27. The input surface can, in one example, be defined by an outer surface, of the optical transmit coupler 27. In particular, the transmit input surface can be defined by the first interconnect surface 41a. Thus, the first transmit path 48 can extend from the first interconnect surface 41a toward the second interconnect surface 41b. The second transmit path 50 can extend in a direction from the first transmit path 48 toward a respective termination surface of the transmit interposer 40 that can be defined by a transmit second surface output surface. The output surface can be defined by an outer surface of the optical transmit coupler 27. In one example, the transmit output surface can be defined by the same surface as the transmit input surface. Thus, the transmit input surface and the transmit output surface can be defined by a common surface of the optical transmit coupler 27. For instance, the transmit output surface can be defined by the first transmit interconnect member surface 41a. Accordingly, the second transmit path 50 can extend in a direction from the second interconnect surface 41b toward the first interconnect surface 41a. The second transmit path 50 can extend from the first transmit path 48. As will be appreciated from the description below, the transmit input surface and the transmit output surface can alternatively be defined by different surfaces of the optical transmit coupler 27.

The optical transmit coupler 27 can be configured to redirect the optical transmit signals from the first transmit path 48 toward the optical transmit waveguides 36. The optical transmit signals can propagate through the optical transmit coupler 27 along the first and second transmit paths 48 and 50 without passing through any waveguides. Thus, the optical signal propagation through the optical transmit coupler 27 can be referred to as free space propagation. Further, the optical transmit signals can travel from the photonic integrated circuit 32 to the optical transmit waveguides 36 without passing through any waveguides. Thus, the optical signal propagation from the photonic integrated circuit 32 to the optical transmit waveguides 36 can be referred to as free space propagation. In one example, the optical transmit coupler 27 can be devoid of optical waveguides. Alternatively, the optical transmit coupler 27 can include waveguides that define at least some, up to all, of the first and second optical transmit paths 48 and 50. The first and second paths 48 and 50 are indicated by opposed dashed lines that represent boundaries of the first and second paths 48 and 50, respectively.

The first transmit path 48 can extend along an angle of incidence, and the second transmit path 50 can extend along an angle of reflection. The first transmit path 48 can be defined by the photonic integrated circuit 32. For instance, as illustrated in FIG. 3C, the photonic integrated circuit 32 can internally conduct the optical transmit signals to an optical output surface 35 that faces the optical transmit coupler 27, such that the optical transmit signals travel from the output surface 35 and into the optical transmit coupler 27 along the first transmit path 48. The output surface 35 can define a bottom surface of the photonic integrated circuit 32. The photonic integrated circuit 32 can include a grating that couples the optical transmit signals out of the output surface 35 to the optical transmit coupler 27. Alternatively or additionally, the photonic integrated circuit 32 can include an internal reflective surface that couples the optical transmit signals out of the output surface 35 to the optical transmit coupler 27.

As illustrated in FIG. 3D, the photonic integrated circuit 32 can define an outer reflection surface 33 that is internally reflective, such that the photonic integrated circuit 32 propagates the optical transmit signals to the outer reflection surface 33 that reflects the optical transmit signals to the output surface 35. The reflected optical transmit signals travel from the output surface 35 into the optical transmit coupler 27 along the first transmit path 48. As shown in FIG. 3E, the photonic integrated circuit 32 can include a layer 49 of transparent material that extends from the output surface 35. The layer 49 can extend forward with respect to the outer reflection surface 33. The forward direction can be defined such that the outer reflection surface 33 extends in the forward direction as it extends in a direction from the top surface of the photonic integrated circuit 32 toward the bottom output surface 35. The forward direction can, for instance, be oriented perpendicular to the transverse direction T. Because the layer 49 extends forward with respect to the outer reflection surface 33, the layer 49 can receive an impact resulting from contact with other structures that would otherwise have been received by the outer reflection surface 33. Thus, the layer 49 can be referred to as a protective layer that protects the outer reflection surface 33 from impact. In one example, the layer 49 can be made from silicon dioxide or silicon nitride that is applied to the output surface 35 of the photonic integrated circuit 32 so that the light does not strike the edge of internal reflection surface 33. In this manner small micron size chips that may be present on the edge of internal reflective surface 33 will not interfere with transmission of light between photonic integrated circuit 32 and the optical transmit coupler 27.

The optical transmit coupler 27 can include at least one reflector 52 that is aligned with a respective first transmit path 48. For instance, the optical transmit coupler 27 can include a plurality of reflectors 52 that are supported by the substrate 41 and are each aligned with a corresponding one of the first transmit paths 48. Alternatively, the optical transmit coupler 27 can include a single reflector 52 that is sized so as to be aligned with each of the first transmit paths 48. The at least one reflector 52 is configured to reflect the optical transmit signal from the first paths 48 to the corresponding second transmit paths 50. The at least one reflector 52 can be integral with or otherwise supported by the second interconnect surface 41b. Alternatively, the at least one reflector 52 can be embedded in the body of the transmit interconnect member 40. Thus, the first path 48 can extend to a reflective transmitter surface 54 of the reflector 52, and the second transmit path 50 can extend from the reflective transmitter surface 54. Thus, the first transmit path 48 can enter the electrical transmit interposer 23 at a surface of the interposer 23, and the second transmit path 50 can exit the electrical transmit interposer 23 at the same surface of the interposer 23. The surface can be defined by the first interconnect surface 41a. The reflective transmitter surface 54 can be planar. Alternatively, the reflective transmitter surface 54 can be curved.

In one example, the angle of incidence of the first transmit path 48 to the reflective transmitter surface 54 can be less than approximately 35 degrees. For instance, the angle of incidence can be between approximately 10 degrees and approximately 30 degrees. In one example, the angle of incidence can be between approximately 15 degrees and approximately 20 degrees. Thus, the first and second transmit paths 48 and 50 can define an angle less than approximately 70 degrees. For instance, the angle defined by the first and second transmit paths 48 and 50 can be between approximately 20 degrees and approximately 60 degrees. In one example, the angle defined by the first and second transmit paths 48 and 50 can be between approximately 30 degrees and approximately 40 degrees. The optical transmit coupler 27 can be configured such that the light beams of the optical transmit signals converge or diverge as they travel along the first and second transmit paths 48 and 50. As described in more detail below, the transmitter 22 can further include at least one or more a transmitter lenses 58 that can condition the light beams of the optical transmit signals.

The reflective transmitter surface 54 can face the substrate 41 of the optical transmit coupler 27. In this regard, the reflective transmitter surface 54 can be said to face a direction that extends toward the first transmit interconnect member surface 41a. The reflective transmitter surface 54 can be metallic, a multi-layer dielectric coating, or made from any suitable alternative reflective material as desired. Further, the reflective transmitter surfaces 54 can be shaped as desired so as to condition the light beams of the optical transmit signals. The reflective transmitter surface 54 can be concave, such that light beams of the optical transmit signal converge as they travel along the second transmit path 50. In one example, the reflector 52 can be deposited onto the second transmit interconnect member surface 41b. Alternatively, a photolithographic process can apply the reflector 52 to the second transmit interconnect member surface 41b. Alternatively still, the reflector 52 can be fabricated on a separate substrate, and the reflector 52 can be positioned below and carried by the second transmit interconnect member surface 41b. The reflector 52 may be an angularly fixed reflector or may be angularly adjustable as described below.

It may be desirable to cause the light beams of the optical transmit signal to converge such that the optical transmit signal traveling through the optical transmit coupler 27 are mode matched with the optical transmit waveguides 36. It should be appreciated that the reflective transmitter surface 54 can be configured to cause the light beams of the optical signal to converge as described above. Alternatively or additionally, the transmitter 22 can include one or more lenses 58 that the optical transmit signals pass through so as to cause the optical transmit signals to converge so that the beam size at the input of the transmit waveguides 36 approximately matches the waveguide mode size, i.e. is substantially mode matched. In another example, the reflective transmitter surface 54 can be substantially planar, such that the reflective transmitter surface 54 does not cause the light beams of the optical transmit signal alter its convergence or divergence. In this case other elements in the optical transmission path, such as one or more lenses 58, may be used to provide mode matching into the transmit waveguides 36.

The optical transmit coupler 27 can be disposed between the substrate 26 and each of the photonic integrated circuit 32 and the transmit waveguide assembly 37, including each of the optical transmit waveguides 36 and the transmit waveguide coupler 38, with respect to the transverse direction T. The first transmit interconnect member surface 41a can face each of the photonic integrated circuit 32 and the transmit waveguide assembly 37, including each of the optical transmit waveguides 36 and the transmit waveguide coupler 38. For instance, the transmit waveguide coupler 38 can be mounted onto the optical transmit coupler 27. In one example, the transmit waveguide coupler 38 can be disposed on the first transmit interconnect member surface 41a. Similarly, the photonic integrated circuit 32 can be mounted onto the optical transmit coupler 27. In one example, the photonic integrated circuit 32 can be disposed on the first transmit interconnect member surface 41a. It should be appreciated that the redistribution layer 43 can be mounted onto the first transmit interconnect member surface 41a. Thus, the redistribution layer 43 can be disposed between the first transmit interconnect member surface 41a and the photonic integrated circuit 32 with respect to the transverse direction T.

As described above, the second transmit path 50 of each of the optical transmit signals can be in optical alignment with an input end of a respective one of the optical transmit waveguides 36. In particular, the transmitter 22 can include a reflective transmit coupler surface 56 that is aligned with both the input ends of the optical transmit waveguides 36 and the second transmit path 50. That is, the reflective transmit coupler surface 56 can be aligned with both the input ends of the optical transmit waveguides 36 and the reflective transmitter surfaces 54. Thus, the reflective transmit coupler surface 56 can be configured to reflect the optical transmit signals from the second transmit path 50 to a third transmit path 51 that is in alignment with the input ends of the optical transmit waveguides 36. The third transmit path 51 is indicated by spaced apart dashed lines, which represent opposed boundaries of the third transmit path 51.

It should thus be appreciated that the reflective transmit coupler surface 56 is oriented non-parallel with respect to the second transmit path 50. For instance, the reflective transmit coupler surface 56 can be oriented along a plane that is angularly offset with respect to the second transmit path 50. In one example, the reflective transmit coupler surface 56 can be oriented along a plane that defines an angle between 25 degrees and 65 degrees with respect to the transverse direction T, such as between 35 degrees and 55 degrees with respect to the transverse direction T, and in one example can be between 40 degrees and 50 degrees with respect to the transverse direction T. With respect to the reflective transmit coupler surface 56, the second transmit path 50 extends along an angle of incidence, and the third path 51 extends along an angle of reflection.

The reflective transmit coupler surface 56 can be defined by the transmit waveguide coupler 38, and can be monolithic with a support portion of the transmit waveguide coupler 38 that supports the optical transmit waveguides 36. While the transmitter can include a single transmit coupler surface 56 that is aligned with each of the transmit waveguides 36 and each of the reflectors 52, it should be appreciated that the transmitter can alternatively include a plurality of reflective transmit coupler surfaces 56 that are each aligned with a respective one of the transmit waveguides 36 and a respective aligned one of the reflectors 52. In some embodiments, the reflective transmit coupler surface 56 can be oriented for total internal reflection of the second transmit path 50. In other embodiments a metallic or dielectric layer may be incorporated in reflective transmit coupler surface 56. Optical transmit coupler 38 may be formed from any suitable optically transparent material, such as, but not limited to, silicon, glass and plastic.

With continuing reference to FIGS. 3A-3D, the transmitter 22 can further include at least one transmitter lens 58 that is disposed upstream of the optical transmit waveguides 36 with respect to the direction of the optical transmit signal propagation. For instance the transmitter 22 can include a plurality of transmitter lenses 58 each in optical alignment with a respective one of the second transmit paths 50 and a corresponding respective one of the transmit waveguides 36. Each transmitter lens 58 can be disposed upstream of the reflective transmit coupler surface 56. In one example, the transmitter lens 58 can be disposed between the reflective transmit coupler surface 56 and the reflector 52. The transmitter lens 58 can be positioned at a location in alignment with the second transmit path 50, such that the optical transmit signals pass therethrough. In one example, the transmitter lens 58 can be fabricated on the transmit waveguide coupler 38. Thus, the transmit waveguide coupler 38 can include the transmitter lens 58. In another example, the transmitter lens 58 can be carried by the transmit waveguide coupler 38. Alternatively, the transmitter lens 58 can be carried by the electrical transmit interposer 23. Alternatively still, the transmitter lens 58 can be fabricated on the electrical transmit interposer 23. Thus, the electrical transmit interposer 23 can include the transmitter lens 58. The transmitter lens 58 can be positioned such that the optical transmit signals are directed to travel along the second transmit path from the reflective transmitter surface 54, through the transmitter lens 58, and to the reflective transmit coupler surface 56. In one example the transmitter lens 58 can be a converging lens that causes light beams of the optical transmit signal to converge as they travel toward the transmit waveguides 36. Accordingly, the optical transmit signal can be properly aligned with the input end of the optical transmit waveguides 36.

In another example, the at least one transmitter lens 58 can include a collimating transmitter lens in combination with a converging lens that is positioned downstream of the collimating transmitter lens and in alignment with the collimating transmitter lens. Thus, the optical transmit signal can pass through the collimating transmitter lens and then through the converging transmitter lens. It is recognized that an advantage of using a collimating lenscan include relaxing the alignment tolerance between the optical transmit signals and the optical transmit waveguides 36. The collimating lens and the converging lens can be positioned anywhere as desired. In one example, the collimating lens can be supported by the electrical transmit interposer 23, while the converging lens is disposed opposite the collimating lens. For instance, the converging lens can be supported by the transmit waveguide coupler 38 or the electrical transmit interposer 23. While the collimating transmitter lens can collimate the beams of the optical transmit signal in one example, alternatively or additionally the reflective transmitter surface 54 can define a collimating mirror or a converging mirror.

Thus, during operation, a method can be provided for processing data in the transmitter 22. The method can include the step of receiving electrical transmit signals in the photonic integrated circuit 32. The electrical transmit signals can be received from the first electrical component through or along the electrical transmit interposer 23. The method can further include the step of converting the electrical transmit signals to optical transmit signals in the photonic integrated circuit 32. The optical transmit signals can be directed into the optical transmit coupler 27. The optical transmit signals can be transmitted in the optical transmit coupler 27 along the first transmit path 48, and reflected in the optical transmit coupler 27 along the second transmit path 50. The method can further include the step of outputting the optical transmit signals from the optical transmit coupler 27 to the optical transmit waveguides 36. The outputting step can include the step of reflecting the optical transmit signals off of the reflective transmitter surface 54.

The outputting step can further include the step of directing the optical transmit signals through the transmitter lens 58 before reflecting the optical signals off of the reflective transmit coupler surface 56. The step of directing the optical transmit signals through the lens 58 can include the step of causing light beams of the optical transmit signals to converge as they travel to the reflective transmit coupler surface 56. The method can further include the step of collimating the optical transmit signals prior to causing the optical transmit signal to so converge. Alternatively, the step of directing the optical transmit signals through the lens 58 can include the step of causing light beams of the optical transmit signals to converge as they travel to the reflective transmit coupler surface 56. The step of reflecting the optical transmit signals along the second transmit path 50 can include the step of causing light beams of the optical transmit signals to converge as they travel along the second path 50. Convergence of the light beam along second transmit path 50 may be accomplished by including optical power in at least one or both of lens 58 and reflective transmit coupler surface 56.

The present disclosure recognizes that environmental changes can impact the propagation of the optical transmit signals from the photonic integrated circuit 32 to the input ends of the optical transmit waveguides 36. For instance, thermal environmental changes can affect the alignment of light beams propagating through the optical transmit coupler 27. Temperature variations may result in misalignment resulting in either permanent or temporary degradation in the performance of optical transmitter 22. Accordingly, the present disclosure recognizes that it may be desirable to control an angular position of the reflector 52, and thus an orientation of the reflective transmitter surface 54, such that the second transmit path 50 is aligned with either or both of the lens 58 and the reflective transmit coupler surface 56. The step of adjusting the orientation of the reflective transmitter surface 54 can correspondingly adjust the direction of the second transmit path 50. The reflector 52, and thus the reflective transmitter surface 54, can be responsive to at least one or both of an electromagnetic and electrostatic force so as to adjust the orientation of the reflective transmitter surface 54 along perpendicular directions. Accordingly, the orientation of the reflective transmitter surface 54 can be adjusted to ensure that the optical transmit signals are sufficiently aligned with the optical transmit waveguides 36 as the optical transmit signals travel along the second and third transmission paths 50 and 51.

In one example, as illustrated in FIGS. 3F-3G, the reflector 52 can be a micro-electromechanical systems (MEMS) structure 53. For instance, a silicon substrate carrying the MEMS reflector 52 can be mounted to the second transmit interconnect member surface 41b. In one example, the reflector 52 can be defined by the transceiver substrate 26 which can be configured as a MEMS substrate. Thus, the transceiver substrate 26 can be made of silicon or any alternative material suitable for MEMS fabrication. For instance, the reflector 52 can be created by deposition onto the transceiver substrate 36 and selective etching as appreciated by one having ordinary skill in the art. Alternatively, the reflector 52 may be mounted on to the second transmit interconnect member surface 41b in any manner as desired. For instance, a silicon substrate carrying the MEMS reflector 52 can be mounted to the second transmit interconnect member surface 41b.

In one example, the reflective transmitter surface 54 can be concave, such that light beams of the optical transmit signal converge as they travel along the second transmit path. Further, the light beams of the optical transmit signal can converge after they travel through the transmitter lens 58. In another example, the reflective transmitter surface 54 can be substantially planar, such that the reflective transmitter surface 54 does not cause the light beams of the optical transmit signal to converge or diverge. In one example, the light beams of the optical transmit signal can be collimated as they travel along the second path. The transmitter lens 58 can also include a collimating lens as described above.

While the transmit interconnect member 40 has been described in the transmitter 22 including a photonic integrated circuit 32, it should be appreciated that the optical transmitter engine 30 can be constructed in accordance with any suitable alternative embodiment that converts electrical signals to optical signals and outputs the optical signals to the interposer 23 along the first transmit path 48 as described above. For instance, in one example, the optical transmitter engine 30, and thus the transmitter 22, can include a light source, and a modulator driver that is external of the light source. The modulator driver is configured to modulate the light source based on the incoming electrical signal, and in particular based on the voltage levels of the incoming electrical signal. The light source can be a steady state light source, such as a VCSEL that is modulated by changing its current.

It should be appreciated that the optical transmitter 22 can be mountable to any suitable platform. For instance, the optical transmitter 22 can be mounted onto a mid-board module or a front panel mounted module. In one example, the optical transmitter 22 can be mounted on a daughter board, a multi-source-agreement (MSA) optical transceiver such as quad small form factor pluggable (QSFP) transceiver, an application specific integrated circuit (ASIC) interposer, or in an on-board transceiver of the type described herein. In some embodiments, the transmit waveguide coupler 38 may comprise a material that has a coefficient of thermal expansion substantially matched to that of one or both of the transmit interconnect member 40 and the photonic integrated circuit 32.

Further, the transceiver 20 can include a controller 42 that is in electrical communication with the photonic integrated circuit 32. The controller 42 can be configured as a microprocessor in one example. The controller 42 can be mounted to the substrate 26, and can be programmed to control the operation of either or both of the optical transmitter 22 and the optical receiver 24. For instance, the controller 42 can control the light modulation characteristic of the modulator driver 25. Such characteristics include, but are not limited to, the high/low extinction ratio, signal pre-compensation, balancing phases in the arms of a Mach Zehnder modulator. The controller 42 can further control a current-to-voltage converter 66 of the receiver 24 that conditions the optical receive signals. For example, the controller 42 can control operation of the current-to-voltage converter thereby placing it in an operating state suitable to receive incoming optical receive signals.

The controller 42 can also communicate squelch signals arising from no incoming optical receive signal from other elements in the data processing system as is described in U.S. Patent Application Publication No. 2016/0109667 filed on Oct. 16, 2015, the disclosure of which is hereby incorporated by reference as if set forth in its entirety herein. The controller 42 may also help in estimating the remaining lifetime of the transceiver as described in U.S. Patent Application Publication No. 2016/0116368 filed on Oct. 23, 2016, the disclosure of which is hereby incorporated by reference as if set forth in its entirety herein.

Referring now to FIGS. 2A, 2B and 4-6, the optical receiver 24 is configured to receive optical receive signals from the second component, convert the optical receive signals to electrical receive signals, and output the electrical receive signals to the first electrical component when the optical transceiver 20 is mated with the first electrical component. The receiver 24 can include an optical engine that is configured as an optical receiver engine 62. The optical receiver engine 62 can include at least one photodetector 64 that is in optical alignment with a corresponding at least one optical receive waveguide 60, and a current-to-voltage converter 66 that is in electrical communication with the at least one photodetector 64. For instance, the optical receiver engine 62 can include a plurality of photodetectors 64 that are each in optical alignment with a respective one of the plurality of optical receive waveguides 60. It can thus be said that the photodetectors 64 place the optical receive waveguides 60 in data communication with the current-to-voltage converter 66.

The optical receive waveguides 60 receive the optical receive signals from the second component. The photodetectors 64, in turn, are configured to receive optical receive signals from the respective optical receive waveguide 60. As will be appreciated from the description below, the optical receive signals can travel from the optical receive waveguides 60 to the photodetectors 64 without passing through any waveguides or other intervening optical structure.

As described above, it is recognized that photodetectors of silicon photonics chips can be polarization sensitive, thereby causing complexities when the silicon photonics chip is integrated into the optical receiver. Accordingly, in some embodiments the photodetectors 64 are used that are in optical communication with optical receive waveguides 60 without use of an intervening photonic integrated circuit. Thus, it should be appreciated that the photodetectors 64 are physically spaced from the photonic integrated circuit 32 of the transmitter 22. For instance, the photodetectors 64 can be physically spaced from the photonic integrated circuit 32 of the transmitter 22 along a direction that is perpendicular to the transverse direction T. Thus, the optical signal propagation from the optical receive waveguides to the photodetectors 64 can be referred to as free space propagation. The optical receive signals can be sent from the second component to the transceiver 20.

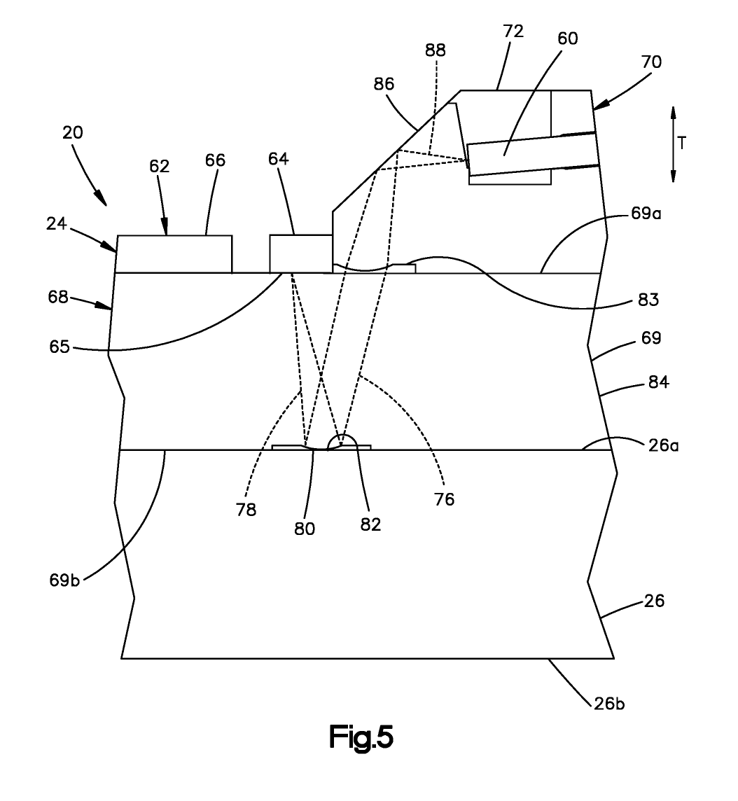

The photodetectors 64 may be surface sensitive photodetector in which incoming photons strike an active region 65 of the photodetector 64 at a normal or near-normal angle of incidence. Such a detector architecture can be advantageous since it provides a small volume absorption region. Since light is striking the active region 65 at a normal or near-normal angle of incidence, the photodetector 64 is polarization insensitive. The active region 65 can have a low electrical capacitance, thereby allowing for high bandwidth operation. It should be appreciated, of course, that photodetectors having alternatively configured active regions are contemplated by the present disclosure. The surface sensitive active regions 65 (see FIG. 5) are configured to receive the optical receive signals from an output end of the respective one of the optical receive waveguides 60.

While the optical receive signals can travel from the optical receive waveguides 60 to the photodetectors 64 without passing through any waveguides in one example, in another example one or more intervening optical elements may be situated between the optical receive waveguides 60 and the photodetectors 64. These intervening optical elements may include one or more of mirrors, lenses, transparent substrates, transparent couplers, and optical waveguides that collectively serve to provide an optical path between the optical receive waveguides 60 and the photodetectors 64. While the optical path is more complex in the embodiments using multiple optical elements, they may improve mode matching and relax alignment tolerances between the optical receive waveguides 60 and the photodetectors 64. The high coupling efficiency may advantageously be maintained over a large operating temperature range.

As described above, the active region 65 can be oriented so as to receive the optical receive signal from an output end of the optical receive waveguide. In some embodiments, a lens can be situated on the opposing side of the photodetector die from the active region 65. The incoming optical receive signals pass through the lens, the photodetector die, and are absorbed in the active region 65. The photodetectors 64 are further configured to convert the optical receive signals to corresponding electrical receive signals. The electrical receive signals can have current levels that are proportional with the quantity of optical photons of the received optical receive signal. Generally the photo generated current increases as the intensity of the incoming optical receive signal increases, and decreases as the intensity of the incoming optical receive signal decreases. It is recognized that the current levels of the electrical receive signals are not necessarily linearly proportional to the quantity of optical photons of the received optical receive signal, and that often the proportionality is nonlinear. Thus, optical receive signals having a higher intensity, or number of incident optical photons per unit time, will be converted to an electrical signal having higher current levels than optical receive signals having a lower number of optical photons. Data may be transmitted by this modulated optical and electrical signal.

Each of the photodetectors 64 can be fabricated in a dedicated die that are each, in turn, supported by the substrate 26 of the transceiver 20. Alternatively, at least some of the photodetectors 64 can be fabricated in a common die that is supported by the substrate 26. In one example, all of the photodetectors can be fabricated in a common die that is supported by the substrate 26. The die may be formed from InGaAs or any suitable semiconductor material capable of absorbing light and outputting an electrical current in response to the absorbed light. Alternatively still, one or more of the photodetectors 64 up to all of the photodetectors 64 and the current-to-voltage converter 66 can be fabricated on a common die. Thus, the current-to-voltage converter can be supported by a common structure that also carries the photodetectors 64.

The optical receiver 24, and thus the optical transceiver 20, can include a receive interconnect member 68 that is configured to be supported by the substrate 26. In one example, the receive interconnect member 68 can be mounted to the substrate 26. In particular, the receive interconnect member 68 can be mounted to the first surface 26a of the substrate 26. For instance, the receive interconnect member 68 can define a first receive interconnect member surface 69a and a second receive interconnect member surface 69b opposite the first receive interconnect member surface 69a along the transverse direction T. The second receive interconnect member surface 69b can face the first substrate surface 26a. In particular, the second interconnect member surface 69b can be mounted to the first substrate surface 26a so as to place the receive interconnect member 68 in electrical communication with the substrate 26. The first receive interconnect member surface 69a can define an upper surface, and the second receive interconnect member surface 69b can define a lower surface. The first surface 69a is thus spaced from the second surface 69b in the upward direction. Similarly, the second surface 69b is spaced from the first surface 69a in the downward direction.

As will be described in more detail below, the receive interconnect member 68 can define an electrical receive interposer 74. Alternatively, the receive interconnect member 68 can define an optical receive coupler 84. Alternatively still, the receive interconnect member 68 can define both an electrical receive interposer 74 and an optical receive coupler 84. Accordingly, the receive interconnect member 68 can be configured to communicate with either or both of 1) electrical signals between the photodetectors 64 and the substrate 26 (and thus also between the current-to-voltage converter 66 and the substrate 26), and 2) optical signals between the optical receive waveguides 60 and the photodetectors 64 (and thus also between the optical receive waveguides and the current-to-voltage converter 66). Reference herein to the electrical receive interposer 74 can apply equally to the receive interconnect member 68 unless otherwise indicated. Further, reference herein to the optical receive coupler 84 can apply equally to the receive interconnect member 68 unless otherwise indicated.

The optical receive coupler 84 can be optically transparent so as to allow optical signals to pass therethrough. For instance, the receive interconnect member, and thus the optical receive coupler 84, can include a receive interconnect substrate 69 that is made from an optically transparent material. In one example, the substrate 69 can be a monolithic substrate. In another example, the substrate 69 can be made of more than one material joined to each other. The transparent material can comprise glass, silicon, or any alternative suitable material. As is further described in more detail below, optical receive signals can travel through the optically transparent material of the optical receive coupler 84. Thus, the optically transparent material of the optical receive coupler 84 can be said to be optically conductive, and can conduct the optical receive signals. Accordingly, the optical receive coupler 84 can be configured to transmit the optical receive signals from the receive waveguides 60 to the photodetectors 64 through the optically transparent material of the optical receive coupler 84. Alternatively, as will be described in more detail below, the optical receive coupler 84 can define optical channels that extend therein or therethrough, and are configured to transmit the optical receive signals.

In particular, the optical receive coupler 84 is configured to transmit the optical receive signals from a receive waveguide assembly 70 to the photodetectors 64, such that the optical receive signals are received by the active regions of the photodetectors 64. The receive waveguide assembly 70 can include the optical receive waveguides 60 and a receive waveguide coupler 72 that is configured to support the optical receive waveguides 60 in optical alignment with the active regions 65 of the photodetectors 64. The receive waveguide coupler 72, the photodetectors 64, and the current-to-voltage converter 66 can each be disposed on the first receive interconnect member surface 69a. The receive waveguide coupler 72 can be referred to as a receive fiber coupler when the optical receive waveguides 60 are configured as optical fibers. Similarly, the receive waveguide assembly 70 can be referred to as a receive fiber assembly when the optical receive waveguides 60 are configured as optical fibers. The receive waveguide coupler 72 can be made from glass, silicon, ceramic, plastic or any suitable alternative material. In one example, the receive waveguide coupler 72 can be configured as a molded optical structure (MOS) that couples one or both of the substrate 26 and the receive interconnect member 68 to the optical receive waveguides 60. In one example, each of the current-to-voltage converter 66, the photodetectors 64, and the receive waveguide coupler 72 can be mounted onto the receive interconnect member 68 so as to place the receive waveguides 60 in optical communication with the photodetectors 64, to place the current-to-voltage converter 66 in electrical communication with the photodetectors 64, and to place the in electrical communication with the substrate 26.

When the receive interconnect member 68 includes both of the optical receive coupler 84 and the electrical receive interposer 74 as a single unitary structure, the optical receive coupler 84 and the electrical receive interposer 74 can be referred to as monolithic with each other. The optical receive coupler 84 and the electrical receive interposer 74 can be monolithic with each other even though the electrical receive interposer 74 can include electrically conductive paths that travel along or through the optically conductive material of the receive interconnect member. Thus, the electrical receive interposer 74 can be made from the same optically transparent material as the optical receive coupler 84. In this regard, the receive interconnect member 68 can also be referred to as monolithic since the optically transparent material at the optical receive coupler 84 can be the same material that supports the electrically conductive paths at the electrical receive interposer 74. In still other embodiments, the optical receive coupler 84 and the electrical receive interposer 74 can be separate structures. When the optical receive coupler 84 and the electrical receive interposer 74 are monolithic with each other, the receive interconnect member 68 can include an optically conductive region defined by the optical receive coupler 84, and an electrically conductive region defined by the electrical receive interposer 74. The optically conductive region and the electrically conductive region can be spaced from each other, or can be defined by a common overlapping region of the receive interconnect member 68.

Because the receive interconnect member 68 can include the optical receive coupler 84, the receive interconnect member 68 can be at least partially or entirely defined by the substrate 69 that is made of the optically conductive material. In some embodiments, the receive interconnect member 68 can define the optical receive coupler 84 and not the electrical receive interposer 74, such that the receive interconnect member 68 has only an optical function. Thus, in these embodiments the electrical receive signals do not pass through the optical receive interconnect member 68. Rather, the electrical transmit signals pass through any suitable alternative structure so as to travel from the current-to-voltage converter 66 to the electrical contacts 28. Alternatively or additionally, the receive interconnect member 68 can define the electrical receive interposer 74 that is configured to conduct electrical signals between the current-to-voltage converter 66 and the substrate 26.

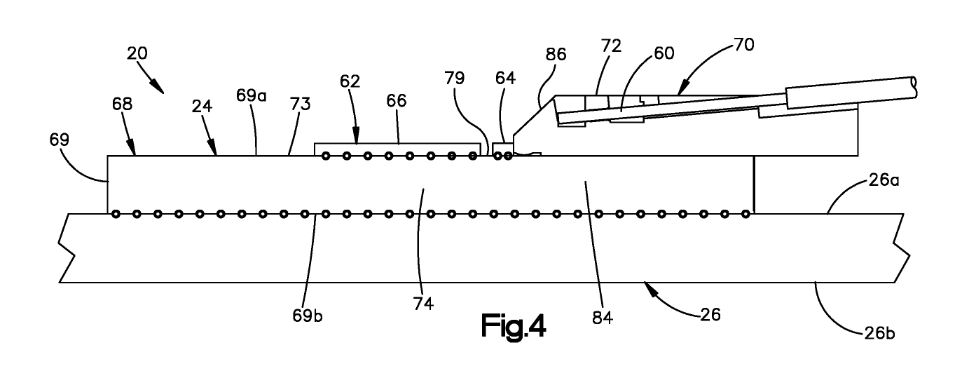

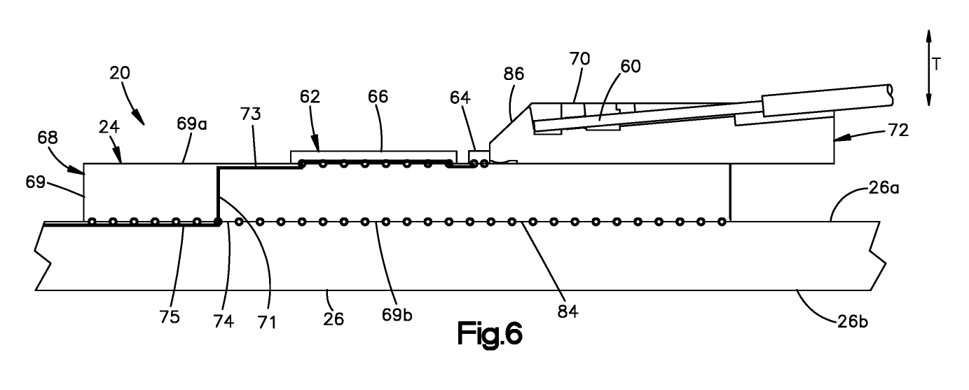

For instance, as illustrated in FIG. 4, the electrical receive interposer 74 can include one or more of electrical vias 71 and a redistribution layer 73 to route electrical signals from the current-to-voltage converter 66 to the vias 71. Thus, the electrical signals can be routed from the vias 71 to the substrate 26. In this example, the electrical vias 71 can be configured as apertures that extend at least into or through the optically transparent material of the substrate 69. The apertures can be at least partially or entirely filled or plated with an electrically conductive material so as to define an electrically conductive path between first and second surfaces of the electrical receive interposer 84, which can be defined by the opposed surfaces 69a and 69b, respectively. In one example, the electrically conductive material can be configured as a cured electrically conductive paste. The paste can be fired after deposition in the apertures of substrate 69. The paste can be inserted into the apertures using thick film technology. The vias 71 can be constructed as described in U.S. Pat. No. 9,374,892, which is hereby incorporated by reference as if set forth in its entirety herein. It should be appreciated that one via 71 is illustrated in FIG. 6 as representative of the plurality of vias 71 described herein. The optical receiver 24 can be mounted to the first surface 26a so as to place the plurality of electrical conductors of the electrical receiver interposer 74 in electrical communication with respective ones of the second group of electrical conductors of the substrate 26.

The redistribution layer 73 can be electrically connected between the vias 71 and the current-to-voltage converter 66. Thus, the vias 71 are placed in electrical communication with the current-to-voltage converter 66 through the redistribution layer 73. The redistribution layer 73 can thus provide an electrically conductive path between the vias 71 and respective channels of the current-to-voltage converter 66. It is appreciated that the optical receive signals are received from respective ones of the optical receive waveguides 60 along respective channels that are conducted to respective ones of the photodetectors 64. The photodetectors 64 output the corresponding electrical transmit signals to respective channels of the current-to-voltage converter 66. In particular, the receiver 24 can include an electrical conductor 79 connected between the photodetectors 64 and the current-to-voltage converter 66, such that the photodetectors are configured to output the electrical receive signal to the current-to-voltage converter 66 along the electrical conductor. For instance, the receiver 24 can include electrical traces that run from the photodetectors to the current-to-voltage converter 66. The electrical traces can, for instance, run along or through the receive interconnect member 68. Alternatively, the photodetectors 64 can be wire bonded to the current-to-voltage converter 66.

The current-to-voltage converter 66 can be configured to receive the electrical receive signals from the photodetectors 64, condition the electrical receive signal, and output the conditioned electrical receive signal. In one example, the current-to-voltage converter 66 is a transimpedence amplifier (TIA) that amplifies the electrical receive signal to voltage levels that are usable for communication with the first electrical component. The photodetector 64 can be a PIN photodiode (named after its P-doped, Intrinsic, and N-doped junction structure) that is in turn coupled to an ultra-low noise, very high gain trans-impedance amplifier which modifies the received photodiode current into an electrically compatible voltage output. In one example, the voltage output can be a differential voltage output. The TIA output can typically incorporate a limiting amplifier (LA) stage and equalization circuitry such as pre and/or de-emphasis. Advanced functionality such as loss of optical signal detection (LOS), received optical power and squelch might also be implemented.

Thus, the electrical receive signals output by the current-to-voltage converter 66 are the electronic equivalent of the optical signals received by the photodetectors 64. Thus, the electrical receive signals output by the current-to-voltage converter 66 can mimic the digital patterns of the received optical patterns in an electrical signal. The current-to-voltage converter 66 outputs the conditioned electrical transmit signals from the respective channels to corresponding ones of the second plurality of electrical contacts 28.

The at least one redistribution layer 73 can extend along the first receive interconnect surface 69a from a first location aligned with the current-to-voltage converter 66 along the transverse direction T to a second location aligned with the vias 71 along the transverse direction T. For instance, the redistribution layer 73 can be supported by the first receive interconnect member surface 69a. In one example, the redistribution layer 73 can be fabricated onto the first receive interconnect member surface 69a. Thus, the redistribution layer 73 can be disposed between the first transmit interconnect surface 69a and the current-to-voltage converter 66 with respect to the transverse direction T. The at least one redistribution layer 73 can be in contact with each of the vias 71 and the current-to-voltage converter 66 so as to conduct the electrical receive signals from the respective channels of the current-to-voltage converter 66 to the aligned ones of the vias 71.

Thus, the receiver 24 can define a plurality of electrical paths 75 from the current-to-voltage converter 66 to respective ones of the electrical contacts 28. The electrical paths 75 can further electrically connect the photodetectors 64 to the current-to-voltage converter 66. It should thus be appreciated that the transceiver 20 can define a plurality of electrical paths 75 from the respective ones of the electrical contacts 28 of the substrate 26 to at least one electrical component which can be defined by one or both of the current-to-voltage converter 66 and the photodetectors 64. In one example, the respective ones of the second group of electrical contacts 28 can define signal contacts. Thus, the electrical paths 75 can extend from respective channels of the current-to-voltage converter 66, along the receive interconnect member 68 in the redistribution layer 73, and along a respective one of the vias 71 to a respective one of electrical conductors of the substrate 26, and finally to a respective one of the electrical contacts 28. Thus, when the substrate 26 is mated with the first electrical component, the first electrical component is placed in electrical communication with the current-to-voltage converter 66.

When the receive interconnect member 68 includes the electrical receive interposer 74, the second interconnect surface 69b can be mounted to the first substrate surface 26a so as to place the electrical receive interposer 74, and thus the receive interconnect member 68, in electrical communication with the substrate 26. Thus, the electrical vias 71 that define electrical conductors of the electrical receive interposer 74 can be placed in electrical communication with the second group of electrical contacts 28 of the substrate 26.

The electrical receive interposer 74, and thus the receive interconnect member 68, can be surface mounted to the substrate 26 in one example. For instance, flip-chip technology, such as use of a ball grid array, copper pillars, or stud bumps, may be used to mount the electrical receive interposer 74, and thus the receive interconnect member 68, to the substrate 26. In one example, the substrate 26 can include an array of electrically conductive lands 46 at the first substrate surface 26a that are configured to be placed in contact with the electrically conductive vias 71 at the second interconnect surface 69b when the electrical receive interposer 74 is mounted to the substrate 26. The lands 46 are in electrical communication with respective ones of the second group of electrical conductors, and are thus in electrical communication with the corresponding respective ones of the electrical contacts 28. The lands 46 can be configured as a ball grid array (BGA). Thus, when the electrical receive interposer 74 is mounted to the substrate 26, the electrically conductive vias 71 can be mounted onto respective ones of the lands 46, such that the lands 46 establish an electrical connection with the electrically conductive material of the vias 71. The vias 71 are further placed in electrical communication with the current-to-voltage converter 66, such that the current-to-voltage converter 66 is in electrical communication with the respective electrical contacts 28 of the substrate 26.

Thus, it should be appreciated that the electrical receive interposer 74 can be mounted to the substrate 26 such that the current-to-voltage converter 66 is placed in electrical communication with the second group of electrical contacts 28 of the substrate 26. In particular, the electrical receive interposer 74 can include a plurality of electrical conductors that are in electrical communication with the current-to-voltage converter 66. The electrical conductors of the electrical receive interposer 74 can further be placed in electrical communication with respective ones of the second group of electrical conductors of the substrate 26 when the electrical receive interposer 74 is mounted to the substrate 26.

Flip-chip technology, such as use of a ball grid array, copper pillars, or stud bumps, may also be used to mount one or both of the current-to-voltage converter 66 and the photodetectors 64 to the receive interconnect member 68. Flip-chip technology can also be used to mount the receive interconnect member 68 to the substrate 26.

In one example, the receive interconnect member 68 can define a thickness along the transverse direction T from the first receive interconnect member surface 69a to the second receive interconnect member surface 69b that is between approximately 125 microns and approximately 2 mm. For instance, the thickness can be between 250 microns and approximately 1 mm. In one example, the thickness scan be approximately 500 microns. The second interconnect surface 69b can be mounted to the first substrate surface 26a so as to place the receive interconnect member 68 in electrical communication with the substrate 26.

It should be appreciated, of course, that the electrical receive interposer 74 can be configured in accordance with any suitable alternative embodiment so as to place the electrical receive interposer 74 in electrical communication with the second group of the electrical contacts 28. As just one example, the substrate 26 can define electrically conductive vias that extend into the first surface 26a, and the electrically conductive material of the electrical receive interposer 23 can extend into the vias of the substrate 26 so as to place the receive interposer 74 in electrical communication with the substrate 26.

With continuing reference to FIGS. 2A, 2B, and 4-5, the receive waveguide assembly 70 can include the optical receive waveguides 60 and the receive waveguide coupler 72 that supports the receive waveguides 60. In particular, the receive waveguide coupler 72 is configured to support the optical receive waveguides 60 such that output ends of the optical receive waveguides 60 are in optical alignment with the active regions 65 of the respective photodetector 64. Thus, the output ends of the optical receive waveguides 60 are configured to transmit the optical receive signals to the photodetectors 64. Each of the current-to-voltage converter 66 and the photodetectors 64 can be mounted onto the receive interconnect member 68. The receive waveguide coupler 72 can also be mounted onto the receive interconnect member 68. The receive interconnect member 68, in turn, can be mounted to the substrate 26, for instance to the first substrate surface 26a. Alternatively, the receive waveguide coupler 72 can be mounted directly on the substrate 26.

The receive waveguide coupler 72 supports the optical receive waveguides 60 such that the output ends of the optical receive waveguides 60 are in optical alignment with the respective ones of the photodetectors 64. In particular, as described above, the receive interconnect member 68 can include the optical receive coupler 84 that is configured to conduct the optical transmit signals along a transmission direction from the optical receive waveguides 60 toward the active regions 65 of the photodetectors 64. In one example, the optical receive coupler 84 can be configured to receive the optical receive signals from the optical receive waveguides 60, and direct the optical receive signals along at least one optically transmissive path of the optical receive coupler 84 toward the receiver engine 62. In one example, the optical receive coupler 84 can be configured to receive the optical receive signals from the optical receive waveguides 60, and direct the optical receive signals along at least one optically transmissive path of the optical receive coupler 84 toward the photodetectors 64. In particular, the optical receive coupler 84 can be configured to receive the optical receive signals from the optical receive waveguides 60 along respective first receive paths 76, and redirect the optical receive signals toward the photodetectors 64 along corresponding second receive paths 78 that are different than the first receive paths 76. The photodetectors 64 can be oriented such that the active regions 65 of the photodetectors 64 face the optical receive coupler 84 so as to receive the optical receive signals that travel through the optical receive coupler 84 along the second optical receive paths 78.

It should be appreciated that the optical receive coupler 84 can be constructed generally as described above with respect to the optical transmit coupler 27. Thus, the optical receive coupler 84 can be fabricated from an optically transparent material, such that the optical receive signals can propagate through the transparent material along the first and second receive paths 76 and 78. The first and second receive paths 76 and 78 are indicated by opposed dashed lines that represent boundaries of the first and second paths 76 and 78, respectively.

It is recognized that the optical receive coupler 84 can have less than 100% optical transparency so long as the optical receive signals can suitably propagate through the first and second receive paths 76 and 78 in the manner described herein. In one example, the transparent material can be glass. For instance, the optical receive coupler 84 can include a substrate 69 that is made of glass or silicon.

Alternatively, the optical receive coupler 84 can further be made from an optically translucent or optically opaque material, but can define the optically transparent first and second receive paths 76 and 78. For instance, the optical receive coupler 84 can be made of an optically translucent or opaque material, and optically transparent channels can extend through the optical receive coupler 84 so as to define the first and second receive paths 76 and 78. Thus, the first and second receive paths 76 and 78 can be air paths that extend through the substrate 69 of the receive interconnect member 68, such that the optical receive signals propagate through air along the first and second receive paths 76 and 78. Alternatively, the channels can be filled with an optically transparent material, such as glass or silicon. Thus, the receive interposer substrate 69 can be made of an optically transparent material, an optically translucent material, or an optically opaque material whereby the electrical transmit interposer 23 defines at least one receive path that conducts the optical receive signals from the receive waveguides 60 to an optical-to-electrical converter. The optical-to-electrical converter can be configured as the photodetectors 64.

The first receive path 76 can extend in a direction from a respective origination surface that can be defined by a receive first surface or input surface of the optical receive coupler 84. The receive input surface can, in one example, be defined by an outer surface of the optical receive coupler 84. In particular, the receive input surface can be defined by the first interconnect surface 69a. Thus, the first receive path 76 can extend from the first interconnect surface 69a toward the second interconnect surface 69b. The second receive path 78 can extend in a direction from the first receive path 76 toward a respective receive termination surface that can be defined by a second surface or output surface of the receive interconnect member 68. The receive output surface can be defined by an outer surface of the optical receive coupler 84. In one example, the receive output surface can be defined by the same surface as the receive input surface. Thus, the receive input surface and the receive output surface can be defined by a common surface of the optical receive coupler 84. For instance, the receive output surface can be defined by the first transmit interconnect member surface 69a. Accordingly, the second receive path 78 can extend in a direction from the second interconnect surface 69b toward the first interconnect surface 69a. As will be appreciated from the description below, the receive input surface and the receive output surface can alternatively be defined by different surfaces of the optical receive coupler 84. The second receive path 78 can extend in a direction from the second interconnect surface 69b toward the receive output surface. For instance, the second receive path 78 can extend from the first receive path 76 to the receive output surface. Thus, the optical receive coupler 84 can be configured to redirect the optical transmit signals from the first receive path 76 toward the photodetectors 64 along the second receive path 78. The first receive path 76 can extend along an angle of incidence, and the second receive path 78 can extend along an angle of reflection.

The optical receive coupler 84 can include at least one reflector 80 that is aligned with a corresponding at least one of the first receive paths 76. For instance, the optical receive coupler 84 can include a plurality of reflectors 80 that are each aligned with a corresponding one of the first receive paths 76. Alternatively, the receiver 24 can include a single reflector 80 that is aligned with each of the first receive paths 48. The at least one reflector 80 is configured to reflect the optical receive signal from the first receive paths 76 to the corresponding second receive paths 78. The at least one reflector 80 can be supported by the second interconnect surface 69b. Alternatively, the at least one reflector 80 can be embedded in the body of the optical receive coupler 84.

Thus, the first receive path 76 can extend to a reflective receiver surface 82 of the reflector 80, and the second receive path 78 can extend from the reflective receiver surface 82. The reflective receiver surface 82 can be planar. Alternatively, the reflective receiver surface 82 can be curved. The optical receive coupler 84 can be configured such that the light beams of the optical receive signals converge or diverge as they travel along the second receive path 78. As will be appreciated from the description below, the receiver 24 can include at least one or more receiver lenses 83 that can condition the light beams of the optical receive signals. In one example, the reflector 80 can be deposited onto the second receive interconnect member surface 69b. Alternatively, a photolithographic process can apply the reflector 80 to the second receive interconnect member surface 69b. Alternatively still, the reflector 80 can be fabricated on a separate substrate, and the reflector 80 can be positioned below and carried by the second receive interconnect member surface 69b. The reflector 80 can be an angularly fixed reflector or can be angularly adjustable as described below.

The first receive path 76 can enter the optical receive coupler 84 at a surface of the optical receive coupler 84, and the second receive path 78 can exit the optical receive coupler 84 at the same surface of the optical receive coupler 84. The surface can be defined by the first interconnect surface 69a. The angle of incidence of the first receive path 76 to the reflective received surface 82 can be less than approximately 35 degrees. For instance, the angle of incidence can be between approximately 10 degrees and approximately 30 degrees. In one example, the angle of incidence can be between approximately 15 degrees and approximately 20 degrees. Thus, the first and second receive paths 76 and 78 can define an angle less than approximately 70 degrees. For instance, the angle defined by the first and second receive paths 76 and 78 can be between approximately 20 degrees and approximately 60 degrees. In one example, the angle defined by the first and second receive paths 76 and 78 can be between approximately 30 degrees and approximately 40 degrees.

Further, the reflective receiver surfaces 82 can be shaped as desired so as to condition the light beams of the optical receive signals. The reflective receiver surface 82 can face the substrate 69 of the optical receive coupler 84. In this regard, the reflective receiver surface 82 can be said to face the first receive interconnect member surface 69a. The reflective receiver surface 82 can be metallic or made from any suitable alternative reflective material as desired. The reflective receiver surface 82 can be concave, such that light beams of the optical receive signal converge as they travel along the second receive path 78. It may be desirable to cause the light beams of the optical receive signal to converge in order to ensure that most or all of the optical beam overlaps with the active regions 65 of the photodetectors 64. In another example, the reflective receiver surface 82 can be substantially planar, such that the reflective receiver surface 82 does not alter the convergence or divergence of the light beams of the optical receive signal. This may be suitable, for instance, when other elements in the optical system cause most or all of the optical beam to overlap the active regions 65 of the photodetectors 64, i.e. the optical beam size is smaller than or comparable to the size of the active region.

The present disclosure recognizes that environmental changes can impact the alignment of the optical transmit signals from the optical receive waveguides 60 to the photodetector 64. For instance, thermal environmental changes can result in differential thermal expansion between the various elements of the receiver 24 resulting in misalignment and poor transmission between the receive waveguides 60 and photodetectors 64. Accordingly, the present disclosure recognizes that it may be desirable to control an angular position of the reflector 80, and thus an orientation of the reflective receiver surface 82, such that the second receive path 78 is aligned with the active regions 65 of the photodetectors 64. The step of adjusting the orientation of the reflective receiver surface 82 can correspondingly adjust the direction of the second receive path 78. The reflector 80, and thus the reflective receiver surface 82, can be responsive to at least one or both of an electromagnetic and electrostatic force so as to adjust the orientation of the reflective receiver surface 82 along perpendicular directions. Accordingly, the orientation of the reflective receiver surface 82 can be adjusted to ensure that the optical receive signals are sufficiently aligned with the active regions 65 of the photodetectors 64 as the optical transmit signals travel along the second receive path 78. In one example, the reflector 80 can be a micro-electromechanical systems (MEMS) structure. For instance, the reflector 80 can be defined by the transceiver substrate 26 which can be configured as a MEMS substrate. Thus, the transceiver substrate 26 can be made of silicon or any alternative material suitable for MEMS fabrication. For instance, a silicon substrate carrying the MEMS reflector 80 can be mounted to the second transmit interconnect member surface 41b. In one example, the reflector 80 can be created by deposition onto the transceiver substrate 26 and selective etching as appreciated by one having ordinary skill in the art. Alternatively, the reflector 80 may be mounted on to the second side of transmit interposer 23.

The receive interconnect member 68 can be disposed between the substrate 26 and each of the photodetectors 64, the current-to-voltage converter 66, and the receive waveguides assembly 70, including the receive waveguide coupler 72 and the optical receive waveguides 60, with respect to the transverse direction T. The first receive interconnect member surface 69a can face each of the current-to-voltage converter 66, the photodetectors 64, and the receive waveguides assembly 70, including each of the optical receive waveguides 60 and the receive waveguide coupler 72. For instance, the receive waveguide coupler 72 can be mounted onto the receive interconnect member 68. In one example, the receive waveguide coupler 72 can be disposed on the first receive interconnect member surface 69a. Similarly, the current-to-voltage converter 66 can be mounted onto the receive interconnect member 68. In one example, the current-to-voltage converter 66 can be disposed on the first receive interconnect member surface 69a. Similarly, the photodetectors 64 can be mounted onto the receive interconnect member 68. In one example, the photodetectors 64 can be disposed on the first receive interconnect member surface 69a.

As described above, the first receive paths 76 of the optical receive signals can be in optical alignment with an output end of respective optical receive waveguides 60. In particular, the receiver 24 can include a reflective receive coupler surface 86 that is aligned with both the output ends of the optical receive waveguides 60 and the first receive paths 76. That is, the reflective receive coupler surface can be aligned with both the output ends of the optical receive waveguides 60 and the reflective receiver surfaces 82. Thus, the reflective receive coupler surface 86 can be configured to receive the optical receive signals from the receive waveguides 60 along a third receive path 88 that is different than each of the first receive path 76 and the second receive path 78. The third receive path 88 is indicated by opposed dashed lines that represent boundaries of the third receive path 88.

The reflective receive coupler surface 86 can reflect the optical receive signals received along the third receive path 88 to redirect the optical receive signals along the first receive path 76 that extends into the optical receive coupler 84 in the manner described above.

Thus, it should be appreciated that the reflective receive coupler surface 86 is oriented non-parallel with respect to the first receive path 76. For instance, the reflective receive coupler surface 86 can be oriented along a plane that is angularly offset with respect to the first receive path 76. In one example, the reflective receive coupler surface 86 can be oriented along a plane that defines an angle between 25 degrees and 65 degrees with respect to the transverse direction T, such as between 35 degrees and 55 degrees with respect to the transverse direction T, and in one example can be between 40 degrees and 50 degrees with respect to the transverse direction T. With respect to the reflective receive coupler surface 86, the third receive path 88 extends along an angle of incidence, and the first receive path 76 extends along an angle of reflection. The reflective receive coupler surface 86 can be defined by the receive waveguide coupler 72, and can be monolithic with a support portion of the receive waveguide coupler 72 that supports the optical receive waveguides 60. While the receiver 24 can include one receive coupler surface 86 that is aligned with each of the receive waveguides 60 and each of the reflectors 80, it should be appreciated that the receiver 24 can alternatively include a plurality of reflective receive coupler surfaces 86 that are each aligned with a respective one of the receive waveguides and a respective aligned one of the reflectors 80. In some embodiments, the reflective transmit coupler surface 86 can be oriented for total internal reflection of the third receive path 88. In other embodiments a metallic or dielectric layer may be incorporated in reflective receive coupler surface 86. The receive waveguide coupler 72 may be formed from any suitable optically transparent material, such as, but not limited to, silicon, glass and plastic.

With continuing reference to FIG. 5, the receiver 24 can further include a receiver lens 83 that is disposed downstream of the output end of the optical receive waveguides 60 with respect to the direction of the optical transmit signal propagation. For instance, the receiver lens 83 can be disposed downstream of the reflective receive coupler surface 86 with respect to the direction of propagation of the optical receive signals. In one example, the receiver lens 83 can be disposed between the reflective receive coupler surface 86 and the reflector 80. Further, the receiver lens 83 can be aligned with each of the reflective receive coupler surface 86 and the reflector 80. The receiver lens 83 can be positioned at a location in alignment with the first receive path 76, such that the optical receive signals pass therethrough. In one example, the receiver lens 83 can be fabricated on the receive waveguide coupler 72. Thus, the receive waveguide coupler 72 can include the receiver lens 83. In another example, the receiver lens 83 can be carried by the receive waveguide coupler 72. Alternatively, the receiver lens 83 can be carried by the optical receive coupler 84. Alternatively still, the receiver lens 83 can be fabricated on the optical receive coupler 84. Thus, the optical receive coupler 84 can include the receiver lens 83.

The receiver lens 83 can be positioned such that the optical receive signals are directed to travel along the first transmit path from the reflective receive coupler surface 86, through the receiver lens 83, and to the reflector 80. In one example the receiver lens 83 can be a converging lens that causes the light beams of the optical receive signals to converge as they travel toward the reflectors 80 along the first receive path. Thus, the beam size of the optical receive signals at the photodetectors 64 can thus be smaller than or approximately match the size of the active region 65 of the photodetectors. In another example, the at least one receiver lens 83 can include a collimating receiver lens in combination with a converging lens that is positioned downstream of the collimating receiver lens and in alignment with the collimating receiver lens. Thus, the optical receiver signals can pass through the collimating receiver lens and then through the converging receiver lens. It is recognized that collimating the beams of the optical receiver signals can include relaxing the alignment tolerance between the optical receiver signals and the active region 65 of the photodetectors. The collimating lens and the converging lens can be positioned anywhere as desired. In one example, the collimating lens and the converging lens can be supported by the optical receive coupler 84, while the converging lens is disposed opposite the collimating lens. For instance, the converging lens can be supported by the receive waveguide coupler 72 or the optical receive coupler 84. While the collimating receiver lens can collimate the beams of the optical receive signal in one example, alternatively or additionally the reflective receiver surface 82 can define a collimating mirror or a converging mirror.

The optical receive signals can reflect off the respective reflectors 80 and propagate along the second receive path to the active regions of the aligned photodetectors 64. The receiver lens 83 can thus be configured such that the optical receive signals can be properly aligned with the active regions 65 of the respective photodetectors 64. The reflective receiver surface 82 can further be configured such that the optical receive signals can be properly aligned with the active regions 65 of the respective photodetectors 64. As described above, the photodetectors 64 convert the optical receive signals to electrical receive signals, and output the electrical receive signals to the current-to-voltage converter 66 that is in electrical communication with the photodetectors 64.

Thus, during operation, a method can be provided for processing data in the transceiver 20, and in particular in the receiver 24. The method can include the step of receiving optical receive signals from the optical receive waveguides 60. The method can further include the step of directing the optical receive signals to the receive interconnect member 68, and conducting the optical receive signals in the receive interconnect member 68 along the respective first receive paths 76. The step of directing the optical receive signals into the interconnect member 68 can include reflecting the optical receive signals off of the reflective receive coupler surface 86 of the waveguide coupler 72. The step of directing the optical receive signals into the receive interconnect member 68 can further include the step of directing the optical receive signals through the receiver lens 83 after reflecting the optical signals off of the reflective receive coupler surface 86. Thus, the step of directing the optical receive signals through the receiver lens 83 can include the step of directing the optical receive signals through the receiver lens 83 can include causing the light beams of the optical receive signals to converge as they travel along the first path. The step of directing the optical receive signals through the received lens 83 can further include the step of collimating the optical receive signals prior to causing the light beams of the optical receive signals to converge as they travel along the first path.

The method can further include the step of reflecting the optical receive signals in the receive interconnect member 68 along respective second receive paths that are different than the corresponding first receive paths. The first receive paths 76 are in a direction from the first interconnect surface 69a toward the second interconnect surface 69b. The first receive paths 76 can be defined by the receive waveguides assembly 70. For instance, the first receive paths 76 can be defined by the reflective receive coupler surface 86. The second receive paths 78 are in a direction from the second interconnect surface 69b toward the first interconnect surface 69a. The step of reflecting the optical receive signals along the second receive path can include the step of causing light beams of the optical receive signals to converge as they travel along the second receive path. It should thus be appreciated that the optical receive signals can propagate through the receive interconnect member 68 along the first and second receive paths 76 and 78 without passing through any waveguides. Thus, the optical signal propagation through the receive interconnect member 68 can be referred to as free space propagation. In one example, the receive interconnect member 68 can be devoid of optical waveguides. Alternatively, the receive interconnect member 68 can include waveguides that define at least some up to all of the first and second optical receive paths 76 and 78.

The step of reflecting the optical receive signals along the second path can include the step of adjusting an orientation of a reflective receiver surface 82 that performs the step of reflecting the optical receive signals along the second path. The method can further include the step of outputting the optical receive signals from the receive interconnect member 68 to respective ones of the photodetectors 64. The method can further include the step of converting the optical receive signals to electrical receive signals in the photodetectors 64. The method can further include the step of converting the electrical receive signals to voltage signals in the current-to-voltage converter 66.

Thus a method of data communication can include the steps of directing an optical signal into a body of an optical coupler along a first optically transmissive path; and after the directing step, reflecting the optical signal off of a reflector so that the optical signal travels along a second optically transmissive path in the body. The optical signals can be optical transmit signals or optical receive signals, as described above.

While the receiver 24 can include the receive interconnect member 68 as described above, it is recognized that other embodiments are envisioned so as to allow the optical receive signals to travel from the respective optical receive waveguides 60 to the active regions 65 of the photodetectors 64. For instance, the photodetectors 64 can be oriented such that the active regions 65 face the output ends of the respective ones of the receive waveguides 60. Thus, the optical receive signals can travel from the receive waveguides 60 to the photodetectors 64 along the receive path 88 without reflecting off the reflective receive coupler surface 86. In this embodiment, particularly with single mode optical signals, the photodetectors 64 can be spaced close enough to the output end of the optical receive waveguides 60 such that the optical receive signals can be aligned with the active region of the photodetectors 64 without including a lens between the optical receive waveguides 60 and the photodetectors 64. If the optical receive signals are multimode, it may be desirable to place a converging lens between the optical receive waveguides 60 and the photodetectors to reduce the beams of the optical receive signals to a size suitable for receipt by the photodetectors 64. For instance, the size of the beams can be reduced below about 28 microns, which may correspond to the diameter of the active regions 65.

As described above, the photodetectors 64 can be spaced from the photonic integrated circuit 32. Thus, a method of data communication of the transceiver 20 can include the step of converting electrical transmit signals to optical transmit signals in the photonic integrated circuit 32 that is supported by the substrate 26 of the optical transceiver 20. The method can further include the step of outputting the optical transmit signals to the respective ones of the optical transmit waveguides 36. For instance, the method can include the step of directing the optical transmit signals from the photonic integrated circuit 32 to the optically transparent optical transmit coupler 27. The method can include the step of conducting the optical transmit signal in the electrical transmit interposer 23 along the first transmit path 48, reflecting the optical transmit signals along the second transmit path 50 in the electrical transmit interposer 23, and directing the optical transmit signals to the optical transmit waveguides 36. The step of directing the optical transmit signals to the optical transmit waveguides 36 can include the step of reflecting the optical transmit signals off of the reflective transmit coupler surface 56. The step of directing the optical transmit signals to the optical transmit waveguides 36 can further include the step of directing the optical transmit signals through at least one transmitter lens 58 before reflecting the optical transmit signals off of the reflective transmit coupler surface 56. The step of directing the optical transmit signals through the transmitter lens 58 can include the step of causing the light beams of the optical transmit signals to converge as they travel toward the optical transmit waveguides 36. The method can further include the step of collimating the optical transmit signals prior to causing the light beams to converge. The step of reflecting the optical transmit signals along the second transmit path 50 can include the step of causing light beams of the optical transmit signals to converge as they travel along the second transmit path 50. The step of reflecting the optical transmit signals along the second transmit path 50 can further include the step of adjusting an orientation of the reflective transmitter surface 54.

The method can further include the step of receiving optical receive signals from the optical receive waveguides 60, and converting the optical receive signals to electrical receive signals in the photodetectors 64 that are supported by the substrate 26 and spaced from the photonic integrated circuit 32. The electrical receive signals can be conditioned in the current-to-voltage converter 66, and the conditioned electrical signals can be output to the first electrical component. The method can further include the step of directing the optical receive signals from the optical receive waveguides 60 to the optically transparent receive interconnect member 68. The step of directing the optical receive signals from the optical receive waveguides 60 to the optically transparent receive interconnect member 68 can include reflecting the optical transmit signals off of the receive waveguide coupler surface 86. The step of directing the optical receive signals from the optical receive waveguides 60 to the optically transparent receive interconnect member 68 can include directing the optical receive signals through the receiver lens 83 after reflecting the optical receive signals off of the receive waveguide coupler surface 86. The step of directing the optical receive signals through the receiver lens 83 can include collimating the optical receive signals. Alternatively, the step of directing the optical receive signals through the receiver lens 83 can cause light beams of the optical receive signals to converge as they travel along the first receive path 76. The method can further include the step of propagating the optical receive signal in the receive interconnect member 68 along the first receive path 76, reflecting the optical transmit signals to travel along the second receive path 78 in the receive interconnect member 68, and directing the optical receive signals from the receive interconnect member 68 to the photodetectors 64. The step of reflecting the optical receive signals to travel along the second receive path 78 can include causing light beams of the optical receive signals to converge as they travel along the second receive path 78. The step of reflecting the optical receive signals to travel along the second receive path 78 can include the step of adjusting an orientation of the reflective surface 82.

The optical transceiver 10 shown in FIG. 1 is capable of transmitting and receiving data at very high data rates. For example, each transmitter/receiver may have 4 distinct waveguides that send/receive data. The modulation rate of the signal in each waveguide may be 28 Gpbs, 56 Gpbs, 100 Gpbs or some other rate. Assuming a 56 Gpbs modulation rate the combined bandwidth of all the waveguides is approximately 200 Gpbs for each of the transmitter and the receiver. As described below, even higher bandwidths are achievable by incorporating wavelength division multiplexing and demultiplexing functionality into the optical transceiver 10. It should be appreciated that the transmitter engine 30 and the receiver engine 62 can include any number of transmitting and receiving channels, respectively, as desired.

It should be appreciated that the optical receiver 24 can be mountable to any suitable platform. For instance, the optical receiver 24 can be mounted onto a mid-board module or a front panel mounted module. In one example, the optical receiver 24 can be mounted on a daughter board, a multi-source-agreement (MSA) optical transceiver such as quad small form factor pluggable (QSFP) transceiver, an application specific integrated circuit (ASIC) interposer, or in an on-board transceiver of the type described herein. In some embodiments, the receive waveguide coupler 72 may comprise a material that has a coefficient of thermal expansion substantially matched to that of one or more up to all of the receive interconnect member 68, the current-to-voltage converter 66, and the photodetectors 64.

As described above, the transceiver 20 can include the transmitter 22 and the receiver 24 that define respective optical assemblies that are separate in their respective entireties from each other. Thus, the transmitter 22 and the receiver 24 are individually mountable onto the substrate 26. For instance, the transmitter 22 can include the electrical transmit interconnect member 40, and the receiver 24 can include the receive interconnect member 68 that is separate from the transmit interconnect member 40.

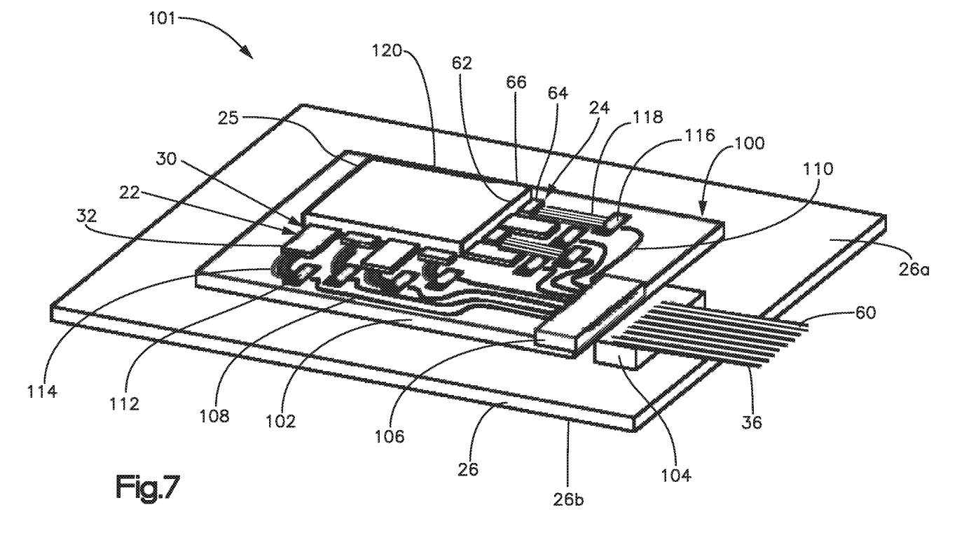

Alternatively, referring now to FIG. 7, in accordance with an alternative embodiment, a data processing system 101 can include an optical assembly 100 that is configure to be mounted to a substrate 20. In particular, the optical assembly 100 can include a single unitary transceiver interconnect member 102 that includes the transmit interconnect member and the receive interconnect member of the type described above. Thus, the optical assembly 100 can include the optical transmitter engine 30 and the optical receiver engine 62 that are mounted onto a common interposer 102 that includes the transmitter interposer and the receiver interposer. The interposer 102 can be mounted to an underlying substrate 26 and placed in electrical communication with the substrate 26 in the manner described above with respect to the electrical transmit interposer 23 and the receive interconnect member 68. The transmit waveguide coupler 38 and the receive waveguide coupler 72 can likewise also be integrated into a single waveguide coupler 104 that supports both the receive waveguide 60 and the transmit waveguides 36. The waveguide coupler 104 can be a single monolithic structure. An application specific integrated circuit (ASIC) 120 may be mounted on the same interposer 102 as the photonic integrated circuit 32 and photodetectors 64. The ASIC 120 may include circuitry suitable for transmitting and receiving high speed electrical signals. In particular, the ASIC 120 may include a modulator driver suitable for driving modulators located in the photonic integrated circuit 32. The ASIC 120 may also include a current-to-voltage converter suitable for conditioning electrical signals received from the photodetectors 64. The arrangement shown in FIG. 7 may be referred to as a co-packaged optical interconnect or an integrated circuit package having built-in optical communication capability, since the optical-to-electrical and electrical-to-optical conversion takes place on the same interposer where the ASIC is located. Advantageously, co-packaging these elements on a common interposer reduces the electrical signal path length between them, which can improve signal integrity and allow for higher bandwidth operation.

The optical assembly 100 can further include an optical signal coupler 106 that is configured to output optical transmit signals to the optical transmit waveguides 36. The optical signal coupler can further be configured to receive optical receive signals from the optical receive waveguides 60. The optical assembly 100 can further include a plurality of transmit waveguides 108 that extend from the optical signal coupler 106 and are configured to conduct transmit signals output from respective photonic integrated circuits 32 to the optical signal coupler 106 which, in turn, outputs the optical transmit signals to respective ones of the transmit waveguides 36.

In this regard, the optical assembly 100 can include a plurality of photonic integrated circuits 32 as opposed to the single photonic integrated circuit 32 described above with respect to the transmitter 22. Of course, it should be appreciated that the transmitter 22 can alternatively include a plurality of photonic integrated circuits that each defines at least one channel, and thus are each in optical communication with a respective at least one of the transmit waveguides 36 and at least one of the first group of electrical conductors of the substrate 26 directly or through the ASIC. Alternatively still, the optical assembly 100 can include a single photonic integrated circuit 32 that is in communication with each of the transmit waveguides 108 in the manner described above with respect to the transmitter 22. The optical assembly 100 can further include a plurality of optical receive waveguides 110 that extend from the optical signal coupler 106 and are configured to conduct receive signals received from the optical receive waveguides 60 to a respective plurality of photodetectors 64. Thus, the transmit waveguides 108 can be in optical alignment with the optical transmit waveguides 36. Similarly, the receive waveguides 110 can be in optical alignment with the optical receive waveguides 60.

At least one or both of the waveguide coupler 104 and the optical signal coupler 106 can include at least one lens such as a plurality of lenses that are aligned with a respective one of the transmit waveguides 36 and the receive waveguides 60. In particular, it is recognized that it is desirable to ensure that the transmit waveguides 108 are in adequate optical alignment with the transmit waveguides 36. Thus, the optical signal coupler 106 can include collimating lenses that are aligned with respective ones of the transmit waveguides 108. Accordingly, optical transmit signals that travel through the transmit waveguides 108 pass through an aligned one of the collimating lenses. The waveguide coupler 104 can include a plurality of converging lenses that are aligned with respective ones of the collimating lenses and further aligned with respective ones of the optical transmit waveguides 36. Thus, the optical transmit signals pass through respective ones of the collimating lenses of the optical signal coupler 106 and through respective ones of the converging lenses of the waveguide coupler 104. Accordingly, the light beams of the transmit signals converge as the light beam travels from the converging lens to the input ends of the optical transmit waveguides 36.

It is further recognized that it is desirable to ensure that the optical receive waveguides 60 are placed into adequate optical alignment with the receive waveguides 110. Thus, the waveguide coupler 104 can include a collimating lens that provides an expanded collimated beam at the surface of the waveguide coupler 104 facing the optical signal coupler 106. The optical signal coupler 106 may include a converging lens that converges the collimated light beam to match the mode size of the receive waveguides 110. As described above, having a larger, collimated beam at the interface between the waveguide coupler 104 and optical signal coupler 106 relaxes the alignment tolerances between the receive optical waveguides 60 and receive waveguides 110.

The optical assembly 100 can further include at least one multiplexer 112 disposed between a respective one of the photonic integrated circuits 32 and the corresponding one of the transmit waveguides 36 that is in optical communication with the photonic integrated circuit 32. For instance, the optical assembly 100 can include a plurality of multiplexers 112 disposed between respective ones of the photonic integrated circuits 32 and the corresponding ones of the transmit waveguides 36 that are in optical communication with the photonic integrated circuits 32. In particular, it is recognized that optical signals can be generated by the photonic integrated circuit 32 at different frequencies.

The optical assembly 100 can thus include a number of first optical transmit waveguides 114 coupled between the multiplexer 112 and the photonic integrated circuit 32, each of the waveguides 114 configured to propagate an optical signal at a respective different wavelengths. The optical driver can further include a single second transmit waveguide 108 that is coupled from the multiplexer 112 at one end, and in alignment with the respective one of the transmit waveguides 36 at the other end. For instance, the transmit waveguide 108 can be coupled to the optical signal coupler 106 at the other end. The multiplexer 112 is configured to combine the optical transmit signals at different wavelengths from the number of optical transmit waveguides 114 to the second single transmit waveguide 108. The optical transmit signals travel at different wavelengths through the second transmit waveguide 108 to the respective optical transmit waveguide 36. While the optical assembly 100 is illustrated as having a single second transmit waveguide 108, it should be appreciated that the optical assembly 100 can include a multiple second transmit waveguides 108 that extend from the multiplexer 112 to a location in alignment with the optical transmit waveguides 36. The number of second transmit waveguides is less than the number of first transmit waveguides 114 because the optical signals are multiplex in the multiplexer 112.

Alternatively or additionally, the optical assembly 100 can further include at least one demultiplexer 116 disposed between a respective one of the photodetectors 46 and the corresponding one of the optical receive waveguides 60 that is in optical communication with the photodetectors 64. For instance, the optical assembly 100 can include a plurality of demultiplexers 116 disposed between respective ones of the photodetectors 64 and the corresponding ones of the optical receive waveguides 60. In one example, the demultiplexers 116 can be disposed between the photodetectors 64 and the corresponding ones of the receive waveguides 60 that are in optical communication with the photodetector 64. In particular, it is recognized that optical signals can be received from the optical receive waveguides 60 at different wavelength. Further, it is recognized that the photodetectors can be spaced from the photonic integrated circuits 32 as described above.

The optical assembly 100 can thus include a single first optical receive waveguide 110 coupled between the demultiplexer 116 at one end, and in optical alignment with the respective one of the optical receive waveguides 60 at the other end. For instance, the first optical receive waveguide 110 can be coupled to the optical signal coupler 106. The optical assembly 100 can further include a plurality of second optical receive waveguides 118 that are coupled from the demultiplexer 116 to the photodetector 64. The demultiplexer 116 is configured to divide the optical receive signals at different wavelengths from the first optical waveguide 110 to respective ones of the second optical receive waveguides 118. The optical receive signals travel at different wavelengths through each of the second receive waveguides 118 to the photodetectors 64, which converts the optical receive signals to electrical receive signals in the manner described above, and outputs the electrical receive signals to the current-to-voltage converter 66. While the optical assembly 100 is illustrated as having a single first receive waveguide 110, it should be appreciated that the optical assembly 100 can include a number of first receive waveguides 110 that is less than the number of second receive waveguides 118.

It should be appreciated that the interposer 102 can include the transmit waveguides 108 and the receive waveguides 110. For instance, the transmit waveguides 108 and the receive waveguides 110 can extend along a first surface of the interposer 102 that faces away from the underlying substrate 26. The transmit waveguides 108 and the receive waveguides 110 can be butt coupled with to the optical transmit waveguides 36 and the optical receive waveguides 60, respectively. For instance, the optical signal coupler 106 can butt couple the transmit waveguides 108 and the receive waveguides 60 with to the optical transmit waveguides 36 and the optical receive waveguides 60, respectively.

Alternatively or additionally, any number of reflective surfaces and/or surface gratings may be used to help route the optical receive signals from the receive waveguides 60 to the demultiplexer 116 and/or from the demultiplex 116 to the photodetectors 64, in the manner described above. Similarly, the interposer 102 can include any number of reflective surfaces and/or surface gratings to help route the optical transmit signals from the at least one photonic integrated circuit 32 to the multiplexer 112 and/or the multiplexer 112 to the transmit waveguides 36.

The optical assembly 100 can further include a controller which can be configured as a microprocessor in the manner described above. In some embodiments, the controller may be integrated into the ASIC 120. The controller can be programmed to control the operation of the optical receiver engine 62 and the optical transmit engine 30. For instance, the controller can control the light modulation protocol of the modulator driver 25. The controller can further control the current-to-voltage converter 66. The photodetectors 64, ASIC 120, the photonic integrated circuits 32, the optical signal coupler 106, can all be mounted to the interposer 102. One or both of the multiplexers 112 and the demultiplexers 116 may be fabricated into the interposer 102. Alternatively or additionally, one or both of the multiplexers 112 and the demultiplexers 116 can be integrated into the photonic integrated circuit 32. Alternatively or additionally, the demultiplexers 116 can be integrated into respective ones of the photodetectors 64. The waveguide coupler 104 can be mounted to the substrate 26. Alternatively, the waveguide coupler 104 can be mounted to the interposer 102.

It should be understood from the above that the optical assembly 100 can include an integrated circuit die that is mounted on the interposer 102. The integrated circuit die can include the ASIC 120 into which the modulator driver 25 and current-to-voltage converter 66 may be integrated. The photonic integrated circuits 32 and photodetectors 64 can further be mounted on the interposer 102. The optical signal coupler 106, which can be a pluggable optical signal coupler, can further be mounted to the interposer 102. The waveguide coupler 104 can be configured to mate with the pluggable optical signal coupler 106. As described above, the interposer 102 can be configured to routing both optical and electrical signals. For instance, the interposer 102 can be optically transparent. Preferably the interposer 102 is glass, which has desirable dielectric properties allowing propagation of electrical signals from substrate 26 to ASIC 120 with good signal integrity.

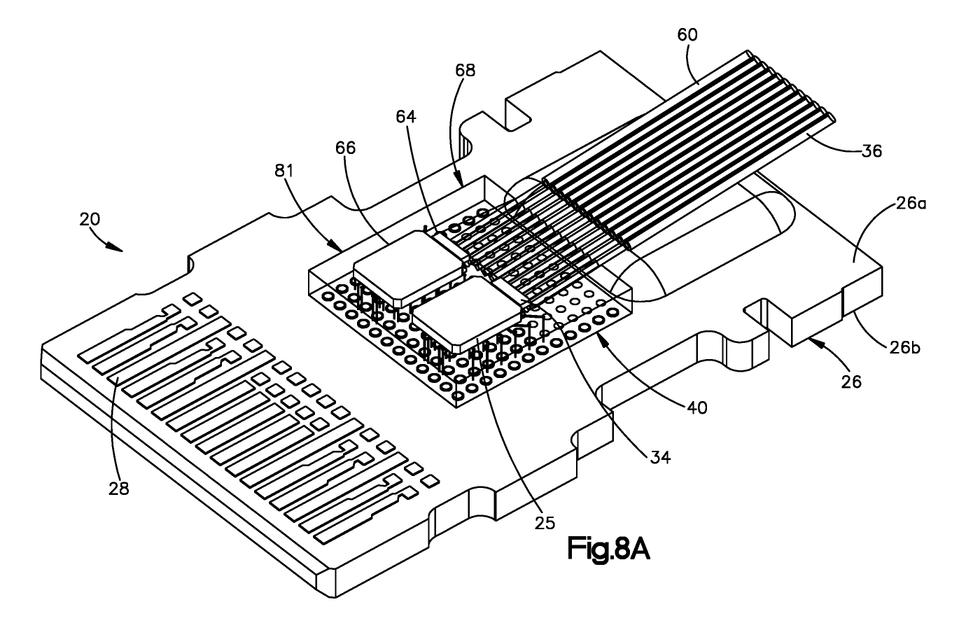

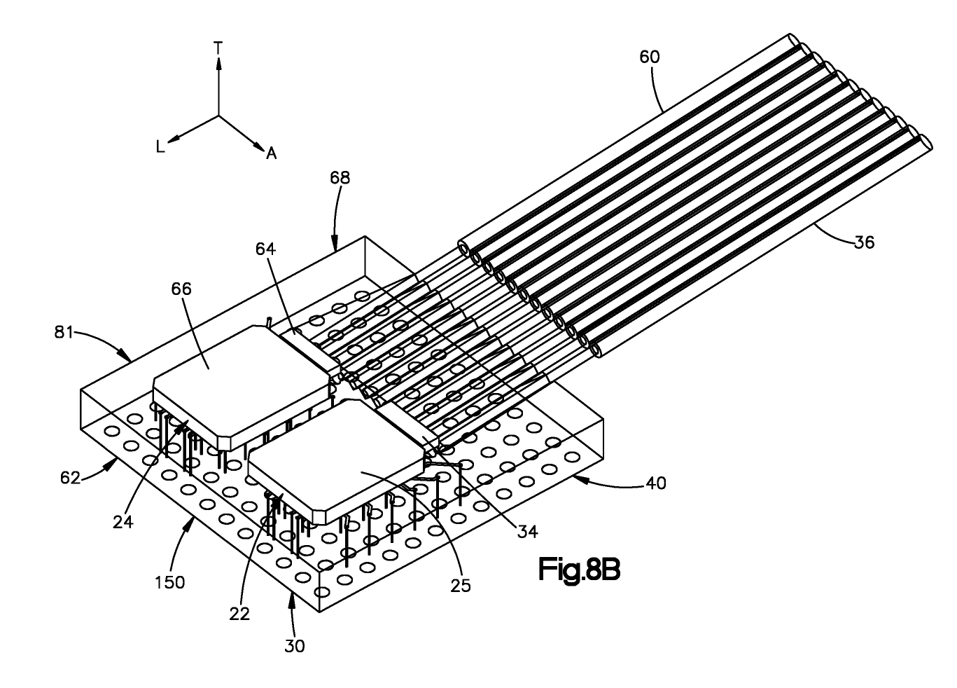

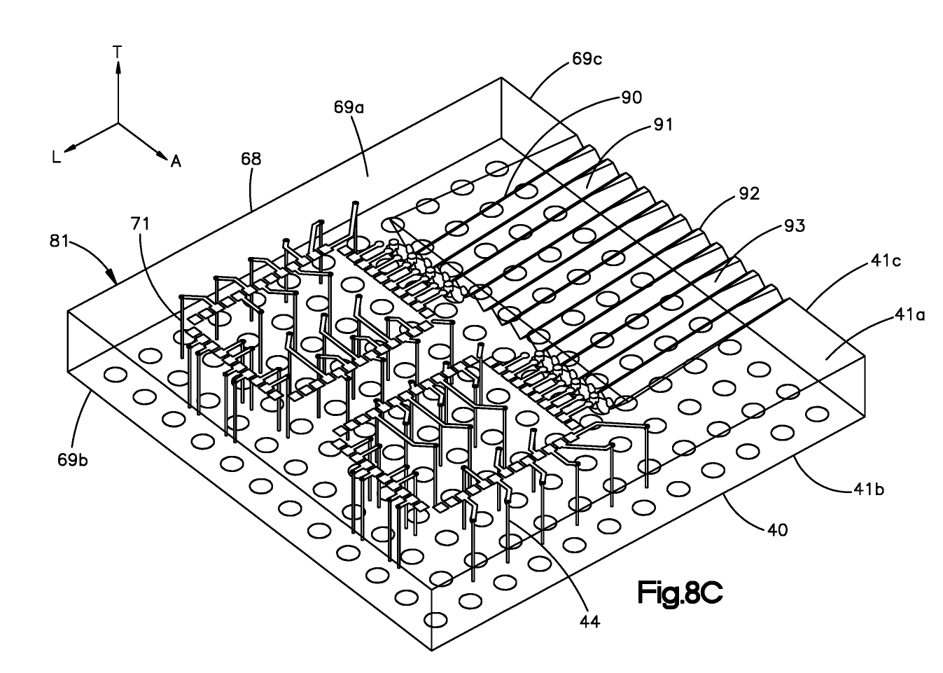

It should be appreciated that the active optical cable described above with respect to FIG. 1, and the transceiver described above with respect to FIGS. 2A and 2B can be constructed in accordance with any suitable alternative embodiment as desired. For instance, referring to FIGS. 8A-8C, it is recognized that the driver 25 can be placed in direct communication with light source 34, which as described above can be configured as a laser, for example VCSEL. The driver 25 can include electronic driver circuitry that is configured to reshape and amplify the electrical transmit signals so as to properly drive the light source 34 to pulsate in a manner that produces optical transmit signals that correspond to the electrical transmit signals. The laser can thus be modulated on and off by the drive current produced by the driver 25. Such a modulation scheme is often referred to as OOK (on-off keying). In typical embodiments, the driver 25 can include numerous refinements to OOK, including temperature dependent laser bias and modulation control, as well as equalization and pre-distortion to drive the light source 34. At higher bit rates, the driver 25 can also provide equalization on the electrical side. In addition, the capability of the driver 25 can also include the ability to turn off a channel and monitor light source characteristics, which may be useful in inferring the remaining operating lifetime of the light source 34.

With continuing reference to FIGS. 8A-8C, and as described above with respect to FIG. 2A, the optical receive waveguides 60 can be pigtailed to the optical receiver engine 62. In one example, the receive interconnect member 68 can include receive waveguide alignment members 90 that are configured to attach to the optical receive waveguides 60 and place the optical receive waveguides 60 in optical alignment with the active regions of the photodetectors 64, such the optical receive signals travel from the optical receive waveguides 60 to the photodetectors 64. In one example, the receive waveguide alignment members 90 define a plurality of receive waveguide grooves 91 that extend into the first or upper receive interconnect member surface 69a. The receive waveguide grooves 91 can be elongate along a longitudinal direction L that is substantially perpendicular to the transverse direction T. Further, the receive waveguide grooves 91 can be spaced from each other along a lateral direction A that is substantially perpendicular to each of the longitudinal direction L and the transverse direction T. The receive waveguide grooves 91 can be sized to receive the optical receive waveguides 60 such that the output ends of the optical receive waveguides are in optical alignment with the active regions 65 of the photodetectors 64. The receive waveguides may be single mode optical fibers having a core surrounded by a cladding. The outer cladding diameter may be approximately 125 microns.

In particular, each of the receive waveguide grooves 91 can be sized to receive a respective one of the optical receive waveguides 60. The receive waveguide grooves 91 extend in a direction from the first receive interconnect member surface 69a toward the second receive interconnect member surface 69b, and terminate at a location between the first receive interconnect member surface 69a and the second receive interconnect member surface 69b. In particular, the receive waveguide grooves 91 can be defined by surfaces of the optical receive interconnect member 68 that taper inwardly in the direction from the first receive interconnect member surface 69a toward the second receive interconnect member surface 69b. In one example, the receive waveguide grooves 91 can be substantially V-shaped, though it should be appreciated that they can be alternatively shaped as desired. The cladding and core (referenced in combination at 63a) of the receive waveguides 60 can extend out from the buffer 63b along the longitudinal direction and into the receive waveguide groves 91. The tapered surfaces that define the receive waveguide grooves 91 can locate the optical receive waveguides 60 in optical alignment with the photodetectors 64. The cladding of the optical receive waveguides 60 can be secured to the optical receive interconnect member 68 in the receive waveguide grooves 91 in any manner as desired. For instance, the cladding can be adhesively bonded to the optical receive interconnect member 68 in the receive waveguide grooves 91. Epoxy is one suitable adhesive to bond the cladding to the optical receive interconnect member 68 in the receive waveguide grooves 91, but it should be appreciated that any suitable method and apparatus that bonds the cladding 63a to the optical receive interconnect member 68 in the receive waveguide grooves 91 is envisioned.

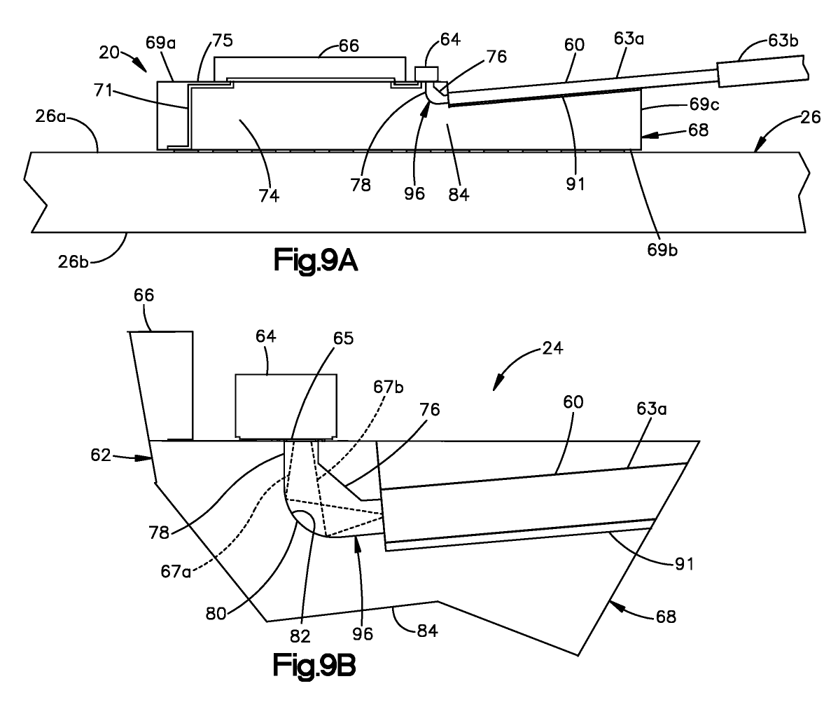

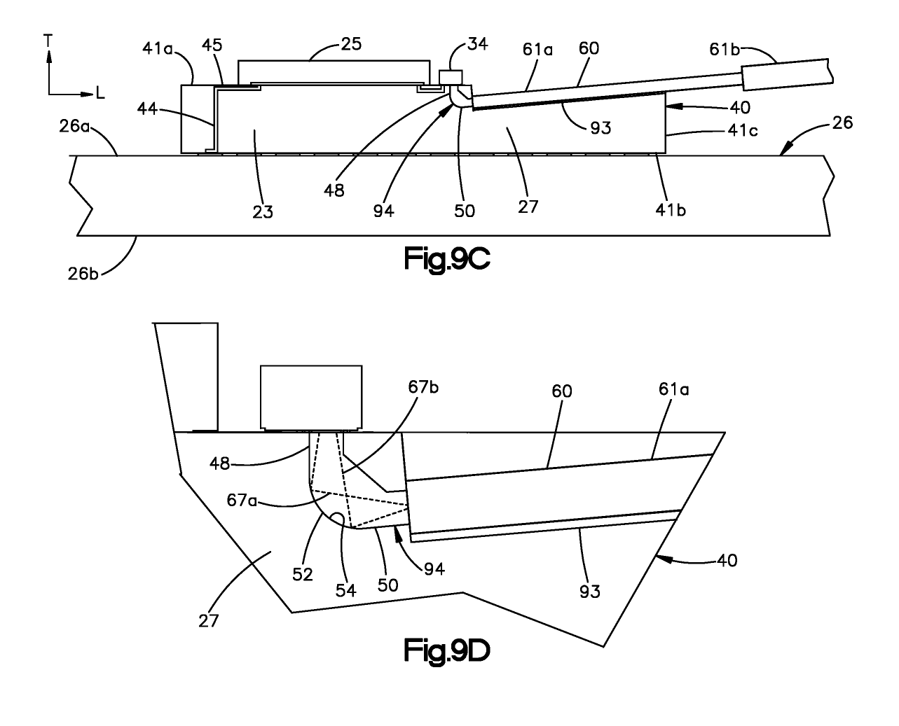

Referring now also to FIGS. 9A-9B, in one example, the output ends of the optical receive waveguides 60 can be recessed with respect to the first receive interconnect member surface 69a. That is, the output ends of the optical receive waveguides 60 can be disposed between the first interconnect surface 69a and the second interconnect surface 69b with respect to the transverse direction T. The receive interconnect member 68 can define a side receive interconnect member surface 69c that extends between the first interconnect surface 69a and the second interconnect surface 69b. Thus, the side interconnect surface 69c can be angularly offset with respect to the first interconnect surface 69a. For instance, the side surface 69c can be substantially perpendicular with respect to the first interconnect surface 69a. In one example, the side surface 69c extends from the first receive interconnect member surface 69a toward the second receive interconnect member surface 69b. The side surface 69c can terminate between the first interconnect surface 69a and the second interconnect surface 69b such that the optical receive coupler 84 includes a notch that is defined by the side surface 69c and the receive waveguide grooves 91. Thus, a lower portion of the side surface 69c can extend between the second receive interconnect member surface 69b and the receive waveguide grooves 91. An upper portion of the side surface 69c can extend between the receive waveguide grooves 91 and the first interconnect surface 69a.

The output ends of the optical receive waveguides 60 can be aligned with the side surface 69c. Accordingly, the side surface 69c can define the origination surface, or the receive input surface. During operation, the optical receive waveguides 60 can direct the optical transmit signals to the receive input surface of the optical receive coupler 84. The termination surface, or the receive output surface, can be defined by the first surface 69a in the manner described above. The optical receive signals can propagate along the first receive path 76 from the side receive interconnect member surface 69c along a downward direction (e.g., a direction from the first surface 69a toward the second surface 69b). It should be appreciated that the receive input surface can be defined by a different surface of the optical receive coupler 84 than the receive output surface. The optical receive signals can travel along the first receive path 76 to the second receive path 78. The second receive path 78 can extend from the first receive path 76 to the first surface 69a. Thus, the receive optical signals can extend along the second path 78, and can exit the optical receive coupler 84 at the top surface 69a and travel to the active regions 65 of the photodetectors 64. The active regions 65 can face the receive output surface. Thus, the active regions can face the first interconnect surface 69a. One or more light shaping elements can be disposed between the optical receive waveguides 60 and the optical receive coupler 84, such that the optical receive signals travel through the one or more light shaping elements prior to traveling into the optical receive coupler 84. Alternatively, the optical receive signals can travel from the optical receive waveguides 60 to the optical receive coupler 84 under free space propagation.

Further as described above, the optical receive signals can travel through the material of the receive interconnect member substrate 68. Alternatively, as illustrated in FIGS. 9A-9B, the optical receive signals can pass through at least one receive channel defined by the optical receive coupler 84. For instance, the first and second receive paths 76 and 78 can be defined by an internal optical receive cavity 96 defined by the optical receive coupler 84. The receive cavity 96 can define at least a portion up to an entirety of one or both of the first and second receive paths 76 and 78. Thus, at least a portion up to an entirety of each of the first and second receive paths 76 and 78 can be air paths that extend through the optical receive coupler 84. In another example, the receive cavity 96 can be filled with an optically transparent material, such that the optical receive signals propagate through the transparent material of the receive cavity 96. The transparent material of the receive cavity 96 can comprise air, an optically transparent material different than the material of the optical coupler 84, or a combination of both.

The receive reflector 80 can be applied to an internal surface of the optical receive coupler 84, such that the reflective receiver surface 82 defines at least a portion of the receive cavity 96. For instance, the reflective receive surface 82 can be made from gold, aluminum, or some other suitable reflective surface. The reflective receiver surface 82 is configured to reflect the optical receive signals from the first receive path 76 to the second receive path 78 and into the active regions 65 of the photodetectors 64. In one example, the reflective receiver surface 82 can be curved. It should be appreciated, of course, that the reflective receiver surface 82 can be alternatively shaped as desired. As illustrated in FIG. 9B, the optical receive signals can be disposed within a pair of opposed boundaries 67a and 67b that are spaced apart from each other. Thus, the optical receive signals can reflect off the reflective receiver surface 82 at any location between the boundaries 67a and 67b and be suitably aligned with the active regions 65 of the photodetectors 64. The reflector surface 82 can be curved along at least one directions, such as two different directions so as to focus light to the photodetectors 64. The two different directions can be oriented perpendicular to each other.

Similarly, the optical transmit waveguides 36 can be pigtailed to the optical transmitter engine 30. In one example, the transmit interconnect member 40 can include a plurality of transmit waveguide alignment members 92 that are configured to attach to the optical transmit waveguides 36 and place the optical transmit waveguides 36 in optical alignment with the light sources 34 such that light emitted by the light sources 34 travels through the respective transmit waveguides 36. In this regard, it should be appreciated that the transmit interconnect member 40 and the receive interconnect member 68 can be defined by separate unitary structures as illustrated above with respect to FIGS. 2A and 2B. Alternatively, as illustrated in FIGS. 8A-8C, the transceiver 20 can include a single unitary transceiver interconnect member 81 that includes both the transmit interconnect member 40 and the receive interconnect member 68. Thus, the transmit interconnect member 40 and the receive interconnect member 68 can be said to be monolithic with each other. The upper surfaces 41a and 69a can define an upper surface of the transceiver interconnect member 81. The lower surfaces 41b and 69b can define a lower surface of the transceiver interconnect member 81. The transceiver 20 can include a single unitary optical engine 150 that includes both the transmitter engine 30 and the receiver engine 62. With the optical transmit waveguides 36 pigtailed to the transmitter engine 30 and the optical receive waveguides 60 pigtailed to the receiver engine 62, the transmitter 22 can be said to be monolithic, or on board with, the receiver 24. Thus, the transmit interconnect member 40 and the receive interconnect member 68 can be monolithic with each other. Accordingly, description herein of the transmit interconnect member 40 can similarly apply to the transceiver interconnect member 81. Similarly, description herein of the receive interconnect member 68 can similarly apply to the transceiver interconnect member 81.

In one example, the transmit waveguide alignment members 92 define a plurality of transmit waveguide grooves 93 that extend into the first transmit interconnect member surface 41a. The transmit waveguide grooves 93 can be elongate along the longitudinal direction L. Further, the transmit waveguide grooves 93 can be spaced from each other along the lateral direction A. The transmit waveguide grooves 93 can be aligned with the receive waveguide grooves 91 along the lateral direction A. The transmit waveguide grooves 93 can be sized to receive the optical transmit waveguides 36 such that the input ends of the optical transmit waveguides 36 are in optical alignment with the light sources 34, such that light emitted by the light sources 34 travels through the optical transmit waveguides 36.

In particular, each of the transmit waveguide grooves 93 can be sized to receive a respective one of the optical transmit waveguides 36. The transmit waveguide grooves 93 extend in a direction from the first or upper transmit interconnect member surface 41a toward the second transmit interconnect member surface 41b, and terminates at a location between the first transmit interconnect member surface 41a and the second transmit interconnect member surface 41b. In particular, the transmit waveguide grooves 93 can be defined by surfaces of the optical transmit interconnect member 40 that taper inwardly in the direction from the first transmit interconnect member surface 41a toward the second transmit interconnect member surface 41b. In one example, the transmit waveguide grooves 93 can be substantially V-shaped, though it should be appreciated that they can be alternatively shaped as desired. The cladding and core (referenced in combination at 61a) of the transmit waveguides 36 can extend out from the buffer 61b along the longitudinal direction L and into the transmit waveguide groves 93. The tapered surfaces that define the transmit waveguide grooves 93 can locate the optical transmit waveguides 36 in optical alignment with the light sources 34. The optical transmit waveguides 36 may be single mode optical fibers having a core surrounded by a cladding. The outer cladding diameter may be approximately 125 microns.

The cladding 61a of the optical transmit waveguides 36 can be secured to the optical transmit interconnect member 40 in the transmit waveguide grooves 93 in any manner as desired. For instance, the cladding 61a can be adhesively bonded to the optical transmit interconnect member 40 in the transmit waveguide grooves 93. Epoxy is one suitable adhesive to bond the cladding 61a to the optical transmit interconnect member 40 in the transmit waveguide grooves 93, but it should be appreciated that any suitable method and apparatus that bonds the cladding 61a to the optical transmit interconnect member 40 in the transmit waveguide grooves 93 is envisioned.

Referring now also to FIGS. 9C-9D, in one example, the input ends of the optical transmit waveguides 36 can be recessed with respect to the first transmit interconnect member surface 41a. That is, the input ends of the optical transmit waveguides 36 can be disposed between the first interconnect surface 41a and the second interconnect surface 41b with respect to the transverse direction T. The transmit interconnect member 40 can define a side interconnect surface 41c that extends between the first interconnect surface 41a and the second interconnect surface. Thus, the side interconnect surface 41c can be angularly offset with respect to the first interconnect surface 41a. For instance, the side surface 41c can be substantially perpendicular with respect to the first interconnect surface 41a. In one example, the side surface 41c extends from the first interconnect surface 41a toward the second surface 41b. The side surface 41c can terminate between the first interconnect surface 41a and the second interconnect surface 41b such that the optical transmit coupler 27 includes a notch that is defined by the side surface 41c and the transmit waveguide grooves 93. Thus, a lower portion of the side surface 41c can extend between the second transmit interconnect member surface 41b and the transmit waveguide grooves 93. An upper portion of the side surface 41c can extend between the transmit waveguide grooves 93 and the first interconnect surface 41a.

The input ends of the optical transmit waveguides 36 can be aligned with the side surface 41c. Accordingly, the side surface 41c can define the termination surface, or the transmit output surface. During operation, the light source 34 can direct the optical transmit signals to the transmit input surface of the optical transmit coupler 27. The origination surface, or the transmit input surface, can be defined by the first transmit interconnect member surface 41a. in the manner described above. The optical transmit signals can propagate along the first transmit path 48 from the first transmit interconnect member surface 41 along a downward direction (e.g., a direction from the first surface 41a toward the second surface 41b). It should be appreciated that the transmit input surface can be defined by a different surface of the optical transmit coupler 27 than the transmit output surface. The optical transmit signals can travel along the first transmit path 48 to the second transmit path 50. The second transmit path 50 can extend from the first transmit path 48 to the side surface 41c. Thus, the transmit optical signals can extend from along the second path, and can exit the optical transmit coupler at the side surface 41c and travel into the input end of the optical transmit waveguides 36. As described above, the optical transmit signals can travel from the optical transmit coupler 27 to the optical transmit waveguides 36 under free space propagation. Alternatively, one or more light shaping elements can be disposed between the optical transmit coupler 27 and the optical transmit waveguides 36, such that the optical transmit signals travel through the one or more light shaping elements prior to traveling into the transmit waveguides 36.

Further as described above, the optical transmit signals can travel through the material of the transmit interconnect member substrate 41. Alternatively, as illustrated in FIGS. 9C-9D, the optical transmit signals can pass through at least one transmit channel defined by the optical transmit coupler 27. For instance, the first and second paths 48 and 50 can be defined by an internal optical transmit cavity 94 defined by the optical transmit coupler 27. The transmit cavity 94 can define at least a portion up to an entirety of one or both of the first and second transmit paths 48 and 50. Thus, at least a portion up to an entirety of each of the first and second transmit paths 48 and 50 can be air paths that extend through the optical transmit coupler 27. In another example, the transmit cavity 94 can be filled with an optically transparent material, such that the optical transmit signals propagate through the transparent material of the transmit cavity 94. The transparent material of the transmit cavity 94 can comprise air, an optically transparent material different than the material of the optical coupler 27, or a combination of both.

The transmit reflector 52 can be applied to an internal surface of the optical transmit coupler 27, such that the reflective transmitter surface 54 defines at least a portion of the transmit cavity 94. For instance, the reflective transmitter surface 54 can be made from gold, aluminum, or some other suitable reflective surface. The reflective transmitter surface 54 is configured to reflect the optical transmit signals from the first transmit path 48 to the second transmit path 50 and into the core of the optical transmit waveguides 36. In one example, the reflective transmitter surface 54 can be curved. It should be appreciated, of course, that the reflective transmitter surface 54 can be alternatively shaped as desired. As illustrated in FIG. 9D, the optical transmit signals can be disposed within a pair of opposed boundaries 67a and 67b that are spaced apart from each other. Thus, the optical transmit signals can reflect off the reflective transmitter surface 54 at any location between the boundaries 67a and 67b and be suitably aligned with the input ends of the optical transmit waveguides 36. The reflector surface 54 can be curved along at least one directions, such as two different directions so as to focus light as it propagates toward the transmit waveguides 36. The two different directions can be oriented perpendicular to each other.

It is further envisioned that the transmit waveguides 36 can be pigtailed in the manner described herein to the optical transmit coupler 27 in the transceiver 20 that includes the photonic integrated circuit 32 described above. Further, the receive waveguides 60 can be pigtailed in the manner described herein to the optical receive coupler 84 in the transceiver 20 that includes the photonic integrated circuit 32 described above.

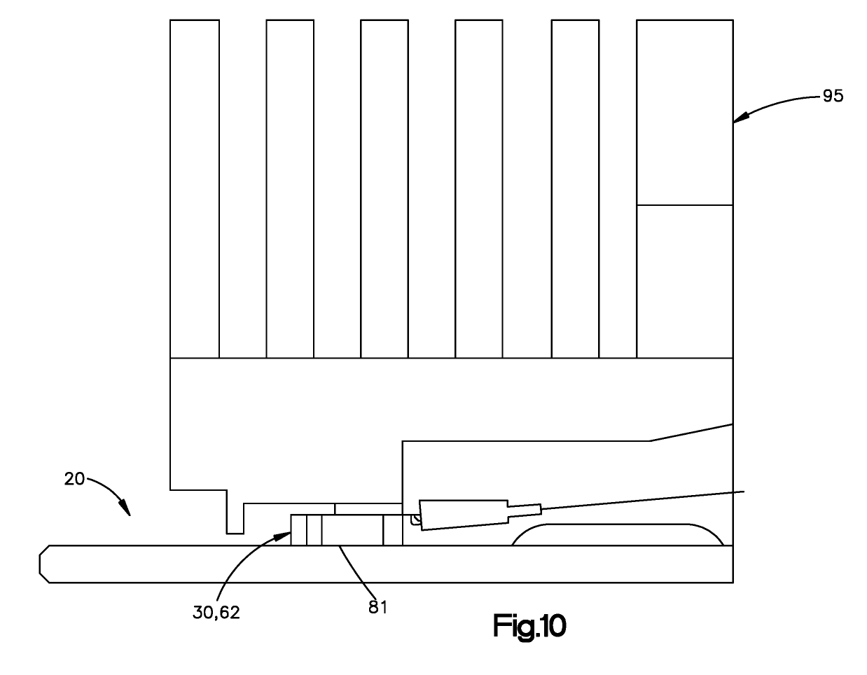

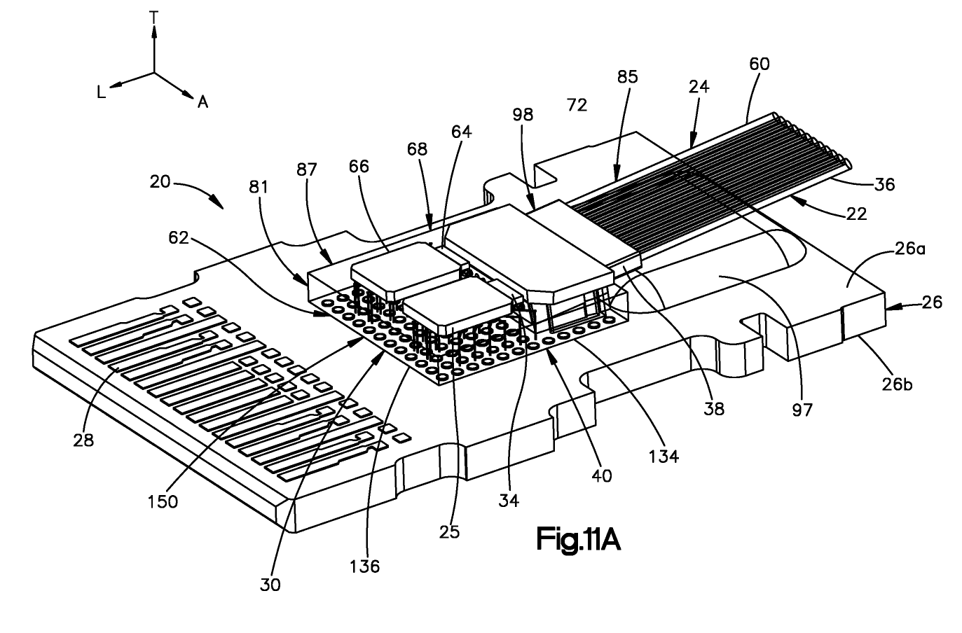

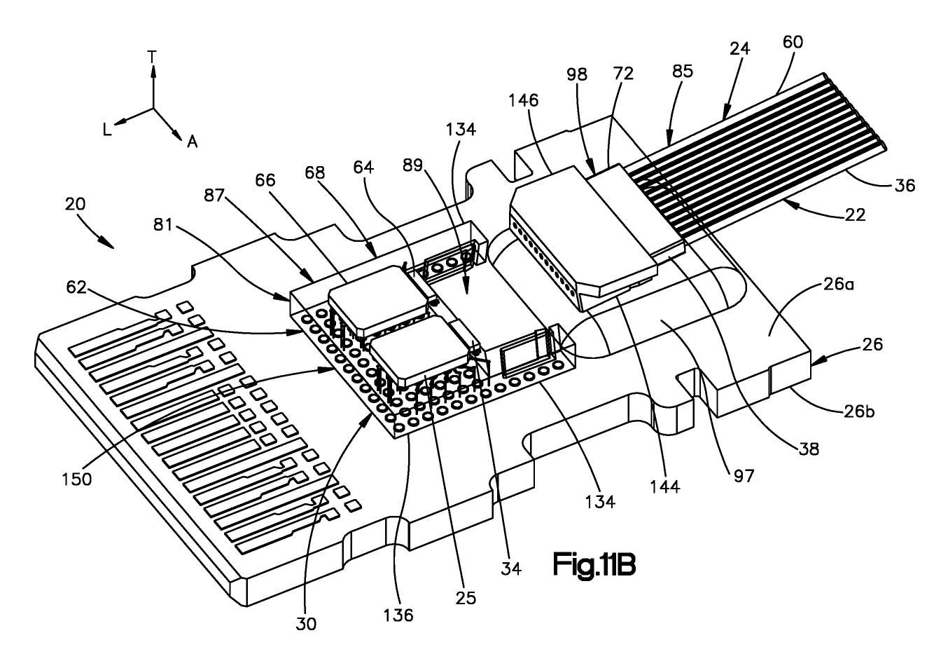

Referring to FIG. 10, it should be appreciated that the transceiver 20 can include any suitable heat dissipation apparatus as desired. For instance, the transceiver 20 can include a thermally conductive heat sink 95 that can be mounted onto one or both of the transmitter engine 30 and the receiver engine 62. In one example, the transceiver 20 having the light sources 34 and the driver 25 without the photonic integrated circuit 32 can include the heat sink 95 that is mounted to one or both of the light sources 34 and driver 25 alone or in combination with one or both of the photodetectors 64 and the current-to-voltage converter 66. In another example, the transceiver 20 having the photonic integrated circuit 32 described above can include the heat sink 95 that is mounted to one or both of the photodetectors 64 and the current-to-voltage converter 66, alone or in combination with the photonic integrated circuit 32.

Referring now to FIGS. 11A-11B, optical transmit waveguides 36 can be removably coupled to the transmitter engine 30. Otherwise stated, the optical transmit waveguides 36 can be pluggable into the transmitter engine 30. When the optical transmit waveguides 36 are coupled to the transmitter engine 30, the optical transmit waveguides are in optical alignment with the light sources 34. Alternatively, the transmitter engine 30 can include the photonic integrated circuit 32, the optical transmit waveguides 36 can be coupled to the transmitter engine 30 such that the optical transmit waveguides are in optical alignment with the photonic integrated circuit 32. Similarly, the optical receive waveguides 60 can be removably coupled to the receiver engine 62. Otherwise stated, the optical receive waveguides 60 can be pluggable into the receiver engine 32. When the optical receive waveguides 60 are coupled to the receiver engine 62, the optical receive waveguides 60 are in optical alignment with the photodetectors 64.

In one example, the transmit waveguide coupler 38 and the receive waveguide coupler 72 can be monolithic with each other so as to define a joint waveguide coupler 98. The joint waveguide coupler 98 is configured to receive the optical transmit waveguides 36 and the receive waveguides 60 that extend therethrough. Thus, in one example, the joint waveguide coupler 98 can be configured as a ferrule, such as a mechanical transfer (MT) ferrule. It should be appreciated that either or both of the transmit waveguide coupler 38 and the receive waveguide coupler 72 described above can also alternatively be configured as a ferrule, such as an MT ferrule. The joint waveguide coupler 98 is configured to be coupled to the transceiver interconnect member 81 so as to define an optical assembly 87, whereby one or both of the optical transmit waveguides 36 and optical receive waveguides 60 are coupled to the transmitter engine 30 and the receiver engine 62, respectively. It should be appreciated that the joint waveguide coupler 98, the optical transmit waveguides 36, and the optical receive waveguides 60, can define a joint waveguide assembly 85. It should be further appreciated that reference to the transceiver interconnect member 81 further applies to an optical coupler of the type described above for either or both of the transmit interconnect member 40 and the receive interconnect member 68. When the optical transmit waveguides 36 are coupled to the transmitter engine, the optical transmit waveguides 36 are placed in optical alignment with the light sources 34, or alternatively with the photonic integrated circuit 32. Further, when the receive waveguides 60 are coupled to the receiver engine 62, the optical receive waveguides 60 are placed in optical alignment with the photodetectors 64. The joint waveguide coupler 98 is further configured to be decoupled from the transceiver interconnect member 81, thereby decoupling the optical transmit waveguides 36 from the transmitter engine, and further decoupling the optical receive waveguides 60 from the receiver engine 62. Thus, when the optical transmit waveguides 36 are decoupled from the transmitter engine, the optical transmit waveguides 36 are decoupled from the light source, or alternatively from the photonic integrated circuit 32. Further, when the optical receive waveguides 60 are decoupled from the receiver engine, the optical receive waveguides 60 are decoupled from the photodetectors 64.

The transceiver 20 can include a spacer member 97 that is supported by the substrate 26. The spacer member 97 is configured to support the optical transmit waveguides 36 and the optical receive waveguides 60 at a location spaced above the substrate 26. Thus, spacer guides the optical transmit waveguides and the optical receive waveguides 60 above a second transceiver that is disposed behind the transceiver 20.

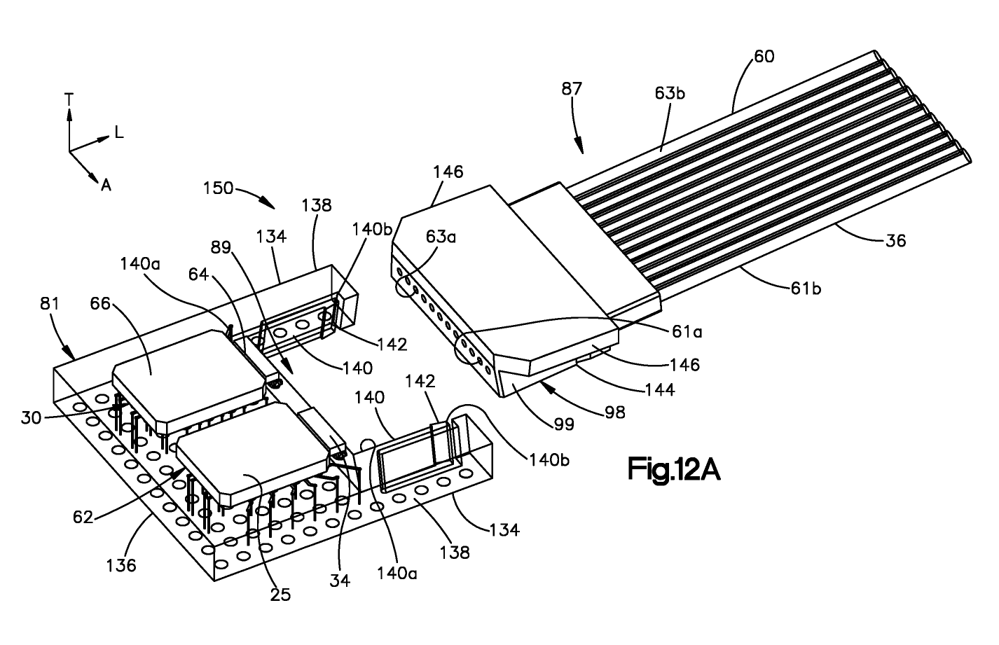

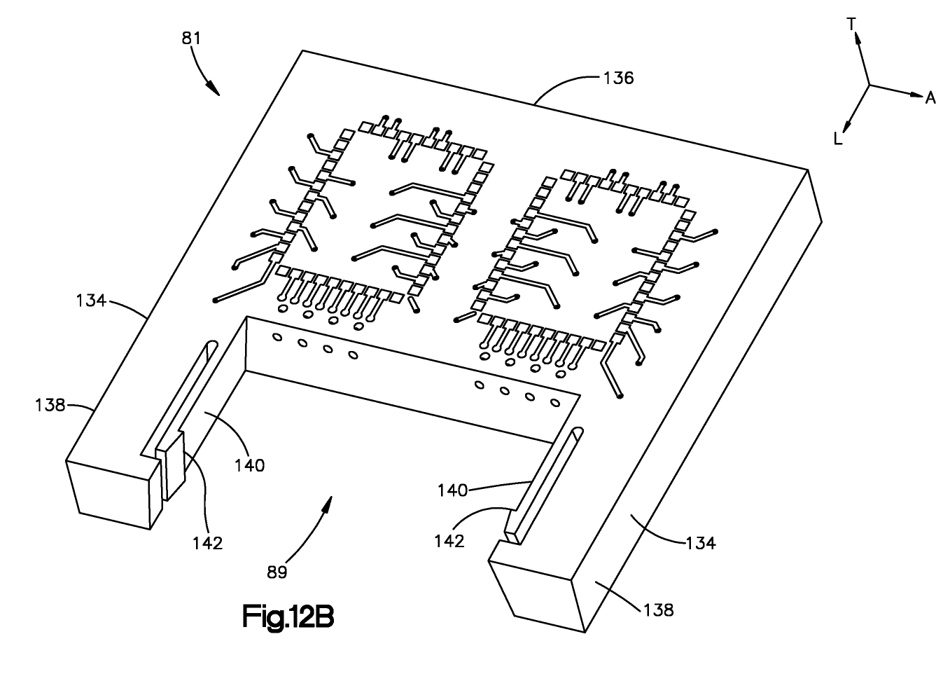

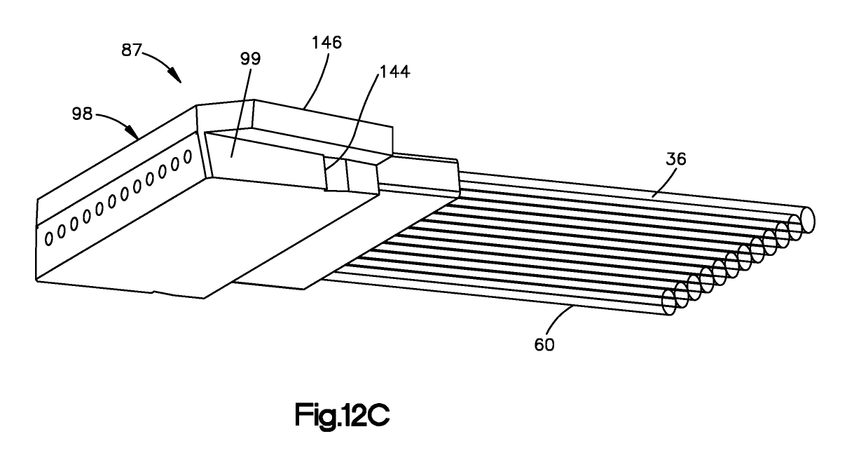

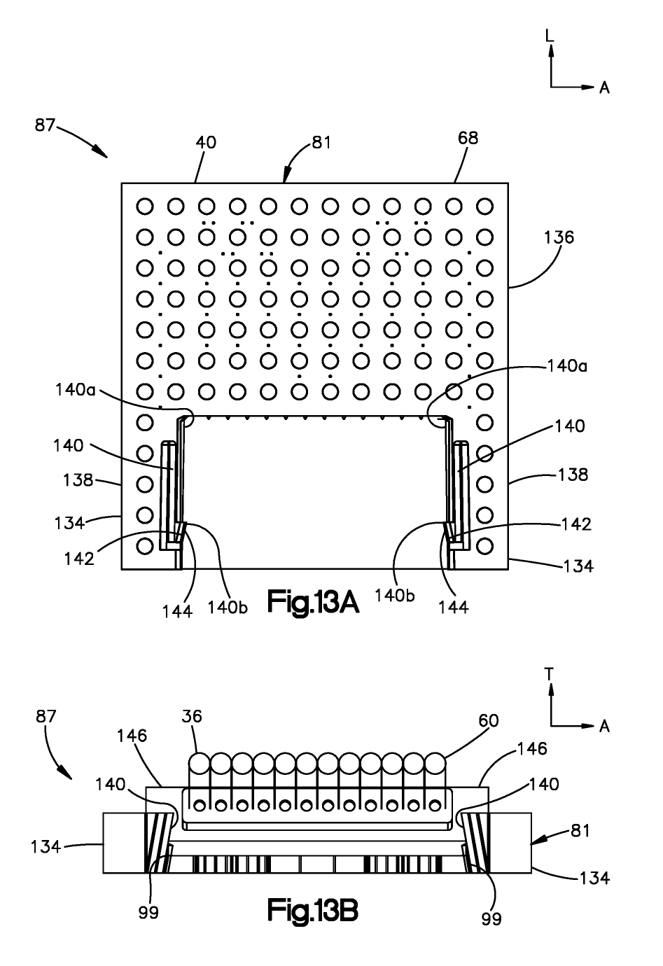

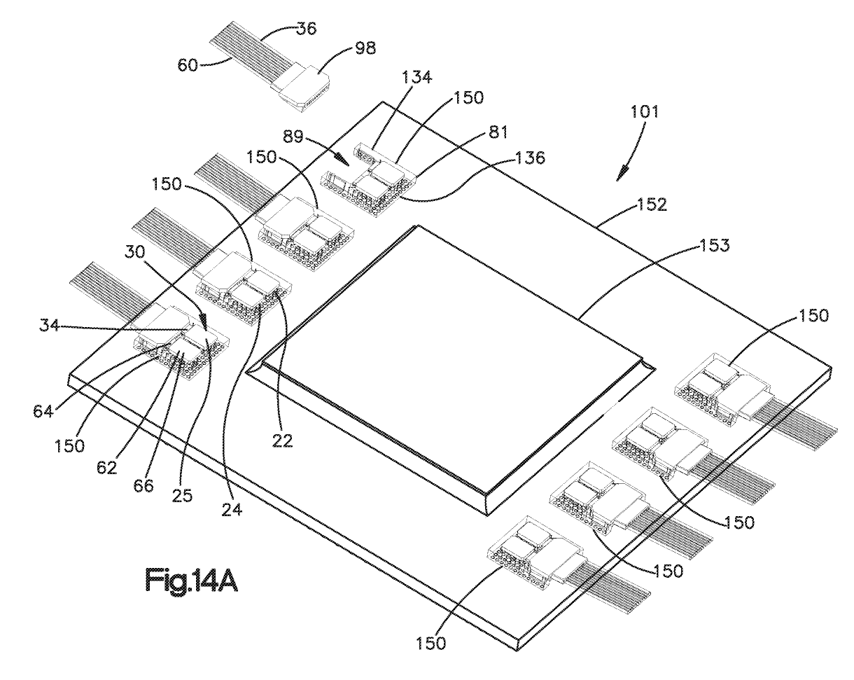

Referring to FIGS. 12A-13B, the joint waveguide coupler 98 is configured to attach to the transceiver interconnect member 81 and detach from the transceiver interconnect member 81. When the joint waveguide coupler 98 is attached to the transceiver interconnect member 81, the optical transmit waveguides 36 are coupled to the transmitter engine 30. Similarly, when the joint waveguide coupler 98 is attached to the transceiver interconnect member 81, the optical receive waveguides 60 are coupled to the receiver engine 62. The joint waveguide coupler 98 is configured to detach from the transceiver interconnect member 81 and detach from the transceiver interconnect member 81. When the joint waveguide coupler 98 is detached from the transceiver interconnect member 81, the optical transmit waveguides 36 are decoupled from the transmitter engine 30. Similarly, when the joint waveguide coupler 98 is detached from the transceiver interconnect member 81, the optical receive waveguides 60 are decoupled from receiver engine 62.

In one example, the transceiver interconnect member 81 defines a pocket that is sized to receive the joint waveguide coupler 98. The transceiver interconnect member 81 is configured to removably attach to the joint waveguide coupler 98 when the joint waveguide coupler 98 is disposed in the pocket 89. In particular, the transceiver interconnect member has at least one arm 134 that is configured to attach to, and detach from, the joint waveguide coupler 98. For instance, the transceiver interconnect member 81 includes an interconnect body portion 136 to which components of the transmitter engine 30 (such as the driver 25, light source 34, and optionally photonic integrated circuit) and the receiver engine 32 (such as the photodetector 64 and current-to-voltage converter 66) are configured to be mounted. In one example, the at least one arm 134 can include a pair of arms 134 that extend in the rearward direction from the body portion 136. The pocket 89 can be defined between the arms 134. The at least one arm can be monolithic with the body portion 136. In one example, the at least one arm 134 can include a pair of arms 134 that are spaced from each other along the lateral direction A. The joint waveguide coupler 98 is configured to attach to the transceiver interconnect member 81 between the arms 134. For instance, the joint waveguide coupler 98 can be configured to attach to the arms 134.

When the joint waveguide coupler 98 is attached to the arms 134, the joint waveguide coupler 98 is prevented from moving along the longitudinal direction L, the transverse direction T, and the lateral direction A relative to the transceiver interconnect member 81 an amount that would decouple the transmit waveguides 36 and the receive waveguides 60 from the transmitter engine 30 and the receiver engine 62.

Each of the arms 134 can include a stationary arm portion 138 and a flexible arm portion 140 that is spaced from the stationary arm portion 138. The flexible arm portion 140 can define a fixed end 140a that is attached to one or both of the stationary arm portion 138 and the body portion 136. The flexible arm portion 140 extends rearwardly from the fixed end 140a to a free end 140b. The free end 140b is spaced from the stationary arm portion 138 along the lateral direction A. The space between the free end 140b and the stationary arm portion 138 provides clearance so as to allow the free end 140b to flex toward the stationary arm portion 138. When the joint waveguide coupler 98 is disposed between the flexible arm portions 140, the flexible arm portions abut lateral sides 99 of the joint waveguide coupler 98, thereby preventing the joint waveguide coupler 98 from moving in the lateral direction A with respect to the transceiver interconnect member 81, absent an applied external force.

At least one of the arms 134 can include an inwardly extending barb 142. In one example, at least one or both of the flexible arm portions 140 can include an inwardly extending barb 142. The barb 142 can extend from the free end 140b, or any suitable alternative location along the flexible arm portion 140. The joint waveguide coupler 98 can define at least one notch 144 that is sized to receive the at least one barb 142 so as to attach the joint waveguide coupler to the transceiver interconnect member 81. In particular, the joint waveguide coupler 98 can define a pair of notches 144 that are each sized to receive the respective pair of barbs 142 of the flexible arm portions 140 so as to attach the joint waveguide coupler to the transceiver interconnect member 81. Alternatively, the joint waveguide coupler 98 can define the at least one barb 142 and the at least one or both of the flexible arm portions 140 can define the at least one notch 144 that is sized to receive the at least one barb 142. In one example, the lateral sides 99 of the joint waveguide coupler 98 define the notches 144.

During operation, the joint waveguide coupler 98 is inserted in the forward direction between the arms 134, and in particular between the flexible arm portions 140. Thus, it should be appreciated that the joint waveguide coupler 98 is further inserted between the stationary arm portions 138. The joint waveguide coupler 98 is inserted between the arms 134 until the at least one barb 142 is inserted into the respective at least one notch 144. The barbs 142 and the notches 144 can be geometrically configured such that mechanical interference between the barbs 142 and the joint waveguide coupler 98 prevents rearward movement of the joint waveguide coupler 98 with respect to the transceiver interconnect member 81. Abutment between the front end of the joint waveguide coupler 98 and the transceiver interconnect member 81, and in particular the body portion 136, prevents forward movement of the joint waveguide coupler 98 with respect to the transceiver interconnect member 81. Thus, the joint waveguide coupler 98 is prevented from moving forward and rearward along the longitudinal direction with respect to the transceiver interconnect member 81 when the joint waveguide coupler 98 is attached to the transceiver interconnect member 81. When it is desired to remove the joint waveguide coupler 98 from the transceiver interconnect member 81, the flexible arm portions 140 can be urged away from each other so as to remove the barbs 142 from the notches 144.

While the arms 134 extend rearward from the body portion 136 of the transceiver interconnect member 81, alternatively, the joint waveguide coupler 98 can include forward extending arms that are configured to attach to the transceiver interconnect member 81. Thus, it can be said that one of the joint waveguide coupler 98 and the transceiver interconnect member 81 can have arms 134 that are configured to attach to the other of the joint waveguide coupler 98 and the transceiver interconnect member 81.

The joint waveguide coupler 98 can further prevented from moving up and down with respect to the transceiver interconnect member 81 along the transverse direction T when the joint waveguide coupler 98 is attached to the transceiver interconnect member 81. In particular, the joint waveguide coupler 98 includes first and second projections that capture the transceiver interconnect member 81 along the transverse direction, thereby limiting or preventing relative movement between the transceiver interconnect member 81 and the joint waveguide coupler 98 along the transverse direction T. The first projection can be defined by an overhang 146 of the joint waveguide coupler 98 that is configured to overlap and contact the transceiver interconnect member 81 so as to prevent movement of the joint waveguide coupler 98 relative to the transceiver interconnect member 81 along the downward direction when the joint waveguide coupler 98 is attached to the transceiver interconnect member 81. In particular, the overhang 146 can be configured to overlap the upper surface of the transceiver interconnect member 81. For example, the overhang 146 is configured to overlap the upper surface of the interconnect body portion 136. Mechanical interference between the overhang 146 and the transceiver interconnect member 81 prevents the joint waveguide coupler from moving with respect to the transceiver interconnect member in the downward direction. Otherwise stated, mechanical interference between the overhang 146 and the transceiver interconnect member 81 prevents the transceiver interconnect member 81 from moving with respect to the joint waveguide coupler 98 in the upward direction.

The second projection of the joint waveguide coupler 98 can be defined by at least one tapered surface of the joint waveguide coupler 98. In particular, the lateral sides 99 can taper away from each other along the lateral direction A as they extend in the downward direction. Similarly, the arms 134 of the transceiver interconnect member 81 taper away from each other along the lateral A as they extend in the downward direction. The lateral sides of the joint waveguide coupler 98 are positioned to overlap the arms 134 along the transverse direction T when the joint waveguide coupler 98 is attached to the transceiver interconnect member 81. In particular, the arms 134 are spaced from the lateral sides 99 in the upward direction. Accordingly, mechanical interference between the lateral sides 99 and the arms 134 prevents the joint waveguide 98 coupler from moving with respect to the transceiver interconnect member 81 in the upward direction. Otherwise stated, mechanical interference between the lateral sides 99 and the arms 134 prevents the transceiver interconnect member 81 from moving with respect to the joint waveguide 98 coupler in the downward direction.

Thus, it can be said that the joint waveguide coupler 98 and the transceiver interconnect member 81 are configured to interlock with each other so as to prevent relative movement along the transverse direction T when the joint waveguide coupler 98 is attached to the transceiver interconnect member 81. In one example, the transceiver interconnect member 81 is captured by the joint waveguide coupler 98 with respect to relative movement along the transverse direction T when the joint waveguide coupler 98 is attached to the transceiver interconnect member 81. In particular, the transceiver interconnect member 81 is captured by the overhang and the tapered lateral sides 99. Alternatively, the waveguide coupler 98 can be captured by the transceiver interconnect member 81 with respect to relative movement along the transverse direction T when the joint waveguide coupler 98 is attached to the transceiver interconnect member 81.

When the joint waveguide coupler 98 is attached to the transceiver interconnect member 81, optical signals can travel from the transmitter engine 30 to the optical transmit waveguides 36 in any manner described above. Further, when the joint waveguide coupler 98 is attached to the transceiver interconnect member 81, optical signals can travel from the optical receive waveguides 60 and the receiver engine 62 in any manner described above.

While the joint waveguide coupler 98 has been described as configured to be coupled to and from the transceiver interconnect member, it should be appreciated that the transceiver 20 can include the transmit waveguide coupler 38 and the receive waveguide coupler 72 that is separate from the transmit waveguide coupler 38. Similarly, the transmitter engine 30 and the receiver engine 62 can be separate from each other in the manner described above. Thus, the description herein of the transceiver interconnect member 81 as described herein can further be applied to one or both of the transmit interconnect member 40 and receive interconnect member 68 that is separate from the transmit interconnect member 40. The transmit waveguide coupler 38 can be coupled to, and decoupled from, the transmit interconnect member 40 in the manned described above with respect to the joint waveguide coupler 98 and the transceiver interconnect member 81 so as cause the optical transmit waveguides 36 to couple to, and decouple from, the transmit interconnect member. Similarly, the receive waveguide coupler 72 can be coupled to, and decoupled from, the receive interconnect member 68 in the manned described above with respect to the joint waveguide coupler 98 and the transceiver interconnect member 81 so as cause the optical receive waveguides 60 to couple to, and decouple from, the receive interconnect member 68.

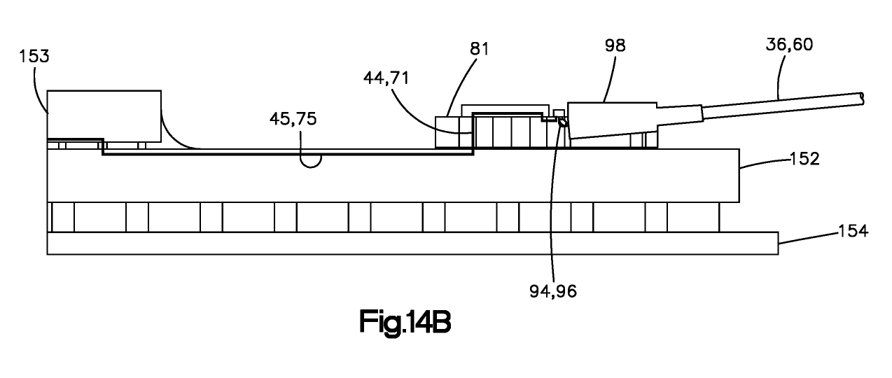

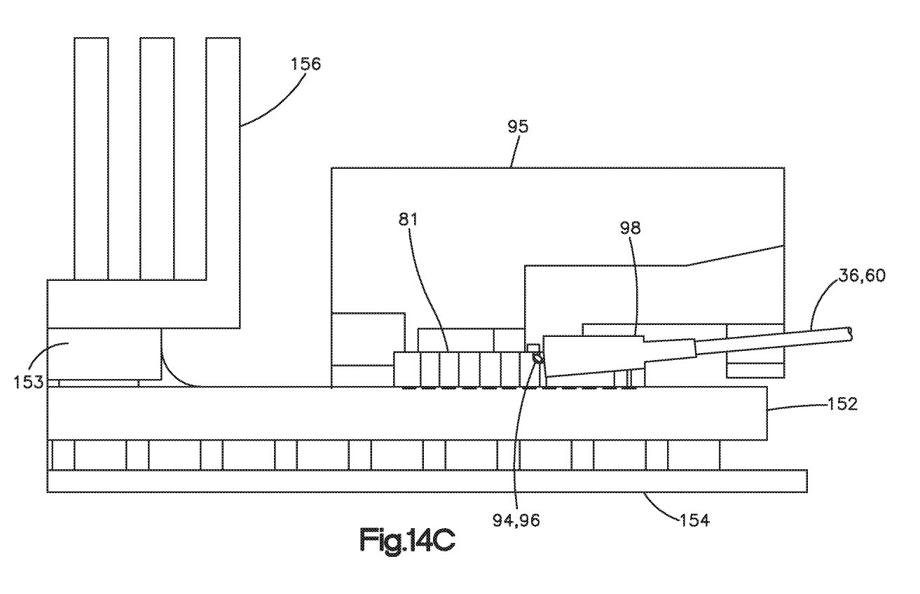

Referring now to FIGS. 14A-14C, it should be appreciated that the joint transceiver interconnect member 81 can support both the transmitter engine 30 and the receiver engine 62 so as to define an optical engine 150 that can be mountable to any suitable platform. The optical transmit waveguides 36 can be coupled to the transmitter engine 30 so as to define the transmitter 22 that is mountable to any suitable platform. Similarly, the optical receive waveguides 60 can be coupled to the receiver engine 62 so as to define the receiver 24 that is mountable to any suitable platform.

For instance, the optical engine 150 can be mounted onto a mid-board module or a front panel mounted module. In one example, the optical engine 150 can be mounted on a daughter board, a multi-source-agreement (MSA) optical transceiver such as quad small form factor pluggable (QSFP) transceiver, an application specific integrated circuit (ASIC) host substrate, or in an on-board transceiver of the type described herein. In some embodiments, the joint waveguide coupler 98 may comprise a material that has a coefficient of thermal expansion substantially matched to that of one or more up to all of the transceiver interconnect member 81, the photonic integrated circuit 32 if incorporated, the light sources 34, the photodetectors 64, and the current-to-voltage converter 66.

As illustrated in FIGS. 14A-14C, a data processing system 101 can include a plurality of the optical engines 150 are mounted on to an host integrated circuit (IC) substrate 152, which can be configured as a printed circuit board. The transceiver interconnect members 81 can be flip-chipped mounted to the host substrate 152. As described above, flip chip mounting allows for short electrical paths between the optical engine 150 and the optical host substrate 152, which facilitates high speed electrical connection. Each of the optical engines 150 can be constructed in accordance with any embodiment described above. Thus, the optical transmit waveguides 36 can be pigtailed to the transmitter engine 30. Similarly, the optical receive waveguides 60 can be pigtailed to the receiver engine 32. Alternatively, the transmit waveguides 36 and the receive waveguides 60 can be supported by the joint waveguide coupler 98, and thus pluggable into the optical engine 150 in the manner described above.

The optical host substrate 152 can support an IC die, which can b configured as an ASIC in one example. Thus, the IC die 153 can include plurality of ASIC components including an ASIC microprocessor, field programmable gate arrays, and switch mounted onto the host substrate 152, and a plurality of the optical engines 150 depending on the desired bandwidth and data transfer rates, and the optical transmit waveguides 36 and optical receive waveguides coupled to the optical engines 150 in any manner described herein. The ASIC components are in electrical communication with both the transmit engine 30 and the receive engine 62.

In one example, the optical host substrate 152 can be assembled by stud bump flip-chipping the light sources 34 and the photodetectors 64 on the transceiver interconnect member 81. The driver and the current-to-voltage converter can also be stud bump flip-chipped to the transceiver interconnect member 81. The transceiver interconnect member 81 can be ball grid array (BGA) flip-chipped to the host substrate 152. Next the host substrate 152 can be solder reflowed onto a host card 154. The joint waveguide couplers 98 can then be attached to the respective transceiver interconnect members 81. Alternatively, the transmit waveguides 36 and the receive waveguides 60 can be pigtailed to the transmit engine 30 and the receive engine 62. The heat sinks 95, as described above, can be mounted to the optical engines 150. Further, an ASIC heat sink 156 can be mounted to the host substrate 152. It should be appreciated, that method steps described herein may be varied in alternative embodiments. Some steps may be combined or omitted, other steps may be added, and the order of the steps can be varied.

Referring now to FIG. 14B, electrical data signals can be transmitted from/to the host substrate 152 to the transceiver interconnect member 81. The signal may be conducted on the substrate with thin copper traces to ball grid array (BGA) to which the transceiver interconnect member 81 is bonded. The electrical transmit signals are conducted from the bottom of the transceiver interconnect member 81 to the top of the transceiver interconnect member 81 through electrically conductive vias 44 in the manner described above. Further as described above, the vias 44 can be connected to a top metallization (or redistribution) layer of the transceiver interconnect member 81. Top metallization layer that can interface with one or both of the light source 34 alone or in combination with one or more of the current-to-voltage converter 66, photodetectors 64, and silicon photonics 32 described above. All electrical paths 45 can be impedance matched to 50 ohms or some other characteristic impedance to enhance the signal integrity of the system.

As described above, the heat sink can be mounted to the host substrate 152. In particular, it is recognized that the system can have three primary sources of heat, including the main ASIC (which can heat up to 100° C. during operation), the laser driver 25 and the current-to-voltage converter 66 (which can heat up to 85° C. during operation) and the light sources 34 (which can heat up to 70° C. during operation). It should be appreciated that the transceiver interposer 81 can provide a thermal isolation barrier to minimize the heat emitted from ASIC to heat the light sources, driver 25, and current-to-voltage amplified 66, all of which having their own heat sink 95 described above, which his separate from the ASIC heat sink 156. Both heat sinks 95 and 156 can be include fins as desired, and leverage forced air cooling or alternatively can use active cooling with fluid running there through.

It should be noted that the illustrations and discussions of the embodiments shown in the figures are for exemplary purposes only, and should not be construed limiting the disclosure. One skilled in the art will appreciate that the present disclosure contemplates various embodiments. Additionally, it should be understood that the concepts described above with the above-described embodiments may be employed alone or in combination with any of the other embodiments described above. It should further be appreciated that the various alternative embodiments described above with respect to one illustrated embodiment can apply to all embodiments as described herein, unless otherwise indicated.

What is claimed:

1. An interconnect member configured to be mounted onto a substrate, the interconnect member comprising:
an optical coupler having at least one optically transmissive path configured to conduct optical signals from an origination surface of the interconnect member to a termination surface of the interconnect member; and
an electrical interposer monolithic with the optical coupler, the electrical interposer including a plurality of electrically conductive vias that extend from a first surface of the interconnect member to a second surface of the interconnect member, wherein the electrically conductive vias are configured to be placed in electrical communication with at least one electrical component of a transceiver at the first surface, and further configured to be placed in electrical communication with the substrate at the second surface.

2. The interconnect member as recited in claim 1, wherein the origination surface and the termination surface define a common surface of the optical coupler.

3. The interconnect member as recited in claim 1, wherein the origination surface and the termination surface define different surfaces of the optical coupler.

4. The interconnect member as recited in claim 3, wherein the first surface, the origination surface, and the termination surface are defined by an upper surface of the interconnect member, and the second surface is defined by a lower surface of the interconnect member.

5. The interconnect member as recited in claim 3, wherein the first surface is defined by an upper surface of the interconnect member, and the second surface is defined by a lower surface of the interconnect member, one of the origination surface and the termination surface is defined by a side surface of the interconnect member that extends between the upper surface and the lower surface, and the other of the origination surface and the termination surface is defined by the upper surface.

6. The interconnect member as recited in any one of claims 4 to 5, further comprising an electrically conductive redistribution layer that extends between respective ends of the vias at the upper surface and the at least one electrical component.

7. The interconnect member as recited in claim 1, wherein the at least one optically transmissive path comprises a first optically transmissive path and a second optically transmissive path angularly offset with respect to the first optically transmissive path, and a reflector that is disposed between the first optically transmissive path and the second optically transmissive path, the reflector configured to reflect optical signals from the first optically transmissive path to the second optically transmissive path.

8. The interconnect member as recited in claim 7, wherein the reflector is an adjustable MEMS mirror.

9. The interconnect member as recited in any one of the preceding claims, wherein the optical coupler is made of an optically conductive material, and the at least one optically transmissive path comprises optically conductive material.

10. The interconnect member as recited in any one of claims 1 to 8, wherein the optical coupler is made of a material, and the at least one optically transmissive path is defined by a channel of the optical coupler that extends through the material.

11. The interconnect member as recited in any one of the preceding claims, wherein the vias are at least partially filled with a cured electrically conductive paste.

12. The interconnect member as recited in any one of the preceding claims, made of glass.

13. An optical engine comprising:
the interconnect member as recited in any one of claims 1 to 12; and
the at least one electrical component.

14. The optical engine as recited in claim 13, comprising an optical receive engine, wherein the at least one electrical component comprises:
a photodetector configured to 1) receive an optical receive signal from an optical receive waveguide from the at least one optical path, and 2) convert the optical receive signal to a corresponding electrical receive signal that has current levels proportional to an intensity of the received optical receive signal; and
a current-to-voltage converter configured to receive the electrical receive signal, condition the electrical receive signal, and output the conditioned electrical receive signal to the substrate through at least one of the electrical vias.

15. The optical engine as recited in claim 13, comprising an optical transmit engine, wherein the at least one electrical component comprises:
a photonic integrated circuit mounted onto the interconnect member, the photonic integrated circuit configured to receive at least one electrical transmit signal that travels through at least one of the vias, convert the electrical transmit signal to an optical transmit signal, and output the optical transmit signal to an optical transmit waveguide.

16. The optical engine as recited in claim 13, comprising an optical transmit engine, wherein the at least one electrical component comprises:
a driver configured to receive at least one electrical transmit signal that travels through at least one of the vias;
a light source mounted onto the interconnect member, the light source configured to receive signals from the driver and, based on the signals from the driver, emit optical signals that travel through the at least one optically transmissive path of the optical coupler to an optical transmit waveguide.

17. The optical engine as recited in claim 16, wherein the light source is a VCSEL.

18. An optical coupler comprising:
a body defining a first optically transmissive path and a second optically transmissive path; and
a reflector configured to reflect an optical signal that has travelled through the first optically transmissive path to the second optically transmissive path.

19. The optical coupler as recited in claim 18, wherein the reflector is supported by the body.

20. The optical coupler as recited in claim 18, wherein the reflector is embedded in the body.

21. The optical coupler as recited in any one of claims 18 to 20, wherein the reflector comprises an adjustable MEMS mirror.

22. The optical coupler as recited in any one of claims 18 to 21, wherein the body defines an origination surface and a termination surface, the first optically transmissive path extends from the origination surface to the reflector, and the second optically conductive channel extends from the reflector to the termination surface.

23. A transmitter engine comprising:
a transmit interconnect member including the optical coupler as recited in claim 20, and an electrical transmit interconnect member,
wherein the electrical transmit interconnect member comprises a plurality of electrically conductive vias that extend therethrough, the electrically conductive vias configured to place an underlying substrate in electrical communication with at least one of a driver, a light source, and a photonic integrated circuit.

24. The transmitter engine as recited in claim 23, wherein the electrically conductive vias are at least partially filled with a cured electrically conductive paste.

25. A receiver engine comprising:
a receive interconnect member including the optical coupler as recited in claim 20, and an electrical receive interconnect member,
wherein the electrical receive interconnect member comprises a plurality of electrically conductive vias that extend therethrough, the electrically conductive vias configured to place an underlying substrate in electrical communication with at least one of a current-to-voltage converter and a photodetector.

26. The receiver engine as recited in claim 25, wherein the electrically conductive vias are at least partially filled with a cured electrically conductive paste.

27. A method of data communication comprising the steps of:
directing an optical signal into a body of an optical coupler along a first optically transmissive path; and
after the directing step, reflecting the optical signal off of a reflector so that the optical signal travels along a second optically transmissive path in the body.

28. The method as recited in claim 27, wherein the reflector is supported by the body.

29. The method as recited in claim 27, wherein the reflector is embedded in the body.

30. The method as recited in any one of claims 27 to 29, wherein the reflector comprises an adjustable MEMS mirror.

31. The method as recited in any one of claims 27 to 30, wherein the body defines an origination surface and a termination surface, the first optically transmissive path extends from the origination surface to the reflector, and the second optically conductive channel extends from the reflector to the termination surface.

32. An optical assembly comprising:
an interconnect member that supports an optical engine, and is configured to be mounted to a substrate; and
a waveguide assembly including a waveguide coupler and a plurality of optical waveguides supported by the waveguide coupler,
wherein the interconnect member is configured to removably attach to the waveguide coupler, thereby placing the optical waveguides in optical alignment with the optical engine through the interconnect member.

33. The optical assembly as recited in claim 32, wherein the interconnect member defines a pair of arms that are configured to attach to the waveguide coupler so as to place the optical waveguides in optical alignment with the optical engine through the interconnect member.

34. The optical assembly as recited in claim 33, wherein mechanical interference between the arms and the waveguide coupler prevents movement of the waveguide coupler away from the interconnect member along a longitudinal direction, and mechanical interference between the waveguide coupler and the interconnect member prevents movement of the waveguide coupler toward the interconnect member along the longitudinal direction.

35. The optical assembly as recited in claim 34, wherein mechanical interference between the arms and the waveguide coupler prevents relative movement of the waveguide coupler and the interconnect member along a lateral direction that is oriented perpendicular to the longitudinal direction.

36. The optical assembly as recited in claim 35, wherein one of the interconnect member and the waveguide coupler is captured between the other of the interconnect member and the waveguide coupler with respect to relative movement along a transverse direction that is perpendicular to each of the lateral direction and the longitudinal direction.

37. The optical assembly as recited in any one of claims 32 to 36, wherein the optical engine comprises a transmitter engine including a light source and a light source driver, the light source configured to output optical transmit signals through the interconnect member to transmit waveguides of the optical waveguides when the transmit waveguides are in optical alignment with the transmitter engine through the interconnect member.

38. The optical assembly as recited in claim 37, wherein the interconnect member further comprises electrical vias that partially define an electrically conductive path between the light source driver and the substrate.

39. The optical assembly as recited in claim 38, wherein the electrical vias are at least partially filled with a cured electrically conductive paste.

40. The optical assembly as recited in any one of claims 32 to 36, wherein the optical engine comprises a receiver engine including a photodetector and a current-to-voltage converter, the photodetector configured to receive optical receive signals from receive waveguides of the plurality of waveguides when the receive waveguides are in optical alignment with the receiver engine through the interconnect member.

41. The optical assembly as recited in claim 40, wherein the interconnect member further comprises electrical vias that partially define an electrically conductive path between the current-to-voltage converter and the substrate.

42. The optical assembly as recited in claim 41, wherein the electrical vias are at least partially filled with a cured electrically conductive paste.

43. An optical transceiver comprising:
the transmitter engine as recited in any one of claims 36 to 38; and
the receiver engine as recited in any one of claims 39 to 42.

44. The optical transceiver as recited in claim 43, wherein the interconnect member of the transmitter engine is monolithic with the interconnect member of the receiver engine.

45. The optical transceiver as recited in claim 43, wherein the interconnect member of the transmitter engine is separate from the interconnect member of the receiver engine.

46. An optical transceiver comprising:
a transmitter including a photonic integrated circuit that is configured to be supported by a substrate, the photonic integrated circuit configured to receive at least one electrical transmit signal, convert the electrical transmit signal to an optical transmit signal, and output the optical transmit signal to an optical transmit waveguide;
a receiver including:
i) a receive waveguide coupler configured to support an optical receive waveguide;
ii) a photodetector configured to 1) receive an optical receive signal from the optical receive waveguide, and 2) convert the optical receive signal to a corresponding electrical receive signal that has current levels proportional to an intensity of the received optical receive signal; and
iii) a current-to-voltage converter configured to receive the electrical receive signal, condition the electrical receive signal, and output the conditioned electrical receive signal.

47. The optical transceiver as recited in claim 46, wherein the photonic integrated circuit comprises a silicon photonics chip.

48. The optical transceiver as recited in claim 47, wherein the transmitter further comprises a light source that emits light that is directed to the photonic integrated circuit, and a modulator that modulates the light to produce the optical transmit signals.

49. The optical transceiver as recited in claim 48, wherein the light source is a laser light source selected from a group consisting of a VCSEL, a DFB laser and a FP laser.

50. The optical transceiver as recited in any claims 46 to 49, wherein the transmitter further comprises the optical transmit waveguide in optical alignment with the photonic integrated circuit and configured to receive the optical transmit signals, and carry the optical transmit signals to a component.

51. The optical transceiver as recited in any one claims 46 to 50, further comprising a transmit interconnect member configured to receive the optical transmit signal from the photonic integrated circuit along a first transmit path, and redirect the optical transmit signal toward the optical transmit waveguide along a second transmit path that is different than the first transmit path.

52. The optical transceiver as recited in claim 51, wherein the transmitter further comprises a transmit waveguide coupler configured to support the transmit waveguide, and the transmit interconnect member is disposed between the substrate and each of the photonic integrated circuit and the transmit waveguide coupler.

53. The optical transceiver as recited in any one of claims 51 to 52, wherein the transmit interconnect member comprises a substrate, and the first and second transmit paths extend through the substrate of the transmit interconnect member.

54. The optical transceiver as recited in claim 53, wherein the substrate comprises a transparent material.

55. The optical transceiver as recited in claim 54, wherein the transparent material comprises glass.

56. The optical transceiver as recited in any one of claims 54 to 55, wherein the substrate comprises one of glass and silicon.

57. The optical transceiver as recited in any one of claims 51 to 56, wherein the transmitter further comprises a reflective transmitter surface that is configured to reflect the optical transmit signal from the first transmit path to the second transmit path.

58. The optical transceiver as recited in claim 57, wherein the transmit interconnect member defines a first transmit interconnect member surface that faces each of the waveguide coupler and the photonic integrated circuit, and the reflective transmitter surface is supported by a second transmit interconnect member surface that is opposite the first transmit interconnect member surface.

59. The optical transceiver as recited in claim 58, wherein the transmit waveguide coupler is supported by the first transmit interconnect member surface.

60. The optical transceiver as recited in claim 59, wherein the photonic integrated circuit is supported by the first transmit interconnect member surface.

61. The optical transceiver as recited in any one of claims 51 to 60, further comprising at least one transmitter lens disposed upstream of the transmit waveguide coupler, and positioned such that the optical transmit signal passes therethrough.

62. The optical transceiver as recited in claim 61, wherein the transmitter lens is disposed between the transmit waveguide coupler and the reflective transmitter surface.

63. The optical transceiver as recited in any one of claims 61 to 62, wherein the transmit waveguide coupler comprises the transmitter lens.

64. The optical transceiver as recited in any one of claims 61 to 62, wherein the transmitter lens is carried by the transmit waveguide coupler.

65. The optical transceiver as recited in any one of claims 61 to 63, wherein the transmit interconnect member comprises the transmitter lens.

66. The optical transceiver as recited in any one of claims 61 to 63, wherein the transmitter lens is carried by the transmit interconnect member.

67. The optical transceiver as recited in any one of claims 61 to 66, wherein the transmitter lens causes light beams of the optical transmit signal to converge as they travel toward the optical transmit waveguide.

68. The optical transceiver as recited in any one of claims 61 to 67, wherein the transmitter lens includes a collimating transmitter lens.

69. The optical transceiver as recited in any one of claims 61 to 68, wherein the transmit waveguide coupler comprises a reflective transmit coupler surface that is non-parallel with the second transmit path, so as to reflect the optical transmit signal along a third transmit path that is in alignment with the optical transmit waveguide.

70. The optical transceiver as recited in claim 69, wherein the reflective transmit coupler surface is oriented along a plane that is angularly offset with respect to the second transmit path.

71. The optical transceiver as recited in any one of claims 69 to 70, wherein the transmit waveguide coupler is mounted onto the transmit interconnect member, such that the optical transmit signal is directed to travel along the second transmit path from the reflective transmitter surface, through the transmitter lens, and to the reflective transmit coupler surface.

72. The optical transceiver as recited in any one of claims 51 to 60, wherein the transmit waveguide coupler comprises a reflective transmit coupler surface that is non-parallel with the second transmit path, so as to reflect the optical transmit signal along a third transmit path that is in alignment with the optical transmit waveguide.

73. The optical transceiver as recited in claim 72, wherein the reflective transmit coupler surface is oriented along a plane that is angularly offset with respect to the second transmit path.

74. The optical transceiver as recited in any one of claims 57 to 73, wherein the reflective transmitter surface is concave, such that the light beams of the optical transmit signal converge as they travel along the second transmit path.

75. The optical transceiver as recited in any one of claims 57 to 73, wherein the reflective transmitter surface is substantially planar.

76. The optical transceiver as recited in any one of claims 57 to 75, wherein the reflective transmitter surface has an adjustable orientation so as to correspondingly adjust the second transmit path.

77. The optical transceiver as recited in claim 76, wherein the reflective transmitter surface is responsive to at least one of an electromagnetic and electrostatic force so as to adjust the orientation.

78. The optical transceiver as recited in any one of claims 76 to 77, wherein the reflective transmitter surface is defined by a reflector that is a micro-electromechanical systems structure.

79. The optical transceiver as recited in claim 78, wherein the micro-electromechanical systems structure is defined by the transmit interconnect member.

80. The optical transceiver as recited in claim 78, wherein the micro-electromechanical systems structure is supported by the transmit interconnect member.

81. The optical transceiver as recited in any of claims 51 to 80, wherein the transmit interconnect member defines at least one electrically conductive path.

82. The optical transceiver as recited in any of claims 51 to 81, wherein the transmit interconnect member comprises at least one electrically conductive via.

83. The optical transceiver as recited in any one of claims 51 to 82, wherein optical transmit signals undergo free space propagation through the transmit interconnect member.

84. The optical transceiver as recited in any one of claims 51 to 83, wherein the transmit interconnect member is devoid of optical waveguides.

85. The optical transceiver as recited in any one of claims 46 to 84, wherein the current-to-voltage converter further comprises an amplifier.

86. The optical transceiver as recited in claim 85, wherein the amplifier is a transimpedance amplifier.

87. The optical transceiver as recited in any one of claims 46 to 86, further comprising the optical receive waveguide that is supported by the receive waveguide coupler so as to be in optical alignment with the photodetector.

88. The optical transceiver as recited in any one of claims 46 to 87, wherein the photodetector is spaced from the current-to-voltage converter.

89. The optical transceiver as recited in any one of claims 85 to 88, wherein the amplifier and the photodetector are fabricated on a common die.

90. The optical transceiver as recited in claim 89, wherein the receiver further comprises an electrical conductor connected between the photodetector and the current-to-voltage converter, and the photodetector is configured to output the electrical receive signal to the current-to-voltage converter along the electrical conductor.

91. The optical transceiver as recited in any one of claims 88 to 90, wherein 1) the photodetector comprises a plurality of photodetectors configured to a) receive a respective plurality of optical receive signals from respective optical receive waveguides, and b) convert the optical receive signals to corresponding electrical receive signals, and 2) the current-to-voltage converter is configured to receive the electrical receive signals, condition the electrical receive signals, and output the conditioned electrical receive signals.

92. The optical transceiver as recited in claim 91, wherein at least some of the plurality of photodetectors is fabricated on a common monolithic die that is configured to be supported by the substrate.

93. The optical transceiver as recited in claim 91, wherein all of the plurality of photodetectors is fabricated on a common monolithic die that is configured to be supported by the substrate.

94. The optical transceiver as recited in any one of claims 92 to 92, wherein at least some of the plurality of photodetectors are fabricated on separate dies.

95. The optical transceiver as recited in any one claims 46 to 94, wherein the photodetector is housed in a common housing as the current-to-voltage converter.

96. The optical transceiver as recited in claim 95, wherein 1) the photodetector comprises a plurality of photodetectors configured to a) receive a respective plurality of optical receive signals from respective optical receive waveguides, and b) convert the optical receive signals to corresponding electrical receive signals, and 2) the current-to-voltage converter is configured to receive the electrical receive signals, condition the electrical receive signals, and output the conditioned electrical receive signals.

97. The optical transceiver as recited in any one of claims 95 to 96, wherein the photodetector is oriented such that the active region faces away from the substrate and the optical receive signal passes through a lens between the output end of the optical receive waveguide and the photodetector.

98. The optical transceiver as recited in any one of claims 46 to 97, wherein the photodetector has an active region that is oriented to receive the optical receive signal from an output end of the optical receive waveguide.

99. The optical transceiver as recited in claim 98, wherein the photodetector is oriented such that the active region faces the substrate.

100. The optical transceiver as recited in any one of claims 46 to 99, further comprising a receive interconnect member configured to receive the optical receive signal from the waveguide along a first receive path, and redirect the optical receive signal toward the photodetector along a second receive path that is different than the first receive path.

101. The optical transceiver as recited in claim 100, wherein the receive interconnect member is disposed between the substrate and each of the receive waveguide coupler, the photodetector, and the current-to-voltage converter.

102. The optical transceiver as recited in any one of claims 100 to 101, wherein the receive interconnect member comprises a substrate, and the first and second receive paths extend through the substrate.

103. The optical transceiver as recited in claim 102, wherein the substrate of the receive interconnect member comprises a transparent material.

104. The optical transceiver as recited in claim 103, wherein the transparent material comprises one of glass and silicon.

105. The optical transceiver as recited in any one of claims 100 to 104, wherein the receiver further comprises a reflective receiver surface that is configured to receive the optical receive signal along the first receive path, and reflect the optical receive signal to travel along the second receive path.

106. The optical transceiver as recited in claim 105, wherein the receive interconnect member defines a first receive interconnect member surface that faces each of the current-to-voltage converter, the photodetector, and the receive waveguide coupler, and the reflective receiver surface is supported by a second receive interconnect member surface that is opposite the first receive interconnect member surface.

107. The optical transceiver as recited in claim 106, wherein the receive waveguide coupler is disposed on the first receive interconnect member surface.

108. The optical transceiver as recited in claim 106, wherein each of the photodetector and the current-to-voltage converter is disposed on the first receive interconnect member surface.

109. The optical transceiver as recited in any one of claims 100 to 108, further comprising at least one receiver lens disposed downstream of the receive waveguide coupler, and positioned such that the optical receive signal passes therethrough.

110. The optical transceiver as recited in claim 109, wherein the receiver lens is disposed between the receive waveguide coupler and the reflective receiver surface.

111. The optical transceiver as recited in any one of claims 109 to 110, wherein the receive waveguide coupler comprises the receiver lens.

112. The optical transceiver as recited in any one of claims 109 to 110, wherein the receiver lens is carried by the receive waveguide coupler.

113. The optical transceiver as recited in any one of claims 109 to 110, wherein the receive interconnect member comprises the receiver lens.

114. The optical transceiver as recited in any one of claims 109 to 110, wherein the receiver lens is carried by the receive interconnect member.

115. The optical transceiver as recited in any one of claims 109 to 114, wherein the receiver lens comprises a converging lens that causes light beams of the optical receive signal to converge as they travel toward the second receive interconnect member surface.

116. The optical transceiver as recited in any one of claims 102 to 105, wherein the receiver lens further comprises a collimating receiver lens disposed upstream of the converging lens.

117. The optical transceiver as recited in any one of claims 109 to 116, wherein the receive waveguide coupler comprises a reflective receive coupler surface that is non-parallel with the first receive path, so as to reflect the optical receive signal from the optical receive waveguide along a direction in alignment with the receiver lens.

118. The optical transceiver as recited in claim 117, wherein the reflective receive coupler surface is oriented along a plane that is angularly offset with respect to the first receive path.

119. The optical transceiver as recited in any one of claims 117 to 118, wherein the receive waveguide coupler is mounted onto the receive interconnect member, such that the optical receive signal is directed to travel along the first receive path from the reflective receive coupler surface, through the receiver lens, and to the reflective receiver surface.

120. The optical transceiver as recited in any one of claims 100 to 108, wherein the receive waveguide coupler comprises a reflective receive coupler surface that is non-parallel with the first receive path, so as to reflect the optical receive signal from the optical receive waveguide along a direction in alignment with the receiver lens.

121. The optical transceiver as recited in claim 120, wherein the reflective receive coupler surface is oriented along a plane that is angularly offset with respect to the first receive path.

122. The optical transceiver as recited in any one of claims to 105 to 121, wherein the reflective receiver surface is concave, such that light beams of the optical receive signal converge as they travel along the second receive path.

123. The optical transceiver as recited in any one of claims 105 to 121, wherein the reflective receiver surface is substantially planar.

124. The optical transceiver as recited in any one of claims to 105 to 123, wherein the reflective receiver surface has an adjustable angular orientation so as to correspondingly adjust the second receive path.

125. The optical transceiver as recited in claim 124, wherein the reflective receiver surface is responsive to at least one of an electromagnetic and electrostatic force so as to adjust the angular orientation of the reflective surface.

126. The optical transceiver as recited in any one of claims 123 to 124, wherein the reflective receiver surface is a micro-electromechanical systems surface.

127. The optical transceiver as recited in claim 126, wherein the micro-electromechanical systems surface is defined by the receive interconnect member.

128. The optical transceiver as recited in claims 124 to 127, wherein the reflective receiver surface is disposed adjacent the receive interconnect member.

129. The optical transceiver as recited in any one of claims 46 to 128, wherein the transceiver is a mid-board transceiver.

130. The optical transceiver as recited in any of claims 100 to 129, wherein the receive interconnect member defines at least one electrically conductive path.

131. The optical transceiver as recited in any of claims 100 to 130, wherein the receive interconnect member comprises at least one electrically conductive via.

132. The optical transceiver as recited in any one of claims 100 to 131, wherein the optical receive signals undergo free space propagation through the receive interconnect member.

133. The optical transceiver as recited in claim 100 to 132, wherein the optical signal propagation through the receive interconnect member contains no optical waveguides.

134. The optical transceiver as recited in any one of claims 46 to 133, wherein the photodetector has a surface sensitive active region.

135. The optical transceiver as recited in any one of claims 46 to 134, configured to be mated and unmated with a first electrical component.

136. The optical transceiver as recited in any one of claims 46 to 135, wherein the photodetector is physically spaced from the photonic integrated circuit of the transmitter.

137. An optical assembly comprising:
an optically transparent interconnect member that defines a first surface and a second surface opposite the first surface along a transverse direction;
an optical engine mounted to the first surface;
an optical waveguide coupler mounted to the first surface at a location spaced from the optical engine along a direction angularly offset with respect to the transverse direction; and
a reflective surface disposed at a location spaced from the first surface along the transverse direction,
wherein the interconnect member is configured to receive an optical signal at the first surface, and conduct the optical signal along a first path to the reflective surface, such that the reflective surface reflects the optical signal to the first surface along a second path different from the first path.

138. The optical assembly as recited in claim 137, wherein the interconnect member receives the optical signal from an optical waveguide coupler along the first path, and outputs the optical signal toward the optical engine along the second path.

139. The optical assembly as recited in claim 138, further comprising an optical waveguide mounted to the optical waveguide coupler, wherein the optical waveguide is configured to output the optical signal upstream of the interconnect member.

140. The optical assembly as recited in any one of claims 137 to 139, wherein the first and second paths both pass through the first surface of the interconnect member.

141. The optical assembly as recited in any one of claims 137 to 140, wherein the optical engine comprises the photodetector and the current-to-voltage converter as recited in any one of claims 1 and 32 to 44.

142. The optical assembly as recited in any one of claims 138 to 141, wherein the interconnect member is as recited in any one of claims 100 to 115.

143. The optical assembly as recited in claim 138, wherein the interconnect member receives the optical signal from the optical engine along the first path, and outputs the optical signal toward the optical waveguide coupler along the second path.

144. The optical assembly as recited in claim 143, further comprising an optical waveguide mounted to the optical waveguide coupler, wherein the optical waveguide is configured to receive the optical signal downstream of the interconnect member.

145. The optical assembly as recited in any one of claims 137 to 144, wherein the interconnect member defines at least one electrically conductive via.

146. The optical assembly as recited in any one of claims 137 to 145, wherein the interconnect member defines at least one electrically conductive path.

147. The optical assembly as recited in any one of claims 137 to 146, wherein the interconnect member comprises a redistribution layer in electrical communication with the at least one electrically conductive via and the electrically conductive path.

148. The optical assembly as recited in any one of claims 137 to 147, wherein the first and second paths define an angle less than 70 degrees.

149. The optical assembly as recited in any one of claims 137 and 143 to 144, wherein the optical engine comprises the photonic integrated circuit as recited in any one of claims 46 to 50.

150. The optical assembly as recited in any one of claims 137, 143, and 149, wherein the interconnect member is as recited in any one of claims 6 to 39.

151. A method of data communication, the method comprising the steps of:
converting electrical transmit signals to optical transmit signals in a photonic integrated circuit that is supported by a substrate of an optical transceiver;
outputting the optical transmit signal to an optical transmit waveguide;
receiving optical receive signals from an optical receive waveguide;
converting the optical receive signals to electrical receive signals in a photodetector;
conditioning the electrical receive signals in a current-to-voltage converter; and
outputting the conditioned electrical receive signals.

152. The method as recited in claim 151, further comprising the step of directing the optical transmit signals from the photonic integrated circuit to an optically transparent transmit interconnect member.

153. The method as recited in claim 152, comprising the step of conducting the optical transmit signal in the interconnect member along a first transmit path, reflecting the optical transmit signals to travel along a second transmit path in the transmit interconnect member that is different than the first transmit path, and directing the optical transmit signals to the optical transmit waveguide.

154. The method as recited in claim 153, wherein the optical transmit signal undergoes free space propagation along the first and second transmit paths.

155. The method as recited in any one of claims 153 to 154, wherein the step of directing the optical transmit signals to the optical transmit waveguide comprises reflecting the optical transmit signals off of a surface of a transmit waveguide coupler that supports the optical transmit waveguide.

156. The method as recited in claim 155, wherein the step of directing the optical transmit signals to the optical transmit waveguide comprises directing the optical transmit signals through a transmitter lens before reflecting the optical transmit signals off of the surface of the transmit waveguide coupler.

157. The method as recited in claim 156, wherein the step of directing the optical transmit signals through the transmitter lens comprises causing light beams of the optical transmit signals to converge as they travel toward the optical transmit waveguide.

158. The method as recited in claim 157, wherein the step of directing the optical transmit signals through the transmitter lens comprises collimating the optical transmit signals prior to causing the light beams to converge.

159. The method as recited in any one of claims 152 to 155, wherein the step of reflecting the optical transmit signals along a second transmit path comprises causing light beams of the optical transmit signals to converge as they travel along the second transmit path.

160. The method as recited in any one of claims 152 to 159, wherein the step of reflecting the optical transmit signals along the second transmit path comprises adjusting an orientation of a reflective surface that performs the step of reflecting the optical transmit signals to travel along the second transmit path.

161. The method as recited in any one of claims 151 to 160, further comprising the step of directing the optical receive signals from the optical receive waveguide to an optically transparent receive interconnect member.

162. The method as recited in claim 161, comprising the step of propagating the optical receive signal in the receive interconnect member along a first receive path, reflecting the optical transmit signals along a second receive path in the receive interconnect member that is different than the first receive path, and directing the optical receive signals from the receive interconnect member to the photodetector.

163. The method as recited in claim 162, wherein the optical transmit signal undergoes free space propagation along the first and second transmit paths.

164. The method as recited in any one of claims 162 to 163, wherein the step of directing the optical receive signals from the optical receive waveguide to an optically transparent receive interconnect member comprises reflecting the optical transmit signals off of a surface of a receive waveguide coupler that supports the optical receive waveguide.

165. The method as recited in claim 164, wherein the step of directing the optical receive signals from the optical receive waveguide to an optically transparent receive interconnect member comprises directing the optical receive signals through a receiver lens after reflecting the optical receive signals off of the surface of the receive waveguide coupler.

166. The method as recited in claim 165, wherein the step of directing the optical receive signals through the receiver lens comprises causing light beams of the optical receive signals to converge as they travel along the first receive path.

167. The method as recited in claim 166, wherein the step of directing the optical receive signals through the receiver lens comprises collimating the optical receive signals prior to causing the light beams to converge.

168. The method as recited in any one of claims 161 to 167, wherein the step of reflecting the optical receive signals along the second receive path comprises causing light beams of the optical receive signals to converge as they travel along the second receive path.

169. The method as recited in any one of claims 161 to 168, wherein the step of reflecting the optical receive signals along the second receive path comprises adjusting an orientation of a reflective surface that performs the step of reflecting the optical receive signals along the second receive path.

170. The method as recited in any one of claims 151 to 169, wherein the photodetector has a surface sensitive active region.

171. The method as recited in any one of claims 151 to 170, wherein the photodetector is supported by the substrate and spaced from the photonic integrated circuit.

172. The method as recited in any one of claims 151 to 171, wherein the optical transmit signal undergoes free space propagation at a location between the photonic optical circuit and the optical transmit waveguide.

173. A method of receiving data in a receiver, the method comprising the steps of:
receiving optical signals from an optical waveguide;
directing the optical signals into an interconnect member;
propagating the optical signals in the interconnect member along a first path;
reflecting the optical signals such that they propagate thru the interconnect member along a second path different than the first path; and
outputting the optical signals from the interconnect member to a photodetector.

174. The method as recited in claim 173, further comprising the step of converting the optical signals to current signals in the photodetector.

175. The method as recited in claim 174, further comprising the step of converting the current signals to voltage signals in a current-to-voltage converter.

176. The method as recited in any one of claims 173 to 175, wherein the first path is in a direction from a first interconnect member surface toward a second interconnect member surface and the second path is in a direction from the second interconnect member surface toward the first interconnect member surface.

177. The method as recited in any one of claims 173 to 176, wherein the step of directing the optical signals into the interconnect member comprises reflecting the optical signals off of a surface of a waveguide coupler that supports the optical waveguide.

178. The method as recited in claim 177, wherein the step of directing the optical signals into the interconnect member comprises directing the optical signals through a lens after reflecting the optical signals off of the surface of the waveguide coupler.

179. The method as recited in claim 178, wherein the step of directing the optical transmit signals through the lens comprises causing light beams of the optical signals to converge as they travel along the first path.

180. The method as recited in claim 179, wherein the step of directing the optical signals through the lens comprises collimating the optical signals prior to causing the light beams to converge.

181. The method as recited in any one of claims 173 to 180, wherein the step of reflecting the optical signals along the second path comprises causing light beams of the optical signals to converge as they travel along the second path.

182. The method as recited in any one of claims 173 to 181, wherein the step of reflecting the optical signals along the second path comprises adjusting an angular orientation of a reflective surface that performs the step of reflecting the optical signals along the second path.

183. The method as recited in any one of claims 173 to 182, wherein the directing step comprises directing the optical signals into a first surface of the interconnect member, and the outputting step comprises outputting the optical signals from the first surface of the interconnect member to the photodetector.

184. The method as recited in any one of claims 173 to 183, further comprising the step of conducting electrical signals through the interconnect member.

185. The method as recited in any one of claims 173 to 184, wherein the outputting step comprises outputting the optical signals from the interconnect member to a surface sensitive active region of the photodetector.

186. The method as recited in any one of claims 173 to 185, wherein the propagating and reflecting steps comprise causing the optical signals to undergo free space propagation.

187. A method of transmitting data in a transceiver, the method comprising the steps of:
receiving electrical signals in a photonic integrated circuit;
converting the electrical signals to optical signals in the photonic integrated circuit;
directing the optical signals into an interconnect member;
propagating the optical signals in the interconnect member along a first path;
reflecting the optical signals such that they propagate in the interconnect member along a second path different than the first path; and
outputting the optical signals from the interconnect member to an optical waveguide.

188. The method as recited in claim 187, wherein the first path is in a direction from a first interconnect member surface toward a second interconnect member surface and the second path is in a direction from the second interconnect member surface toward the first interconnect member surface.

189. The method as recited in any one of claims 187 to 188, wherein the outputting step comprises reflecting the optical signals off of a surface of a waveguide coupler that supports the optical waveguide.

190. The method as recited in claim 189, wherein the outputting step comprises directing the optical signals through a lens before reflecting the optical signals off of the surface of the waveguide coupler.

191. The method as recited in claim 190, wherein the step of directing the optical signals through the lens comprises causing light beams of the optical signals to converge as they travel to the surface of the waveguide coupler.

192. The method as recited in claim 191, wherein the step of directing the optical signals through the lens comprises collimating the optical signals prior to causing the light beams to converge.

193. The method as recited in any one of claims 187 to 192, wherein the step of reflecting the optical signals along the second path comprises causing light beams of the optical signals to converge as they travel along the second path.

194. The method as recited in any one of claims 187 to 193, wherein the step of reflecting the optical signals along the second path comprises adjusting an orientation of a reflective surface that performs the step of reflecting the optical signals along the second path.

195. The method as recited in any one of claims 187 to 194, wherein the directing step comprises directing the optical signals into a first surface of the interconnect member, and the outputting step comprises outputting the optical signals from the first surface of the interconnect member toward the waveguide.

196. The method as recited in any one of claims 187 to 195, further comprising the step of conducting electrical signals through the interconnect member.

197. An optical assembly comprising:
an optically transparent interconnect member configured to be mounted onto a transceiver substrate;
a transmitter including a photonic integrated circuit mounted onto the interconnect member, the photonic integrated circuit configured to receive at least one electrical transmit signal from an electrical component, convert the electrical transmit signal to an optical transmit signal, and output the optical transmit signal to be received by an optical transmit waveguide;
a receiver including:
i) a photodetector configured to receive an optical receive signal from an optical receive waveguide, and convert the optical receive signal to a corresponding electrical receive signal that has current levels proportional to an intensity of the received optical receive signal; and
ii) a current-to-voltage converter configured to receive the electrical receive signal, condition the electrical receive signal, and output the conditioned electrical receive signal,
wherein the photodetector is physically spaced from the photonic integrated circuit of the transmitter.

198. The optical assembly as recited in claim 197, further comprising a multiplexer disposed between the photonic integrated circuit and the optical transmit waveguide, the multiplexer configured to combine multiple optical transmit signals of different wavelengths output by the photonic integrated circuit into a single waveguide, such that the multiple optical transmit signals propagate toward the optical transmit waveguide.

199. The optical assembly as recited in any one of claims 197 to 198, further comprising a demultiplexer disposed between the photodetector and the optical receive waveguide, the demultiplexer configured to divide multiple optical receive signals of different wavelengths received from the optical receive waveguide onto a plurality of waveguides, such that the multiple optical receive signals propagate toward the photodetectors.

200. The optical assembly as recited in claim 199, wherein the multiple optical receive signals travel to the photodetector.

201. The optical assembly as recited in any one of claims 197 to 200, further comprising an application specific integrated circuit mounted on the interconnect member.

202. The optical assembly as recited in claim 201, wherein the application specific integrated circuit comprises the current-to-voltage converter.

203. The optical assembly as recited in any one of claims 201 to 202, wherein the application specific integrated circuit comprises a modulator driver configured to drive modulators of the photonic integrated circuit.

204. The optical assembly as recited in any one of claims 201 to 203, wherein the application specific integrated circuit comprises a current-to-voltage converter configured to be electrically connected to the photodetector.

205. An integrated circuit package comprising:
an integrated circuit die mounted on a substrate,
a photonic integrated circuit mounted on the substrate,
a photodetector mounted on the substrate,
an optical signal coupler mounted on the substrate, wherein a waveguide coupler is suitable for mating with a pluggable optical signal coupler,
wherein the substrate is an optically transparent interconnect member suitable for routing both optical and electrical signals.

206. The integrated circuit package as recited in claim 205, further comprising a multiplexer configured to combine multiple optical transmit signals of different wavelengths output by the photonic integrated circuit into a single waveguide.

207. The integrated circuit package as recited in claim 206, wherein the multiplexer is fabricated into the interconnect member.

208. The integrated circuit package as recited in any one of claims 205 to 207, further comprising a demultiplexer configured to divide multiple optical receive signals of different wavelengths received thru the optical signal coupler, such that the multiple optical receive signals propagate toward the photodetectors on a plurality of waveguides, each waveguide for propagating a single wavelength.

209. The integrated circuit package as recited in any one of claims 205 to 208, wherein the photodetector is physically spaced apart from the photonic integrated circuit.

210. The integrated circuit package as recited in any one of claims 205 to 209, wherein the photodetector has a surface sensitive active region.

211. The integrated circuit package as recited in any one of claims 205 to 210, wherein the interconnect member includes electrically conductive vias extending therethrough.

212. An optical transceiver comprising:
a transmitter including a photonic integrated circuit configured to be supported by a substrate, the photonic integrated circuit configured to receive at least one electrical transmit signal, convert the electrical transmit signal to an optical transmit signal, and output the optical transmit signal to be received by an optical transmit waveguide;
a receiver including:
i) a photodetector configured to 1) receive an optical receive signal from an optical receive waveguide, and 2) convert the optical receive signal to a corresponding electrical receive signal that has current levels proportional to an intensity of the received optical receive signal; and
iii) a current-to-voltage converter configured to receive the electrical receive signal, condition the electrical receive signal, and output the conditioned electrical receive signal,
wherein an angularly adjustable reflector is positioned between at least one of the photonic integrated circuit and optical transmit waveguide and the photodetector and optical receive waveguide.

213. The optical transceiver as recited in claim 212, wherein the photonic integrated circuit is mounted on a transmit interconnect member and the photodetector is mounted on a receive interconnect member that is separate from the transmit interconnect member.

214. The optical transceiver as recited in claim 212, wherein the photonic integrated circuit and the photodetector are mounted on a first side of a common interconnect member.

215. The optical transceiver as recited in claim 214, wherein at least one of the optical transmit signal or optical receive signal propagates thru the interconnect member.

216. The optical transceiver as recited in claim 215, wherein the adjustable mirror is situated adjacent a second side of the interconnect member that is opposite the first side.

217. The optical transceiver as recited in claim 212, wherein the adjustable mirror is a MEMS mirror.
